(19) United States
(12) Patent Application Publication
(10) Pub. No.: US 2009/0125875 A1
(43) Pub. Date: May 14, 2009

(54) METHOD FOR MANUFACTURING A FINAL PRODUCT OF A TARGET SOFTWARE PRODUCT

(75) Inventors: Robert L. SCHMITTER, King of Prussia, PA (US); Raavi IQBAL, Philadelphia, PA (US)

Correspondence Address: ROBERT L. SCHMITTER;OBJECTBUILDERS, INC., 20134 WEST VALLEY FORGE CIRCLE, KING OF PRUSSIA, PA, 19406, US

(73) Assignee: OBJECTBUILDERS, INC. (A PENNSYLVANIA CORPORATION), King of Prussia, PA (US)

(21) Appl. No.: 11/939,710

(22) Filed: Nov. 14, 2007

(51) Int. Cl. G06F 9/44

(52) U.S. Cl. 717/101

(57) ABSTRACT

A method for manufacturing a Final Product of a Target Software Product based on a specification for the Final Product. The method includes setting-up a software manufacturing environment constructing the Final Product by implementing a Schematic on the Assembly Line, the Schematic designating how the Target Software Product is to be manipulated by the at least one Assembly Station.

### BACKGROUND OF THE INVENTION

The present invention relates to a method for manufacturing a Final Product of a Target Software Product based on a specification for the software product.

Manufacturing is the transformation of raw materials into finished goods for sale. Mass production is the production of large amounts of standardized products on production lines. With mass production very high rates of production can be achieved per person. This in turn allows for very inexpensive products. Often mass production systems are organized into Assembly Lines.

Modern concepts of manufacturing are generally regarded as beginning at the time of the British Industrial Revolution. However, mass production techniques were in use, in one form or another, since ancient times—such as manufacturing ceramics in the Orient. The modern mass production techniques that those skilled in the art are familiar with today are referred to as the American System.

Eli Whitney is credited with establishing the American System. Whitney adapted the techniques of mass production and the interchangeability of parts and applied them to the production of muskets for the United States government in the late 1790s. Product designs utilized in the American System required much less trained “assemblers” than the design craftsmen used in the past. This meant that with the American System products could be created for a lower cost.

In 1901 Ransom E. Olds created an Assembly Line for manufacturing automobiles. It is reported that Olds was able to quadruple his factory's output with the Assembly Line. Olds increased the output from 425 cars in 1901 to 2,500 cars in 1902.

Henry Ford improved on Olds' concept by developing large scale Assembly Line, mass production techniques. Ford did this by installing the first moving Assembly Line on Dec. 1, 1913. The moving Assembly Line was intended to cut costs and permit mass production of the Model T Ford. Ford's moving Assembly Line cut the time required to build a Model T Ford from approximately 12½ hours to 1½ hours. This in turn cut the cost of a Model T Ford from $850 in 1908 to $290 in 1927.

One of the key concepts of manufacturing is the designing of a product so that it can be dismantled for easier maintenance, repair, recovery and reuse of components and materials. Manufacturing allows for (a) increased labor output; (b) improved quality control; (c) reduction in purchase costs; and (d) reduction of maintenance costs. And perhaps, most importantly, manufacturing allows for using non-skilled (or less skilled) resources that use easily acquired task-oriented skills to assemble high quality finished products. This use of non-technical resources has then enabled the evolution of the computer-implemented fully automated Assembly Line, which eliminates the need to have almost any resources involved in the production process. Such Assembly Lines are now used for a variety of manufacturing tasks, employing computer software and robotics as the means to implement the production of almost any kind of physical component.

Software tools and technology have been evolving since the first punch card based computers. The evolution included:

1. Machine Code or Assembly Language

2. Procedural programming

3. Object-Oriented programming

4. Components based programming

Even with the evolution of computer programming, those skilled in the art are still not able to achieve the predictable production costs and high levels of efficiency that those skilled in the art have been able to achieve in the manufacturing industry. It is conceivable that by combining a traditional Manufacturing process with Software Development those skilled in the art may keep up with or outpace the demand for software produced products. For example, if the creation of one report or component is needed, a developer is told what is needed and the developer creates the report or component. If the creation of 50 or 500 unique reports in the same amount of time as creating one report is required, 50 or 500 developers are needed to create the reports respectively. The limiting factor is finding 500 developers that can produce all the report to the same quality. This is virtually unachievable even on a small scale. Furthermore, the need for skilled resources and the inability to predict software production costs continue to be significant issues in the software development industry.

The software industry is the next frontier for applying the concepts of manufacturing, Assembly Lines and mass production. These concepts will allow for the production of high quality finished software applications that may be produced in a predictable amount of time, using unskilled resources. Furthermore, such an application of manufacturing and the Assembly Line approach, allows for the natural evolution of a computer-implemented method for manufacturing software products.

Accordingly, there is a need in the art for a method for manufacturing a final product of a Target Software Product corresponding to a factory metaphor.

### BRIEF SUMMARY OF THE INVENTION

Briefly stated, one embodiment of the present invention is directed to a method for manufacturing a Final Product of a Target Software Product based on a specification for the Final Product. The method comprises: a. setting-up a software manufacturing environment having a configurable Assembly Line comprising at least one Assembly Station; and b. constructing the Final Product by implementing a Schematic on the Assembly Line, the Schematic designating how the Target Software Product is to be manipulated by the at least one Assembly Station.

Another embodiment of the present invention is directed to a method for manufacturing a Final Product of a Target Software Product based on a specification for the Final Product. The method comprises: a. setting-up a software manufacturing environment having a configurable Assembly Line comprising at least one Assembly Station, the setting-up step comprising: (1) providing or enhancing a Reference Library having content related to the Target Software Product and a plurality of Job types; and (2) configuring the at least one Assembly Station to manipulate the Target Software Product for at least one Job type selected from the plurality of Job types; b. Encoding a Job corresponding to the at least one Job type, the Encoding step comprising: (1) producing a Schematic for the Job based on the specification and the content of the Reference Library, the Schematic designating how the Target Software Product is to be manipulated by the at least one Assembly Station; and c. constructing the Final Product by implementing the Schematic on the at least one Assembly Station.

Another embodiment of the present invention is directed to a method for manufacturing a Final Product of a Target Software Product based on a specification for the Final Product. The method comprises: a. performing an engineering analysis of the specification, the performing step comprising: (1) confirming the specification format; and (2) creating a Part Listing based on a decomposition of the specification, the Part Listing comprising a plurality of parts, each Part associated with a Job type of a plurality of Job types; b. setting-up a software manufacturing environment having a configurable Assembly Line comprising a plurality of Assembly Stations, the setting-up step comprising: (1) providing or enhancing a Reference Library having content related to the Target Software Product and the plurality of Job types; (2) configuring the Assembly Line to manipulate the Target Software Product for each Job type of the plurality of Job types, each Assembly Station configured to manipulate the Target Software Product for at least one Job; and (3) creating a plurality of Jobs, each Job associated with one Part of the plurality of parts; c. controlling production of the Final Product by managing the assignment of Jobs to the plurality of Assembly Stations; d. Encoding each Job, the Encoding step comprising: (1) producing a Schematic for the each Job based on the specification and the content of the Reference Library, the Schematic designating how the Target Software Product is to be manipulated by the plurality of Assembly Stations; and e. constructing the Final Product by implementing the Schematic on the Assembly Line.

Another embodiment of the present invention is directed to a method for controlling the production of a Final Product of a Target Software Product in a software manufacturing environment. The method comprises: a. providing a configurable Assembly Line comprising at least one Assembly Station; and b. routing a Job associated with the manufacturing of the Final Product to the at least one Assembly Station in accordance with a workflow for the Job.

Another embodiment of the present invention is directed to a method for Encoding a Job in a Software Factory, the Job associated with a Part of a Final Product of a Target Software Product. The method comprises: a. confirming that a Schematic can be created in the Software Factory; and b. producing a Schematic designating how the Target Software Product is to be manipulated to produce a Part of a Final Product of a Target Software Product.

Another embodiment of the present invention is directed to a method for constructing a Final Product of a Target Software Product in accordance with a Schematic having a Schematic Label. The method comprises implementing the Schematic, wherein the implementing step constructs the Final Product.

Another embodiment of the present invention is directed to a method for constructing in a software manufacturing environment a Final Product of a Target Software Product in accordance with a Schematic having a Schematic Label. The method comprises: a. validating the Schematic, wherein the validating step produces a validated Schematic; b. decoding the validated Schematic, wherein the decoding step produces a decoded Schematic; c. implementing the decoded Schematic, wherein the implementing step constructs a unit Final Product; and d. testing the final unit product, wherein the testing step produced a tested Final Product.

Another embodiment of the present invention is directed to a method for providing support for manufacturing a Final Product of a Target Software Product. The method comprises: a. making a request to a Reference Library having content related to the Target Software Product, the request related to the construction of the Final Product; b. retrieving content from the Reference Library in response to the request; and c. making the retrieved content available for use in the manufacturing of the Final Product.

Another embodiment of the present invention is directed to a method for constructing a Final Product of a Target Software Product in accordance with a Machine Readable Schematic. The method comprises: a. configuring an Assembly Robot to produce an output corresponding to a manipulation of the Target Software Product; b. reading the Machine Readable Schematic with the Assembly Robot; and c. producing the Final Product by implementing the Machine Readable Schematic with the Assembly Robot.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a flow diagram of a preferred embodiment of a method for manufacturing a Final Product in accordance with the present invention;

FIG. 2 is a top level N² diagram for the method of FIG. 1;

FIG. 3 is an N² diagram for the Engineering function of FIG. 2;

FIG. 4 is an example specification;

FIG. 5 is an example Reference Library with a section on specification format;

FIG. 6 is a valid specification;

FIG. 7 is a complete specification;

FIG. 8 is an example Reference Library with a section on how the specification gets split into Jobs;

FIG. 9 is a Part listing;

FIG. 10 is an example of a Reference Library index showing Target Software Product/Job Type;

FIG. 11 is a Part Listing (New Job Types);

FIG. 12 is a Part Listing (Existing Job Types);

FIG. 13 is an N² diagram for the Setup function of FIG. 2;

FIG. 14 is an example of shorthand names;

FIG. 14.1 is an example of shorthand parameters;

FIG. 15 is an example of mockup;

FIG. 16 is an example of sketch;

FIG. 17 is an example of mockup produced from sketch;

FIG. 18 is an example of Shorthand Definition for “B”;

FIG. 19 is an example of Shorthand Definition for “B” (revised);

FIG. 19.1 is an Assembly Definition example;

FIG. 20 is an Instruction Set example (alternative 1);

FIG. 21 is an Instruction Set example (alternative 2);

FIG. 22 is an Instruction Set example (alternative 3);

FIG. 23 is an Instruction Set example (Machine Readable);

FIG. 24 is another Instruction Set example (Machine Readable);

FIG. 25 is an Instruction Set example (API Example);

FIG. 26 is a validation rule example 1;

FIG. 27 is a validation rule example 2;

FIG. 28 is a checklist example;

FIG. 29 is an updated Reference Library Index;

FIG. 30 is an N² diagram for the Create Jobs function of FIG. 2;

FIG. 31 is another checklist example for screen development;

FIG. 32 is an N² diagram for the Production Control function of FIG. 2;

FIG. 33 is an example of Workflows/Rules;

FIG. 34 is an Assembly Station Configuration;

FIG. 35 is a Job Type Hierarchy;

FIG. 36 is a Job Hierarchy;

FIG. 37 is an Example Assignment Algorithm;

FIG. 38 is an N² diagram for the Encoding function of FIG. 2;

FIG. 39 is a sketch Schematic example;

FIG. 40 is a mockup Schematic example;

FIG. 41 is another mockup Schematic example;

FIG. 42 is a mockup Schematic in machine readable form;

FIG. 43 is a Test Form;

FIG. 44 is an N² diagram for the Construction function of FIG. 2;

FIG. 45 is a validation algorithm;

FIG. 46 is a validation diagram;

FIG. 47 is a decode process algorithm;

FIG. 48 is a decoding process diagram;

FIG. 49 is a decoded Schematic;

FIG. 50 is a decoding process illustration;

FIG. 51 is a Perform Manipulations Algorithm;

FIG. 52 is a Perform Manipulations Diagram;

FIG. 53 is a Target Software Configuration of W1;

FIG. 54 is a Target Software Configuration of B1;

FIG. 55 is a Target Software Configuration of W2;

FIG. 56 is a Final Product candidate;

FIG. 57 is a Test Form example 2;

FIG. 58 is an N² diagram for the Inspection function of FIG. 2;

FIG. 59 is an inspection Test Form;

FIG. 60 is a business scenario Test Form;

FIG. 61 is an example Job: Simple Test Screen (further simplified);

FIG. 62 is a Simple Test Screen (further simplified): Mockup; and

FIG. 63 is a plan view of an example Software Factory.

### DETAILED DESCRIPTION OF THE INVENTION

For certain terminology used in the claims and the corresponding portions of the specification, unless otherwise defined herein, the definitions set forth for the words appearing in the Definitions Table below shall be controlling.

Table of Definitions

| Word | Definition |
|---|---|
| Encoding | the process or step of using the Shorthand Definition to |
| | describe how a Part shall be constructed. This process results |
| | in the creation of a Schematic. |
| Schematic | the output of the Encoding process or step, which is a |
| | technical document that may be machine readable. This |
| | document has Schematic Labels on it and uses these to |
| | describe to the assembler or Assembly Robot the intended |
| | software manipulation to produce the Final Product. A |
| | Reference Library is used to translate the Schematic into the |
| | specific step by step operations to be performed in the context of the |
| | Target Software Product. |
| Machine Readable | the output of the Encoding process or step, which is a |
| Schematic | Schematic that is electronic in format and is therefore |
| | readable by a machine. |
| Schematic Label | A single instance or notation based on a Shorthand Definition |
| | that indicates to the Assembler or Assembly Robot what an |
| | intended software manipulation is. Schematic Labels exist on |
| | a Schematic and are intended to be interpreted with a |
| | Reference Library. |
| Test Form | A document (electronic or physical) that indicates or lists a |
| | series of tests to be conducted. The tests may be specific to |
| | the unit being tested or my generic in nature. |
| Business Scenario | A type of Test Form in which the tests are specific to a use |
| Test Form | case or situation of predicted usage. |
| Shorthand | a Part of the Reference Library, a Shorthand Definition |
| Definition | describes the syntax and possible parameters for a given |
| | object or sub-unit of a Target Software Product. The |
| | Shorthand Definitions are used in creating a Schematic and in |
| | reading a Schematic. |
| Productivity Tools | software applications that make a task or set of tasks easy to |
| | perform. |
| Jobs | A Job is a defined unit of work associated with a Part (which |
| | is a Part of a specification and a Part of a Completed Software |
| | Application. A Job may have multiple steps and a workflow. |
| | The given workflow of a Job is defined by its Job Type. |
| Job Types | A Job Type is a type of unit of work associated with a Part. |
| | Examples include Screens, Workflows, Models, etc. Full |
| | application etc. |
| Part | A Part is a portion of the specification that maps to a single |
| | component that needs to be assembled. Examples include |
| | Order Entry Screen or Billing Report or Widget Processing |
| | Workflow. |
| Part Listing | A Part Listing is a list of the parts that need to be assembled |
| | in order to create a Completed Software Application. The |
| | Part Listing is produced as Part of the Engineering step of the |
| | Preparation phase of the Software Manufacturing Method. |
| Unit Testing | The operation of testing a single Part. Executed as Part of the |
| | Construction step of the Assembly phase of the Software |
| | Manufacturing Method. |
| Reference Library | This is a set of documents or artifacts that may or may not be |
| | machine readable that are used to create, interpret, validate |
| | and implement Schematics for a given Target Software |
| | Product. The Reference Library typically includes: |
| | Shorthand Definitions, Instruction Sets, Validation Rules, and |
| | Assembly Definitions (collectively “EAGuides”) for any |
| | number of Target Software Products. |
| Instruction Set | This is a Part of a given Reference Library and provides the |
| | information necessary to produce the output of a given Target |
| | Software Product from a Schematic created with a set of |
| | Shorthand Definitions. The information provided is typically |
| | the step by step instructions (for either machine or human) or |
| | a mapping to the output Final Product directly. |
| Machine Readable | The machine readable version of an Instruction Set typically |
| Instruction Set | utilized by an Assembly Robot. |
| Assembly | This is a Part of a given Reference Library and provides the |
| Definition | information necessary to interpret Schematic Labels on a |
| | Schematic that are defined as a combination of Shorthand |
| | Definitions. |
| Machine Readable | The machine readable version of an Assembly Definition |
| Assembly | typically utilized by an Assembly Robot. |
| Definition | |
| Validation Rules | This is a Part of a given Reference Library and provides the |
| | information necessary to validate a Schematic to confirm that |
| | it may be assembled. |
| Machine Readable | The machine readable version of Validation Rules that |
| Validation Rules | typically utilized by an Assembly Robot. |
| Assembly Station | A combination of a Computer and an Operator for the |
| | purpose of processing a Job or step within a Job. This may |
| | also be a Robot on a computer. |
| Assembly Line | A set of Assembly Stations arranged in such a form whereby |
| | the output of one Assembly Station becomes the input of |
| | another. |
| Assembly Robot | A piece of automation (hardware/software or both) with the |
| | purpose of executing the Construction step of the Assembly |
| | phase of the Software Manufacturing Process. |
| Software Factory | a single or combined operation that is performing software |
| | manipulation using the Software Manufacturing Method. |
| Software | The process of manipulating software that includes the phases |
| Manufacturing | of Preparation, Assembly and Inspection as described in this |
| Method | document. |
| Target Software | A piece of software that is used by a Software Factory to |
| Product | produce a given Final Product output. Examples include: |
| | Crystal Reports, LiveIntegrator ™, LiveModeler ™, FileNet, |
| | SQL Server, etc. |
| Completed | The result of applying the Software Manufacturing Method to |
| Software | a given specification. |
| Application | |
| Final Product | The output of a Job, which is typically the output of software |
| | manipulation on a Target Software Product. |

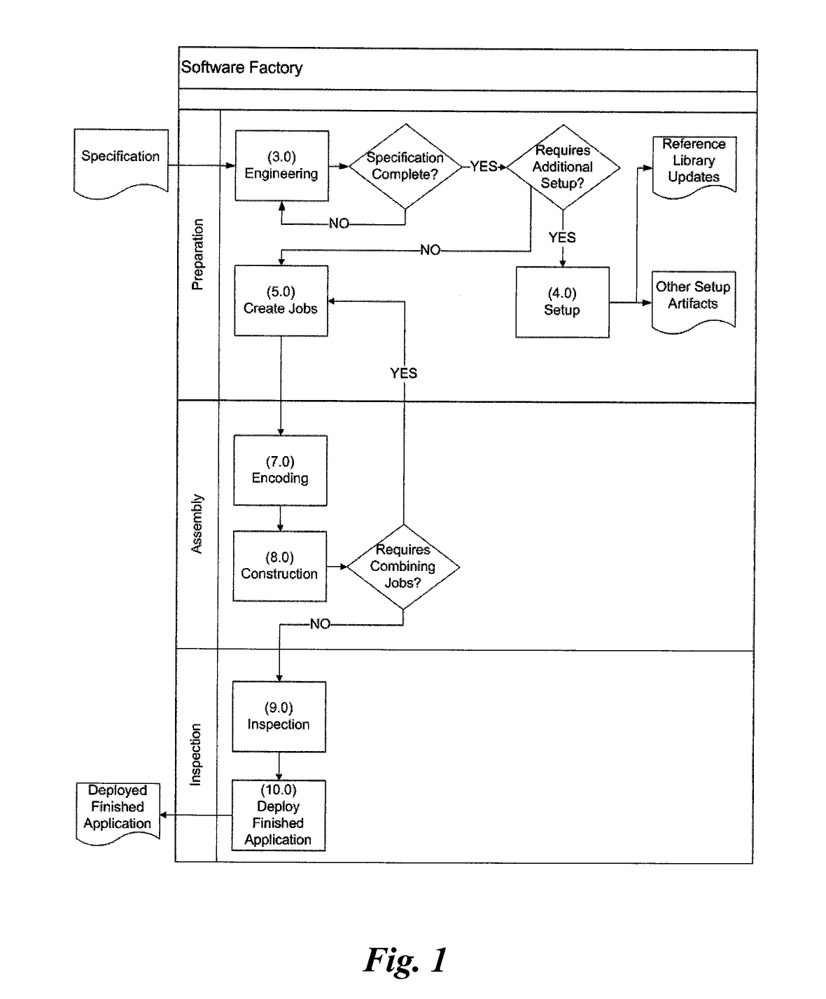

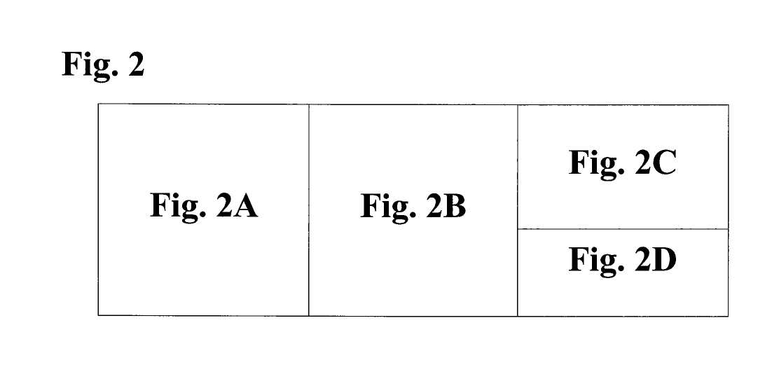

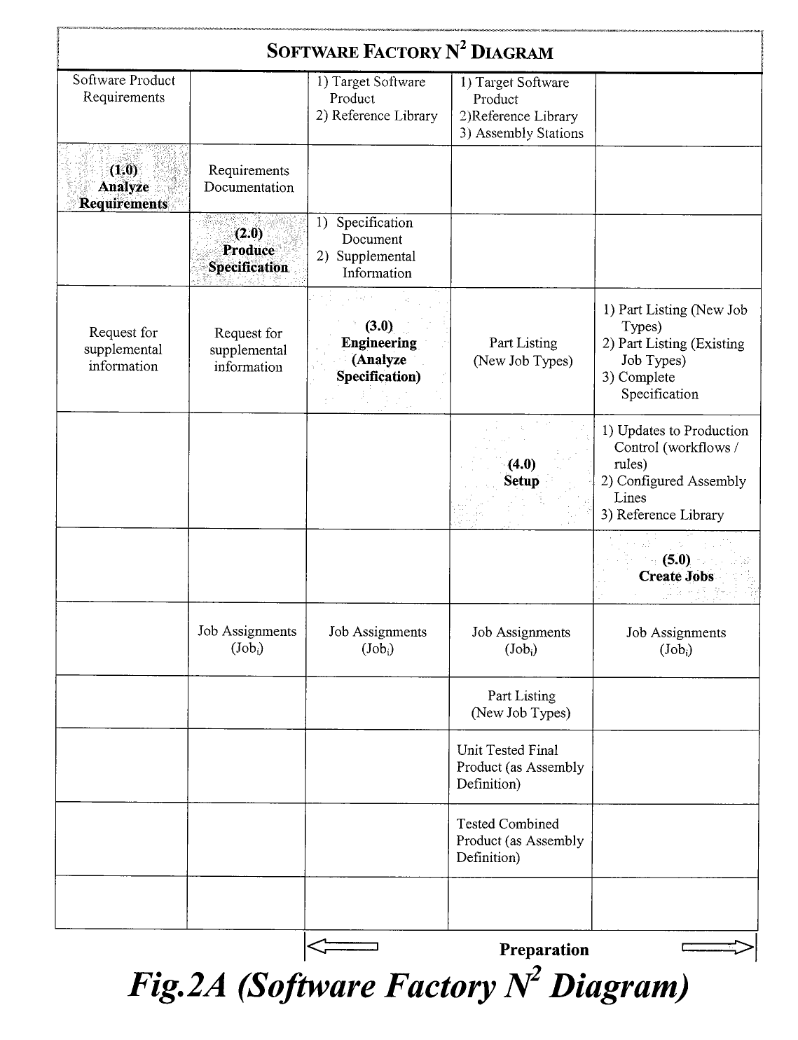

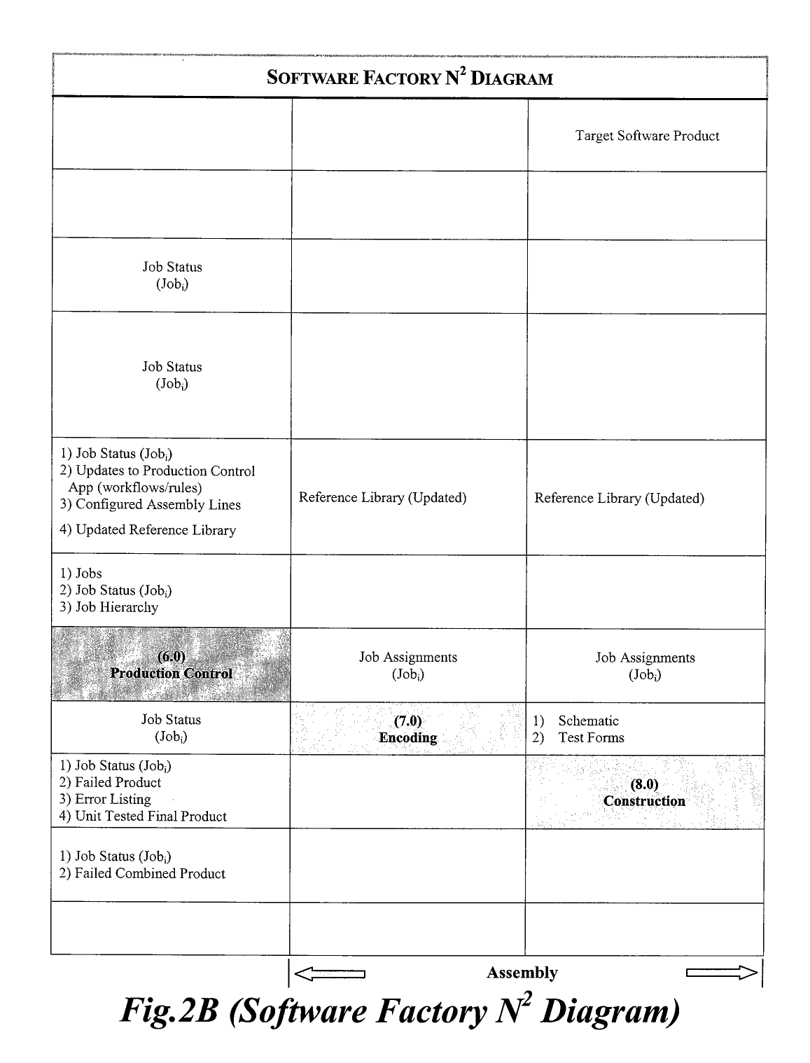

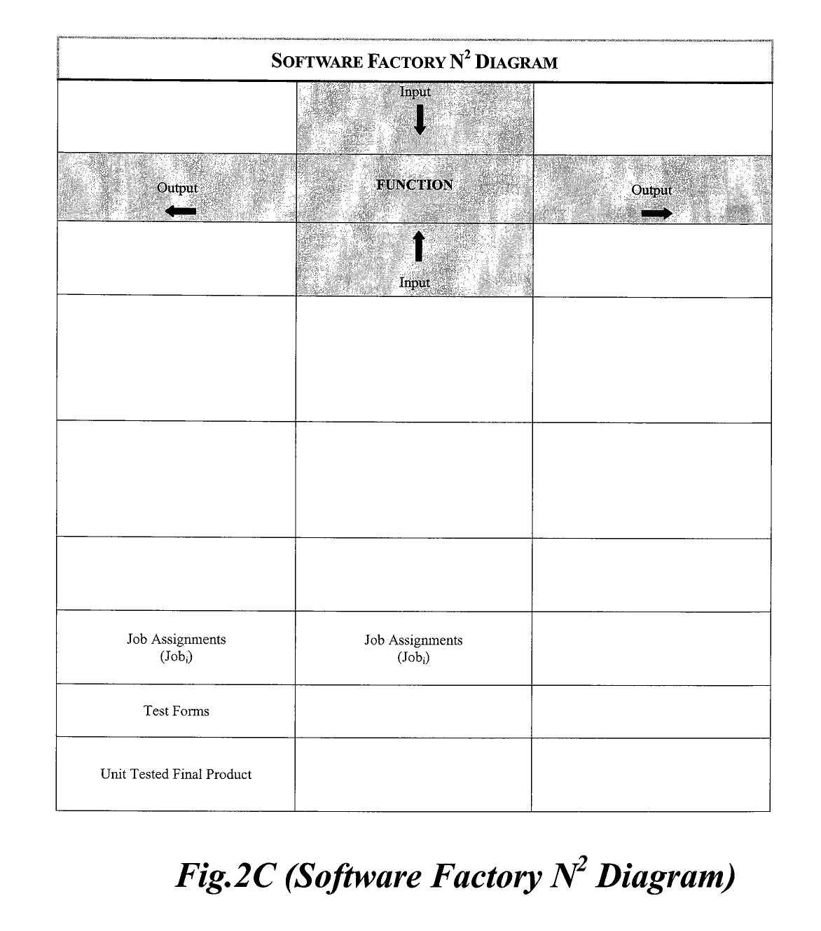

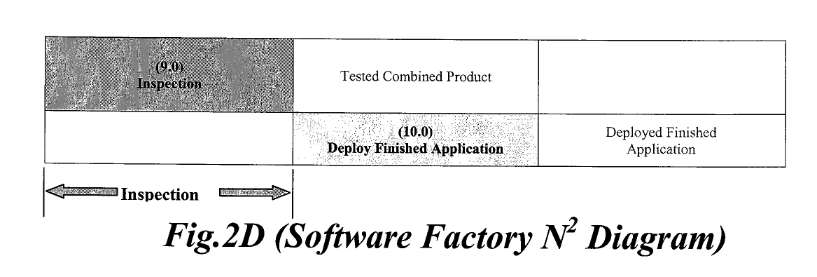

Referring to the drawings in detail, where like numerals indicate like elements throughout, there is shown in FIGS. 1-2 a first preferred embodiment of the method for manufacturing a Final Product generally designated 10, and hereinafter referred to as the “Software Manufacturing Method” 10 in accordance with the present invention. In general, the Software Manufacturing Method 10 has three phases: a preparation phase, an assembly phase, and an inspection phase. Prior to the preparation phase, requirements for the Final Product are developed and after the inspection phase, the Final Product is deployed. The requirements development process and Final Product deployment are outside the scope of the claimed invention and are only disclosed briefly herein for completeness.

Referring to FIGS. 1 and 2, a top level functional flow diagram and an N-Squared (N²) diagram of the Software Manufacturing Method 10 are shown, respectively. As further discussed below, the functional flow diagram shows a preferred order for executing the functions performed by the Software Manufacturing Method 10 and the N² diagram shows the interrelationships among the functions appearing as diagonal elements of the N² diagram and the inputs and outputs for the functions, the inputs appearing as column elements above and below each diagonal elements and the appearing as row elements to the right and left of each diagonal element.

The Software Manufacturing Method 10 uses a manufacturing approach for the production of high quality finished software applications that may be produced in a predictable amount of time, using unskilled resources. Furthermore, as is the case in traditional manufacturing, the Assembly Line approach allows for the natural evolution of a computer-implemented method for manufacturing software products.

The Software Manufacturing Method 10 typically utilizes one or more Target Software Products and preferably, Productivity Tools to manufacture a Deployed Finished Application. Although the Software Manufacturing Method 10 is not limited to the use of Productivity Tools and may be applied to any Computer Software, for simplicity, Productivity Tools are used to disclose the Software Manufacturing Method 10.

Typical characteristics of a productivity tool are: (1) they are focused on non-technical resources, (2) they have a graphical user interface and provide usable feedback without the need to compile, (3) they simplify complex technology and (4) they use documents to store the result of what was created. Productivity Tools come in all sizes and types. All of the following tasks require code or scripting to complete if Productivity Tools are not used: email, reporting, workflow, spreadsheet, word-processing, desktop publishing, computer graphics, presentations and application development. A variety of Productivity Tools may be used to perform these tasks. Examples of such tools include, but are not limited to, Microsoft Outlook®, Crystal Reports®, FileNet Process Designer®, Microsoft Excel®, Microsoft Word®, Adobe Page Maker®, Adobe Photo Shop®, Microsoft PowerPoint®, and ObjectBuilders LiveIntegrator®.

Prior to commencing the software manufacturing method 10, a requirements development phase should be executed. Referring to FIG. 2, during the requirements development phase at least two functions are performed; analyzing the requirements (diagonal element 1.0) for the product to be manufactured and producing the specification (diagonal element 2.0) for the product. The requirements development phase produces as an output a specification document that is the input to the first phase of the Software Manufacturing Method.

At a high level the software manufacturing method comprises three phases: (i) Preparation, (ii) Assembly, and (iii) Inspection. During the Preparation Phase three functions may be performed: an Engineering Analysis of the specification (diagonal element 3.0), Setup (diagonal element 4.0), and Job Creation (diagonal element 5.0). The Preparation Phase typically accomplishes two things: first, it augments the Software Factory configuration in such a way that it is able to process a given specification effectively and second, it divides a given specification into a set of parts and then assigns a Job to each part. As a result of the Engineering analysis, a Part Listing of new Job types and existing Job types is created. The Part Listing of new Job types is then processed in a Setup step (4.0) to prepare the Software Factory to handle those new Job types. After the Software Factory is setup to handle the new Job types, the Creating Jobs function produces a set of Jobs that can be processed in the Assembly phase.

During the Assembly phase three additional functions may be performed: Production Control (diagonal element 6.0); Encoding (diagonal element 7.0); and Construction (diagonal element 8.0). In the Assembly phase, the Jobs may be processed serially or in parallel to produce the Unit Tested Final Product. This is achieved in Part through the use of a production control system that manages the Job assignments and routing of Jobs, an Encoding step where a Schematic is created for each Job in such a way that it can be assembled as an independent unit, and a Construction step whereby the Schematic is processed by an Assembly Station, and the result is tested as a unit, so as to produce a Unit Tested Final Product.

In the Inspection phase (diagonal element 9.0), the Unit Tested Final Product(s) may be assembled into one Tested Combined product which is then inspected for any errors and packaged for delivery. Once the inspection is complete, the Tested Combined Product may be deployed in a Product Deployment Phase (diagonal element 10.0.) which results in the Deployed Finished Application.

Each of the three phases of the software manufacturing method (Preparation, Assembly, and Inspection) comprise a set of steps that are shown in the functional flow diagram depicted in FIG. 1 and that are further discussed in detail below.

For the purpose of describing in detail the functions performed by the steps of the Software Manufacturing Method 10, from time to time, reference is made to one or more features of four distinct parts: Screens, Reports, Workflows, and Business Objects or Data Models. Reference to these parts is not meant to be limiting. The distinct parts for any particular Final Product will depend on the specific type of applications being created.

For example, a Business Application typically has the following parts: Screens, Reports, Workflows, Business Objects or Data Models, Services and Interfaces. In contrast, a computer video game (also a software application) has Characters, Weapons and Levels or Worlds. While the video game looks completely different, it also contains some similar parts: Reports and Business Object or Data Models.

Screens are visual units of an application that together comprise the entire user interface of an application. A single screen is made up of visual components that are arranged on the screen and have some particular behavior.

Reports are similar to screens except that they are not meant as mechanisms to manipulate data, rather they are read-only views of data that are, in most cases, designed to be printed and reviewed.

Workflows are flow charts that determine the flow through the application of the user or the data. Such workflows typically include logical routing instructions and other such business rules. In most cases, workflows are not directly visible in the application by the end user, rather they are a development component of an application that, once created and invoked, function invisibility to the end user.

Business Objects or Data Models encapsulate the definitions of the entities (including attributes and functions) and relationships between entities that are involved in a given application. The business objects or data models are similar to workflows in that they are not typically visible to the end user. These artifacts encapsulate business rules and definitions that influence the other components of the application. For example, each attribute on a screen may map back to an attribute of an entity on a business object or table within a data model.

As briefly discussed above, and as indicated in both FIGS. 1 and 2, the software manufacturing process consists of three phases, Preparation, Assembly, and Inspection, each of which is described in detail below.

A. Preparation Phase.

The Preparation Phase comprises of three steps: Engineering, Setup and Create Jobs. Engineering (diagonal element 3.0) is the process of reviewing the Specification Document for completeness to determine the required Setup, if any. Setup (diagonal element 4.0) is a one-time task (per new Part type) of equipping the Software Factory and preparing the Assembly Lines to meet the requirements of the Specification Documents. Finally, the Create Jobs (diagonal element 5.0) process decomposes a Specification Document into a sequence of parts that can then be categorized into Job Types that flow through the factory as parallel and dependent Jobs to be assembled in the Assembly Phase.

As will become apparent from the discussion to follow, to satisfactorily produce a Final Product, the Software Factory should have sufficient assets to perform the requisite functions. Preferably, these assets include, but are not limited to a configurable Assembly Line and a Reference Library having content related to the Target Software Product to be used to create the Final Product. In the case of a new or minimally facilitated Software Factory, each Part type is considered a new one and the setup process may be used to actually start the process of creating the factory by providing the necessary Assembly Lines and producing or enhancing a Reference Library having content related to the target product software and a plurality of Job types associated with the target product software. The setup function discussed below addresses this subject matter.

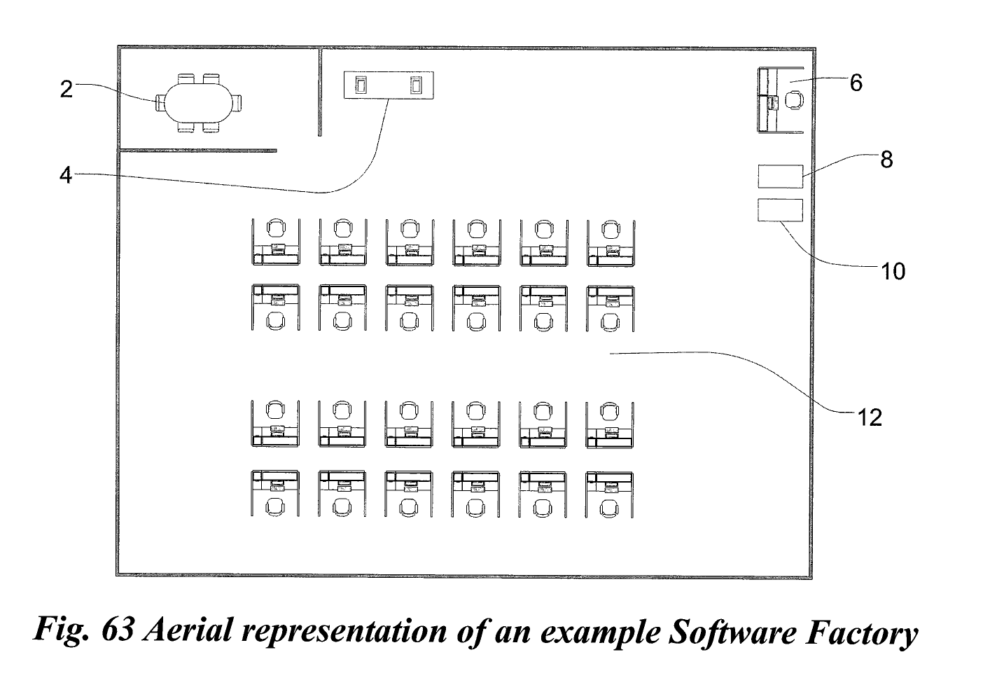

As a precursor to the preparation phase, the existence of a virtual or physical facility having certain fundamental capabilities is desirable. Such capabilities may include, but are not limited to, capabilities for collection and management of documents (electronic and/or physical), as well as some mechanism of communication (electronic email or physical communication). Certain electronic devices such as computers are should also be available. FIG. 63 shows a plan view of one possible configuration for such a Software Factory facility. In the figure shown, a location is provided for conducting engineering in a discussion/conference setting. Additionally, it is preferable for the capabilities to include some scanning stations for the electronic capture of physical drawings or pictures. A set of Assembly Stations are shown as desks with computers on them. It may be advantageous to have a supervisor station that overlooks the Assembly Stations (if humans are involved in the direct operation of the factory). FIG. 63 also illustrates the possibility for a production control server (which hosts a software application that performs the (6.0) production control function described in this disclosure). Furthermore, a storage server is also indicated, which may be used to store Reference Libraries, manuals, and even electronic versions of the Jobs processed by the Software Factory.

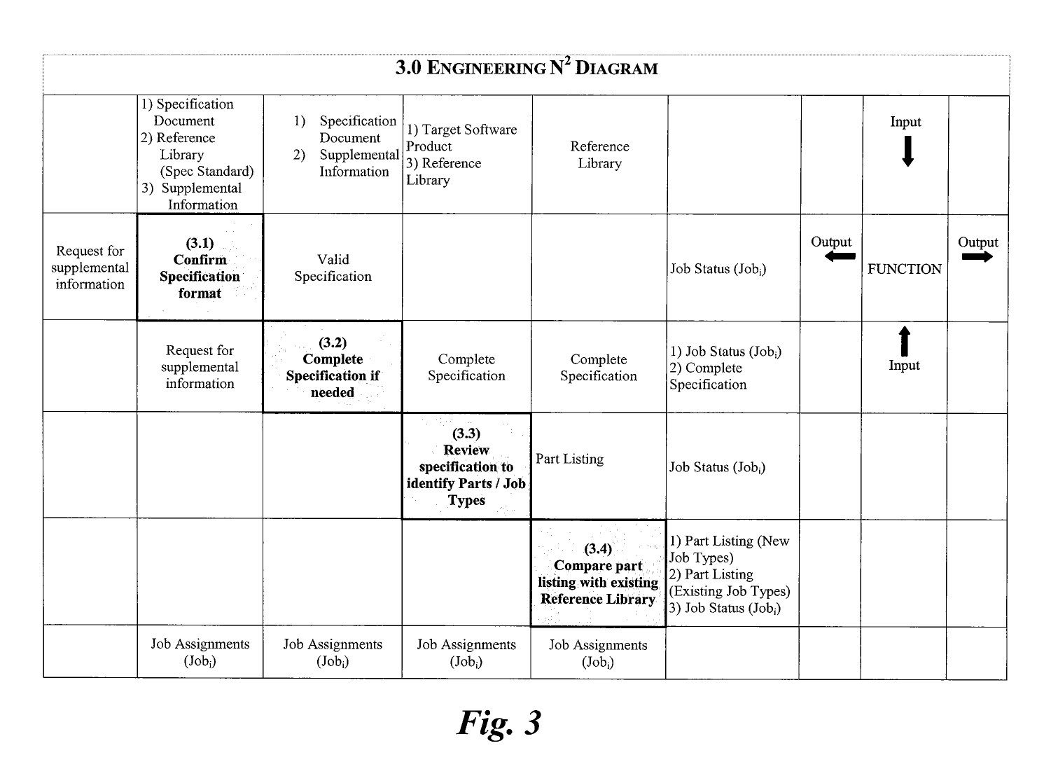

An N² diagram for the Engineering function (diagonal element 3.0 of FIG. 2) is shown in FIG. 3. The engineering function analyzes the specification and determines the capabilities of an existing facilitized Software Factory and what setup, if any, needs to be done for those parts that cannot be assembled with the existing factory. The Specification Document is delivered to the Software Factory's Engineering process from the Requirements Development Phase. Preferably there is interactive communication between the provider of the Specification Document and the engineering function of the software manufacturing process. This allows for an iterative process that culminates in the document being provided to the factory in a desired form and at a desired level of completeness. If it is not provided in the desired form or level of completeness, the deficiencies are addressed during the Engineering process through the issuance of requests for supplemental information. The result of these requests is additional information in the form of specification documents that are provided to the engineering function.

The Engineering function creates a Part Listing based on the specification document. The Part Listing comprising a plurality of parts, each Part associable with a Job type of a plurality of Job types. More specifically, the Part Listing is a list of the parts of the application and the type of Part that it is. For each Part evaluated, a decision is made as to whether an existing Job Type applies or whether a new Job Type should be defined. A Job Type is a type of unit of work associated with a Part and as such is a classification of a Job and applies to the given part. The decision on whether a Job Type exists or whether a new one needs to be created is made by choosing the Target Software Product for each Part. The Target Software Product is the productivity tool that will be used to create the Part. The Target Software Product for each Part is either designated within the specification document or is determined by the Engineering function by mapping the capabilities required by the Part against the Reference Library.

Referring to FIG. 3, the engineering function comprises the following sub-functions: Confirming Specification Format (diagonal element 3.1), Completing Specification if needed (diagonal element 3.2), Reviewing the specification to identify the parts/Job types (diagonal element 3.3), and finally Comparing parts listing with the contents of the existing Reference Library (element 3.4).

The confirming specification format sub-function receives as an input a Specification Document from the Requirements Phase function discussed above and determines if the Specification Document is in a valid format such that it can be processed by the remaining steps in the Engineering function. This determination is accomplished by comparing that Specification Document against another input which is the Software Factory Reference Library. The Reference Library may include a specification template or standards section that indicates the expected specific layout of each section within the specification document and furthermore what subsections should be contained within each section.

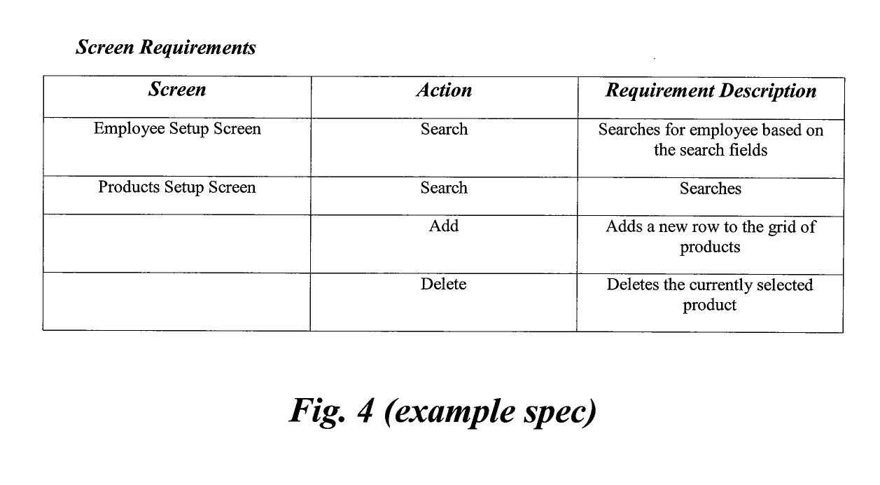

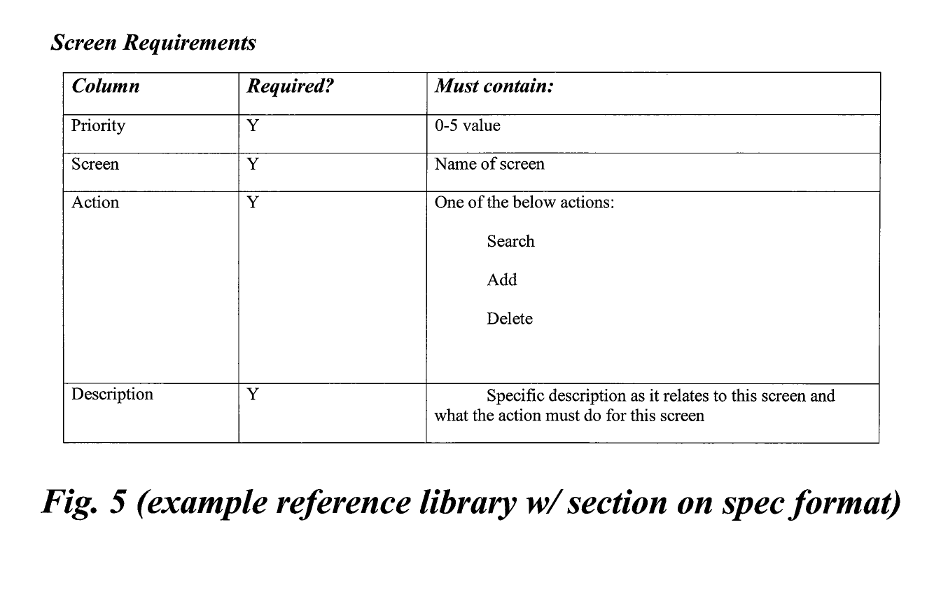

A partial example of a Specification Document is shown in FIG. 4. The example shown is directed to screen requirements and represents one section of such a Specification Document. An example of a Reference Library template containing information on a desired format for the example specification screen requirements specification is shown in FIG. 5. After the Specification Document is compared against the expected standard in the Reference Library, the validity of the Specification Document may be established.

If certain sections of the Specification Document are not in compliance with the Reference Library template or standards, requests may be issued back to the Requirements Development phase for clarification or retooling of the specification. These requests are called Requests for Supplemental information. Those portions of the specification that are deemed valid are called the “Valid Specification” and are provided as an input to the next step, Complete Specification if needed (3.2).

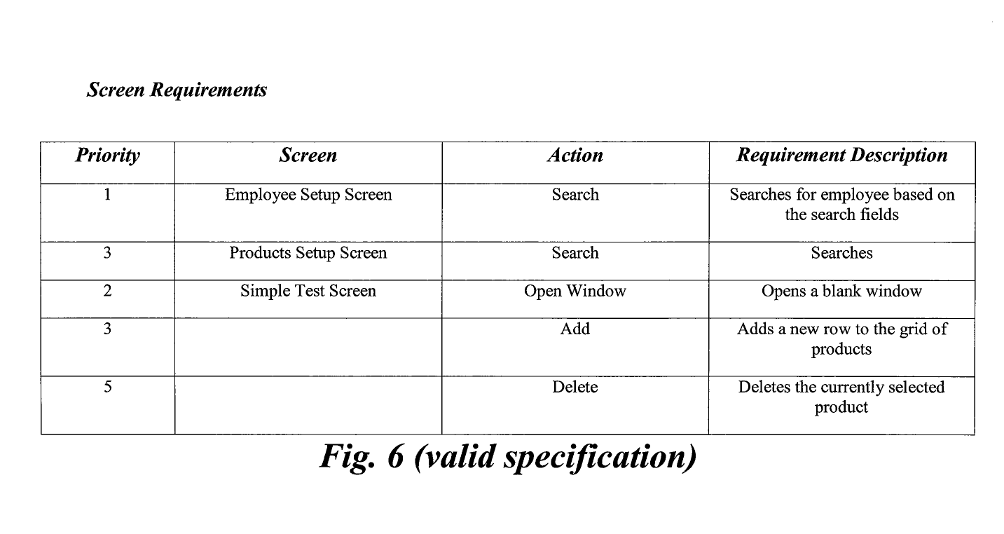

As an example, the specification shown in FIG. 4 is invalid because it contains a different set of sections within the group called “Screen Requirements”; specifically, the “Priority” column was not provided in the table. The expected table format shown in FIG. 5.0 is indicated in the Reference Library. After issuing a request for fixing this section back to the Requirements Development phase and receiving the supplemental information, a Valid Specification is now provided containing the correct structure (see FIG. 6).

A Specification Document may be valid, but may still not contain the information needed to assemble the end Deployed Finished Application. Accordingly, the next step in the Engineering function is called “Complete Spec if needed (3.2).” This step is used to fill in the missing information so that ultimately the Software Factory has the information needed to assemble the Deployed Finished Application from the specification.

The “Complete Spec if needed” sub-function takes a Valid Specification as one of its inputs, and a Reference Library as another of its inputs. The Reference Library contains requirements regarding the type of information that should be covered in each section in a Valid Specification Document. The requirements indicated by the Reference Library are compared with the content provided in the Valid Specification Document. If information is deemed to be missing based on this comparison, a set of requests may be generated back to the Requirements Development phase. Information is provided in pieces back to the Complete Spec sub-function if needed (or the Confirm Specification Format Step) and through this cyclical process the Specification Document is completed. Those portions of the Specification Document that are complete are then called the “Complete Specification” which is provided as an input to the next sub-function of the Engineering function.

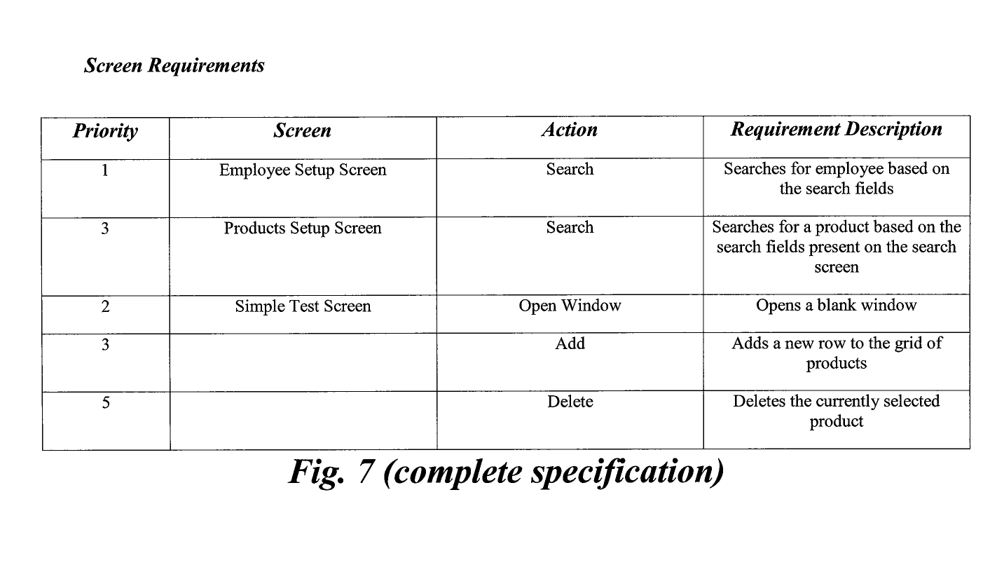

Consider the example of the Valid Specification discussed above and shown in FIG. 6. Reviewing the information found in the Reference Library Example (FIG. 5), it can be seen that under the field “Requirement Description” that a “Requirement Description” should contain information about a specific functionality on a screen. Checking the Valid Specification Document against this, it is seen that the information provided in “Requirement Description” does not relate to a specific screen, and as such the specification is not complete. After issuing a request to clarify the information, information is provided back to this step with a complete “Requirement Description”. This information is used to update the Valid Specification so that it can become the “Complete Specification.” The example “Complete[d] Specification” is shown in FIG. 7. The “Completed Specification” is now provided to the “Review Specification to Identify Parts/Job Types” sub-function of the Engineering function.

The “Completed Specification” is analyzed by the “Review Specification to Identify Parts/Job Types (3.3)” sub-function, in conjunction with a Target Software Product to produce a Part Listing. Ultimately the Part Listing becomes the list of Jobs or tasks that need to be implemented by the Software Factory so that a Deployed Finished Application can be produced.

The “Review Specification to identify parts/Job types” sub-function receives as an input the “Complete Specification” and using the Reference Library and the list of Target Software Products, creates a Part Listing. The Reference Library provides the information on how the Complete Specification Document may be partitioned into a specific set of Parts.

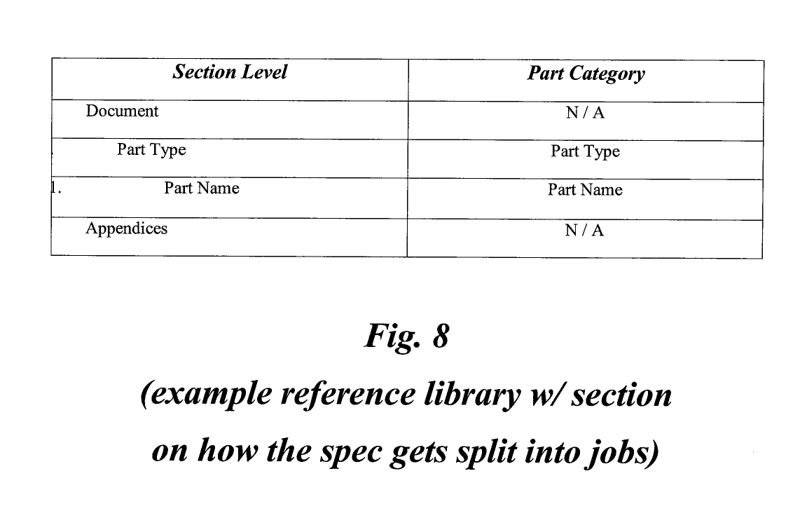

An example of the Parts rules are shown in FIG. 8. As is shown in FIG. 8, a specification document may be structured into an outline format and certain levels of the structure may indicate a Part definition. More complicated mappings are possible; however, the Part rules will typically need to be created by experienced individuals. It is anticipated that machines with machine learning capability may observe the deconstruction of a specification document into a set of Parts and therefore “learn” rules for conversion of specification documents into Parts. Each of these Parts is a distinct unit of work (or Job) that may be operated on separately and in many cases independently of the other parts.

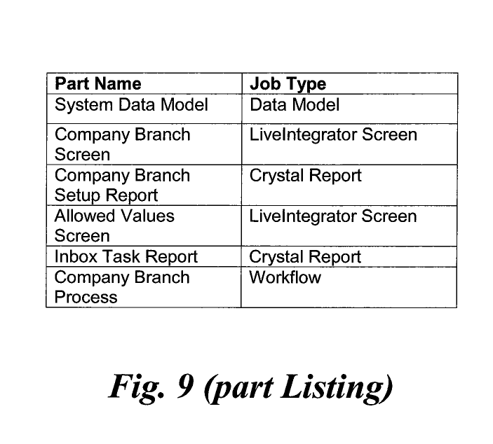

An example of the Part list produced from the example Complete Specification Document that was shown in FIG. 7, is shown in FIG. 9. Note that each Part listed in the Part Listing references a Job Type. This Job Type ultimately indicates how that Part will be assembled in the Software Factory. The Job Type is also determined through the rules implied by the Reference Library. The “Part Listing” is submitted as an input to the next sub-function of the Engineering function which is called “Confirm Part Listing with Existing Reference Library.”

The “Part Listing” is an input to the “Confirm Part Listing with Existing Reference Library” sub-function along with the Reference Library. This sub-function consults the Reference Library to determine if the Software Factory is setup to process each of those Parts listed in the Part Listing. The Part Listing that was provided as input to this sub-function is then translated into two listings, one is the “Part Listing (New Job Types)” and the other is the “Part Listing (Existing Job Types)”

The Confirming Part Listing sub-function is performed by analyzing each distinct Job Type listed in the Part Listing. A lookup is performed on the Reference Library for each Job Type/Target Software Product combination. If the necessary components for that Job Type are found to exist in the Reference Library, that Job Type is placed on the “Part Listing (Existing Job Types)” list. If the necessary components are not found it is placed on the “Part Listing (New Job Types)” list. If it is the case that this is a new Software Factory and no existing Reference Library exists, each Job type will be placed on the “Part Listing (New Job Types)” list.

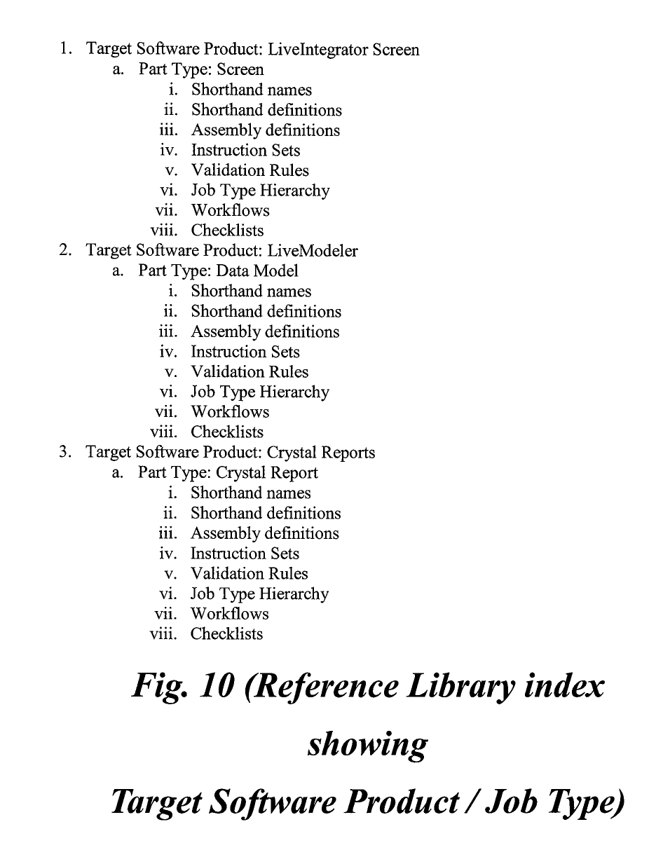

Consider the example of the Part Listing shown in FIG. 9. Consider the scenario where that Part Listing is compared against an example index provided in a Reference Library shown in FIG. 10. In this example the only Job Type not found in the index is “Workflow”.

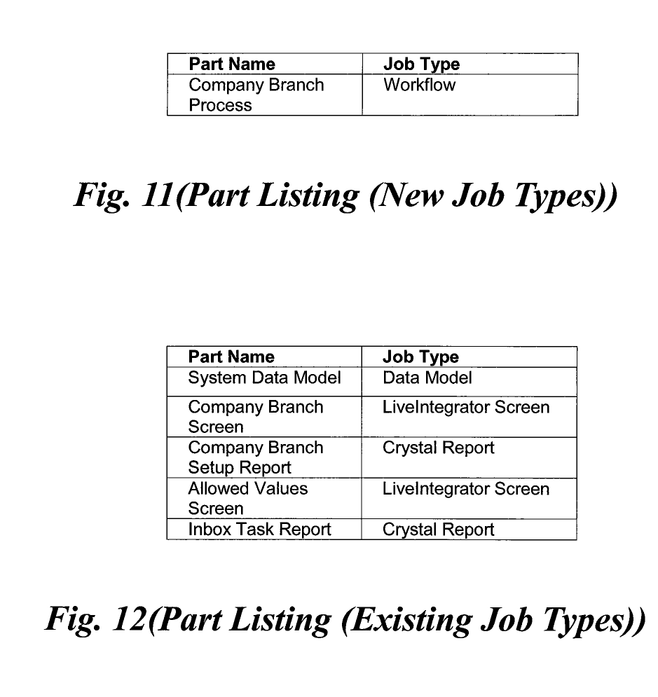

As such, those Parts with this Job Type would go on the list “Part Listing (New Job Types)” (shown for this example in FIG. 11). The remaining Parts in the Part Listing would be added to the list “Part Listing (Existing Job Types).” (Shown for this example in FIG. 12). The “Part Listing (Existing Job types)” is supplied as an input directly to the “Create Jobs” function whereas the “Part Listing (New Job Types)” is supplied as an input to the Setup Function.

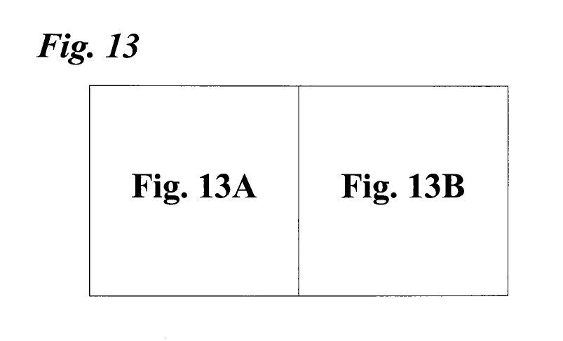

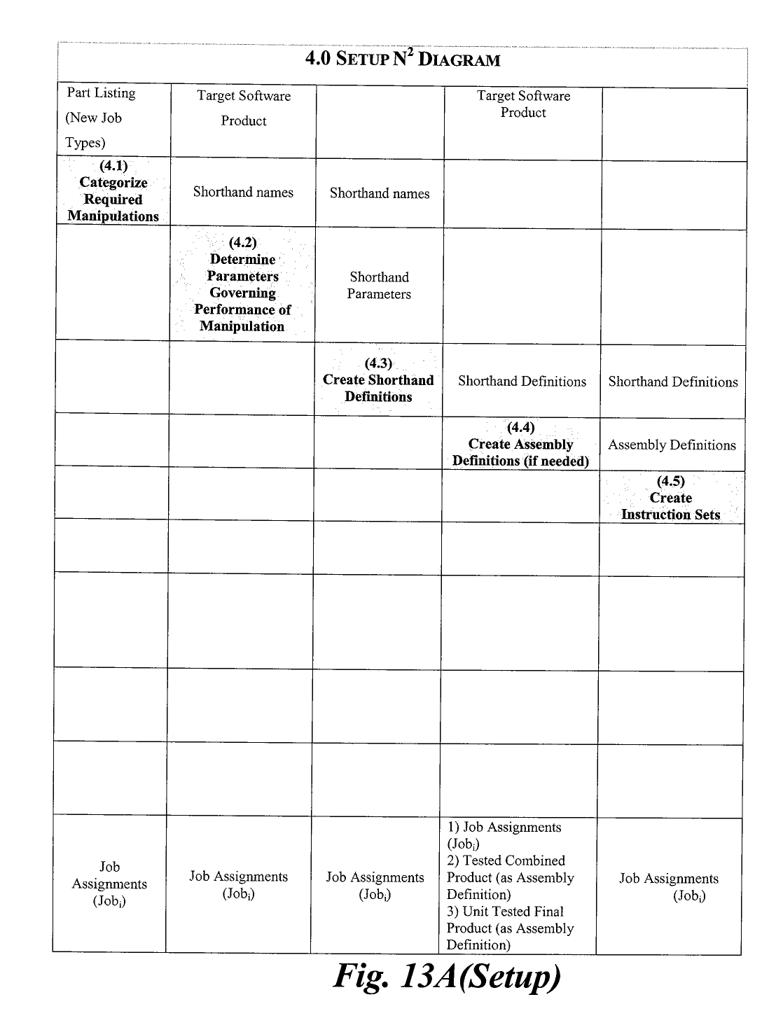

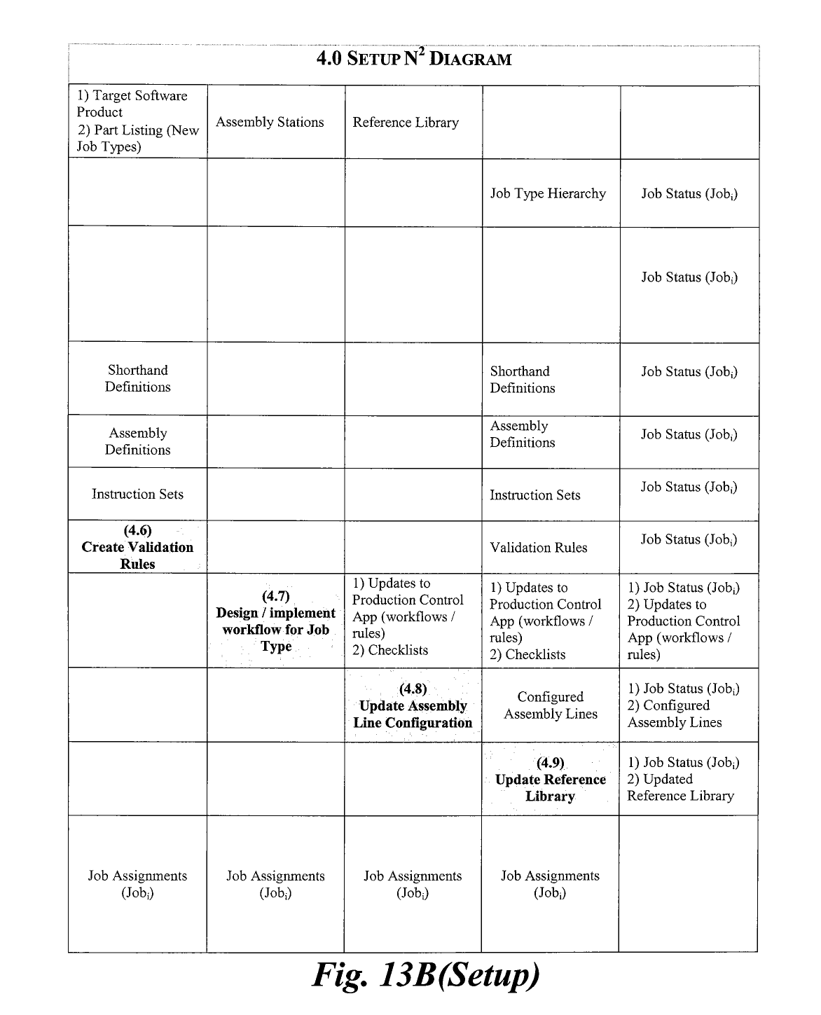

An N² Diagram for the Setup Function (diagonal element 4.0 of FIG. 2) is shown in FIG. 13. The Setup function sets-up (or creates) within the Software Factory a software manufacturing environment having the necessary components or features to produce a Deployed Finished Application from a Specification Document. Setup can be considered a “one-time” task and may only be needed for a new Software Factory, or when new Target Software Products or new Job Types are used in the factory or new features of the Target Software Products that have not been utilized in the past need to be assembled through the factory. Parts are assembled through the factory by using a process (described later) called Encoding. This process results in a Schematic which can then be used to assemble the desired output.

The Setup function operates on each new Job Type referenced by the “Part Listing (New Job Types)” and creates for each Job type, the components needed in the Reference Library so that Parts of this Job Type may be assembled in the Software Factory. If the Setup function is completed for a given Job Type, and after this, such a Job Type is listed on the “Part Listing” output of the “Review specification to identify the parts/Job types (3.3)” step in the Engineering function (3.0), it will end up on the “Part Listing (Existing Job Types)” output of the “Confirm Part Listing with Existing Reference Library (3.4)” step (as the necessary setup has already been performed and the Software Factory is now equipped to work with that Job type).

The first sub-function to be performed by the Setup function is to “Categorize Required Manipulations (diagonal element 4.1)”. This sub-function is performed for each of the Job Types referenced by the “Parts Listing (New Job Types)” input. The allowable manipulations are categorized so as to allow the creation of a “Shorthand Definition.”

The Shorthand Definition is used to allow for an efficient and consistent performance of the Encoding process and production of the resultant Schematic of a Part by an engineer for the purpose of assembly of the Schematic by an Assembler. An assembler is a person, or piece of automation, that may play the role of an Assembly Station or multiple Assembly Stations in the Software Manufacturing Process.

A consistent Schematic provides for a consistent final result or output. In addition to the production of the “Shorthand Definition”, a “Job Type Hierarchy” is produced. The “Job Type Hierarchy” is used for situations where a given Job type is a product of a set of other Job types. Jobs may be combined based on the type of output required. The process of combining the Jobs is no different than the process of creating a single Job like a Report or Screen. The combination Job is a set of Jobs.

For example, consider a Business Application containing Screens, Reports, Workflows and Interfaces. First, the EAGuide for a Business Application is used to Encode the Job and then the Job is Constructed from the Encoding. This way Jobs can be combined to produce much larger outcomes utilizing an embodiment of the present Invention.

It is common that one software solution may consist of several systems or interrelated application, each such application then consisting of Modules or logical sections of functionality, and each such Module consisting of Units as described above. One can see that in these cases, any one of these items (the full solution, an individual application, a given Module and the Units within a Module) may be processed through the factory as a single Job. Jobs may be designed to be independent or dependent upon one another. It is the function of an individual Software Factory to define the relationships between the Job Types and orchestrate the Assembly Lines to make most efficient usage of the resources. This concept of sub Jobs or Assembly is analogous to the concept of manufacturing an air conditioner for an automobile.

The air conditioner may be a sub unit of an automobile, but may go through its own Assembly Line that results in the Final Product. This is commonly referred to as a subassembly or assembly or part. This unit may then be a component that is put into the automobile as Part of the overall Assembly Line that results in the completed automobile.

Likewise the Business Application Job is the process of producing the overall application from the completed units which have already been processed through the factory. Such a Job may have steps that include pulling together the completed Units, creating a main menu that controls the invocation of the Units during run time and testing those units together as a combined Unit.

The “Categorize Required Manipulations (4.1)” sub-function is performed through analysis of a Target Software Product and the subsequent determination of the allowable manipulations of that Target Software Product so as to produce meaningful results. The allowable manipulations of the Target Software Product are categorized into objects or sub-units and in a later step, for each sub-unit, that manipulation is evaluated to determine the parameters that govern how that manipulation is performed.

Consider the example of a Target Software Product used to build or layout screens. This step may categorize the allowable manipulations in such a way that a “Shorthand Definition” may be later defined. In this example, multiple sources of information may be used in the process of categorizing the allowable manipulations. Product documentation (or help documentation), experts with knowledge of that Target Software Product and feature listings are some possible resources for this exercise.

Some possibly allowable manipulations of this example Target Software Product could be categorized with names such as “Save a screen document”, “Add a text field to a screen document”, “Add a checkbox to a screen document”, “Add a viewer to a screen document”, and “Add a button to a screen document”. Some of these allowable manipulations are manipulations that entail adding or configuration some attribute of the resultant document of the Target Software Product, and some are manipulations that do not directly affect the configuration of the resultant document. Although exceptions are possible, in most cases it is preferable to only list those items that directly affect the configuration of the resultant document.

In the example being discussed, the Target Software Product is used to create screens. As such, the resultant document is a screen document that persists the state of the screen being assembled. Therefore all of the manipulations listed in the example, with the exception of “Save a screen document” are possible candidates for the creation of Shorthand Names. Further detail regarding creation of screens is disclosed in U.S. Pat. No. 5,583,983 issued Dec. 10, 1996, incorporated herein in the entirety by reference.

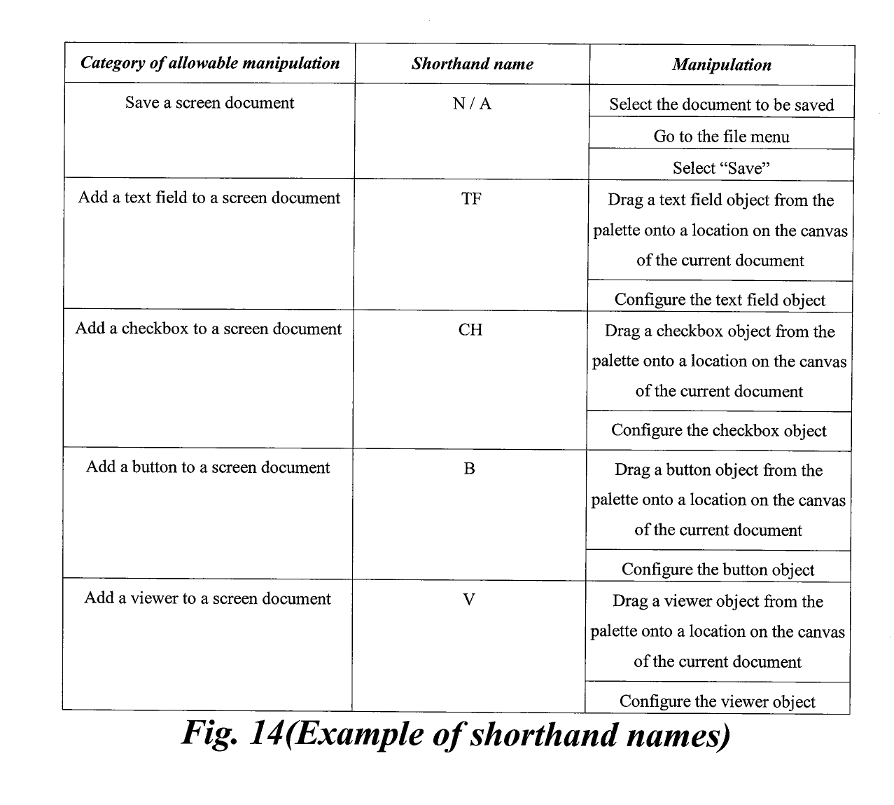

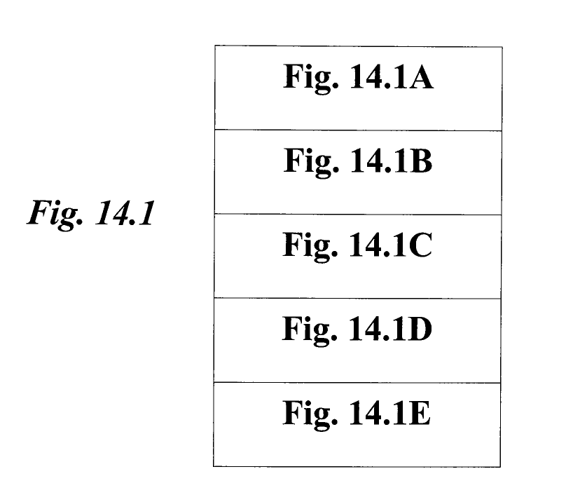

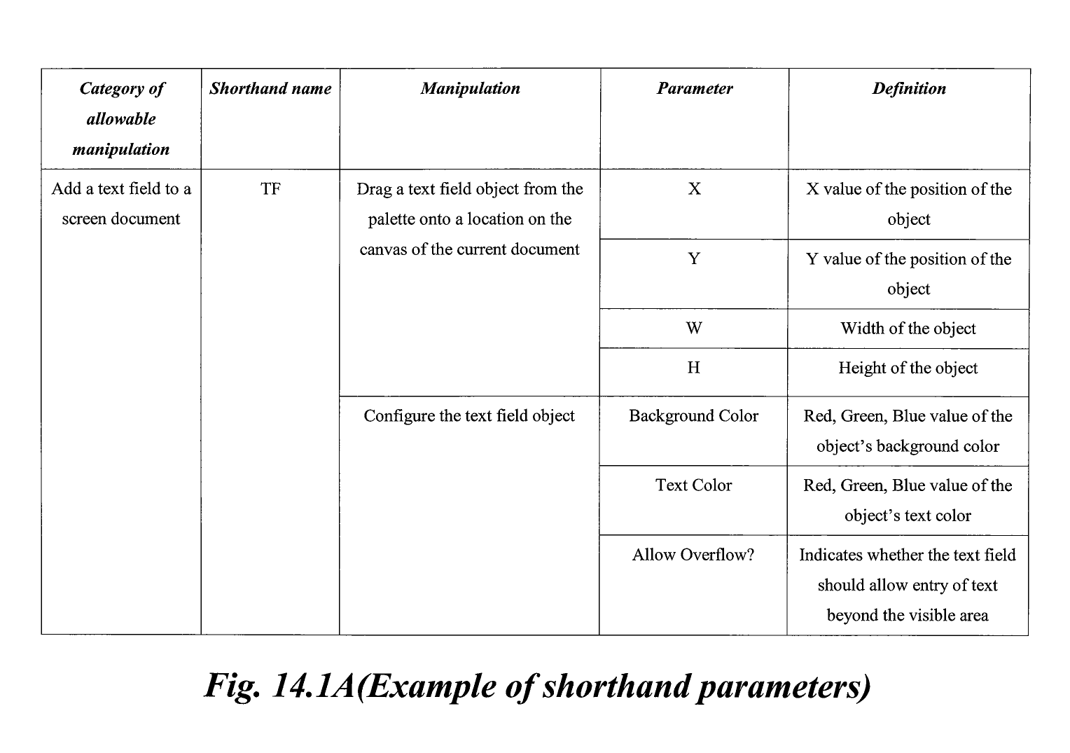

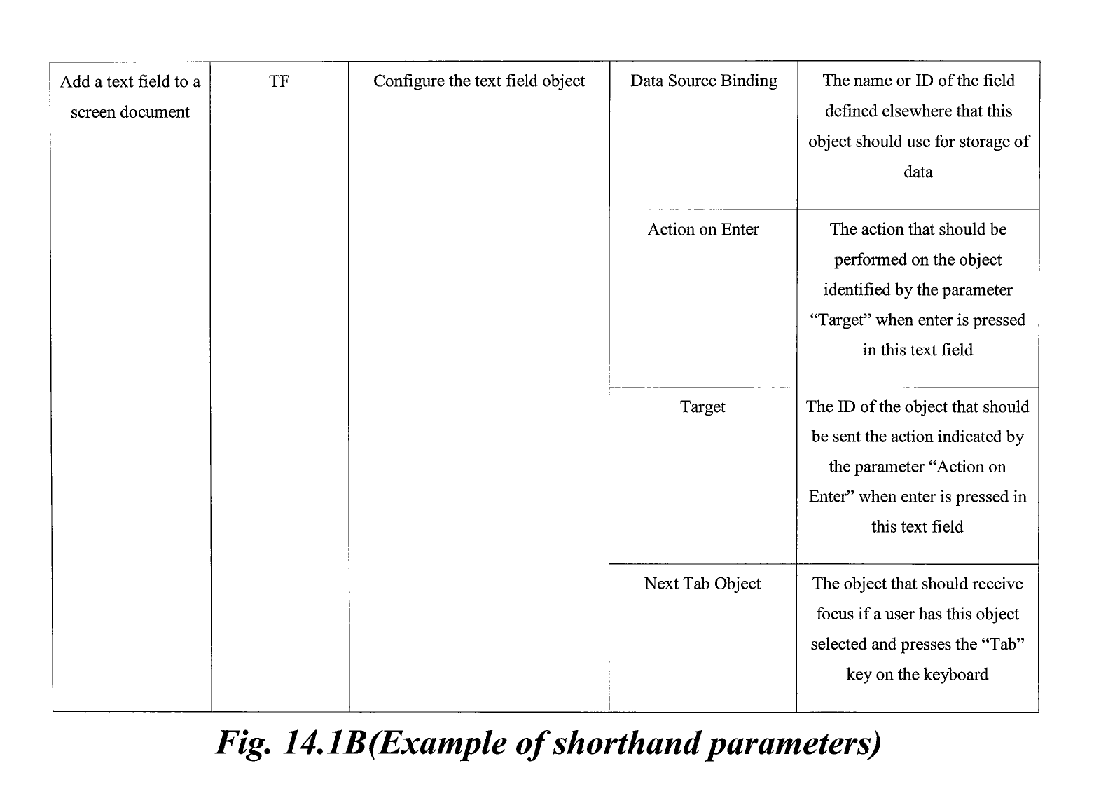

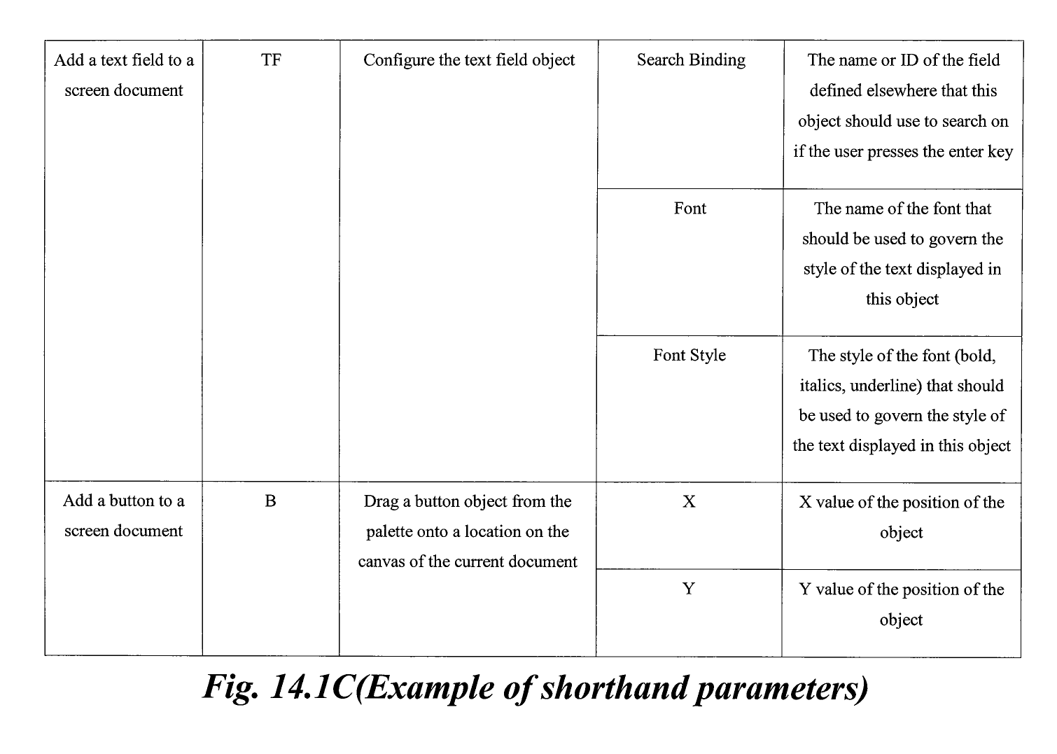

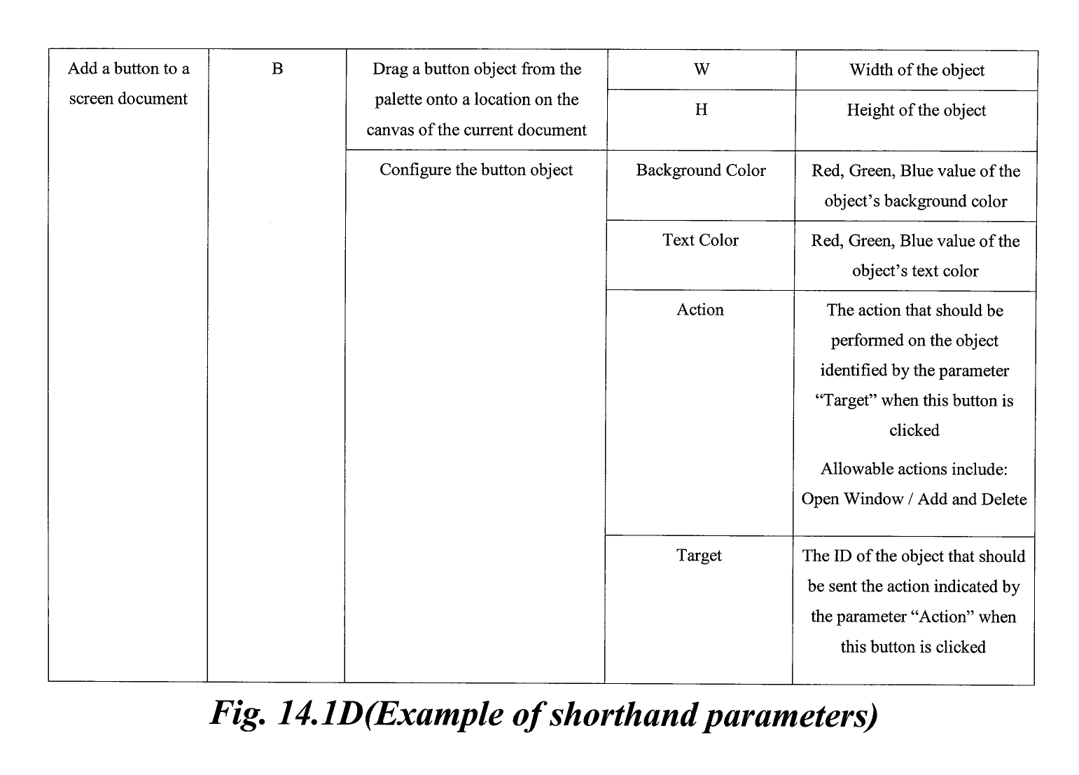

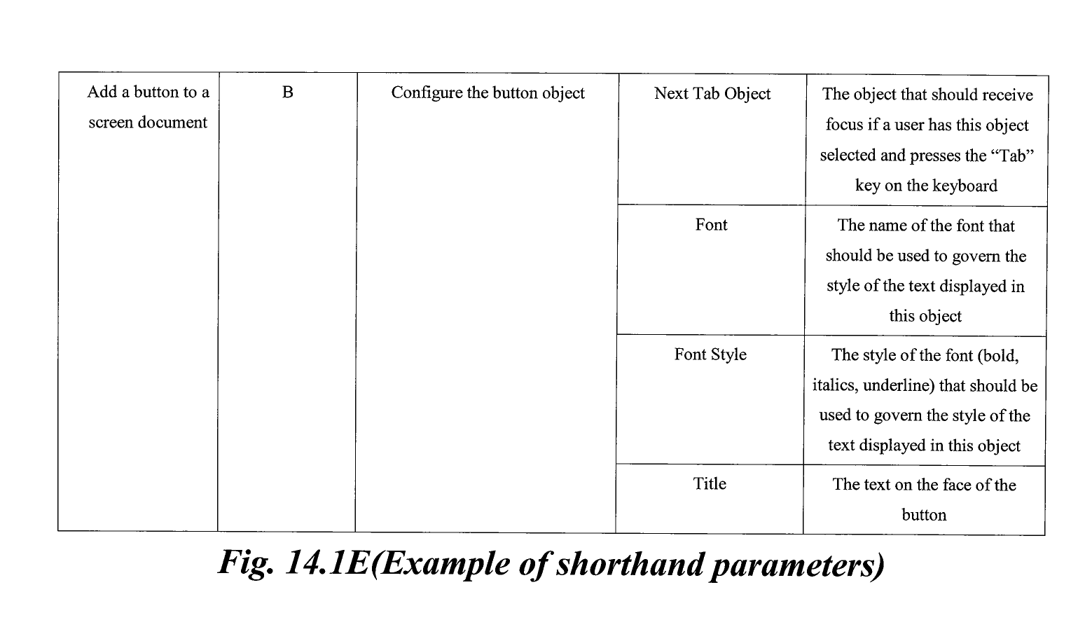

A shorthand name may be created simply by abbreviating the name of the object. For example, “Add a text field to a screen document” may result in “TF” (and so on). The specific shorthand name is of no consequence except that it should be short and its meaning should be associated with that category of allowable manipulation of a specific Target Software Product. The output of this step, the “Shorthand names” for the example discussed here are shown in FIG. 14. Likewise, in the case of an existing Target Software Product that has a feature for which a Shorthand Definition is not yet defined, that feature may be considered a new allowable manipulation and the same process to create the Shorthand Definition may be used.

The manipulations for each of those categories identified could be parameterized. As an example, consider the case of “Add a button to the screen document”, the location of the button, the style of the button, the size of the button, and the behavior of the button are some examples of the parameters that could be added. Those parameters may later be mapped into a simple grammar or syntax which becomes the Shorthand Definition . . .

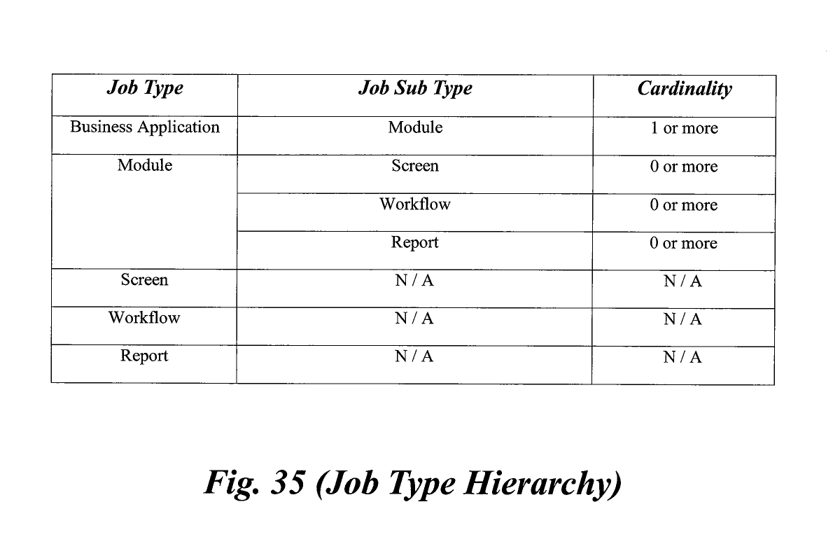

As was mentioned previously, in addition to Shorthand Definitions, the Categorize Required Manipulations sub-function may produce a “Job Type Hierarchy.” In the case where a given Job is a product of a set of other Jobs, such a hierarchy may be used. Consider, for example, a situation where a business application Job type is being submitted to this step as a new Job type. In this example a business application is made up of one or more modules, and each module contains one or more components. This may be represented in an output called “Job Type Hierarchy.” An example of such an output is shown in FIG. 35. This matrix of Job Types and their Sub types is used in the Production Control function (see diagonal element 6.0 of FIG. 2). Specifically this output is the input to the “Combine Job if needed” step.

The “Determine parameters governing performance of manipulations (” sub-function (diagonal element 4.2) is the next step in the setup process. This step continues toward the production of the Shorthand Definitions through the creation of the “Shorthand Parameters” associated with the Shorthand Names.

The “Shorthand Parameters” are created by reviewing each of the Shorthand Names (an input to this step) produced as an output form the Categorize Required Manipulations sub-function discussed above and by identifying what the allowable and relevant parameters are for manipulation implied by each Shorthand Name.

For example, consider the Shorthand Name “T” described in the previous step and listed in the Shorthand Names output (FIG. 13). The Shorthand Name “T” was defined as the manipulation of a Target Software Product that comprises dragging a text field onto a canvas and then subsequently configuring it. These two steps, 1) placement of text field onto canvas and 2) configuration of text field, may be parameterized based on the feature set of the Target Software Product. For this example consider the first step of placement of the text field onto the canvas (screen). The parameters that govern this operation are the X and Y location of that object. In the example of the Target Software Product, after the object is placed by the user onto a specific location on the canvas, a set of “handles” or icons may appear around the object, specifically for the sizing of that object. In this case, it is logical to associate Width and Height parameters with the same operation.

For the second step in the example, the parameters can be identified for the subsequent configuration of the text field object by reviewing the property inspector for that object. Further detail regarding inspectors is disclosed in U.S. Pat. No. 7,168,068 issued Jan. 23, 2007, incorporated herein in the entirety by reference. In FIG. 14, two of the Shorthand Names from the Categorize Required Manipulations sub-function have been detailed to show the Shorthand Parameters output. Some parameters are the same between the T and B shorthand names and some are different. A description of the parameter is provided; while this is not required, providing a description is preferred, as it makes the subsequent steps easier. In some cases all of the parameters will be explicitly identified in the Schematic, and in other cases, the nature of the Schematic will imply certain parameters. The details of how this works are described in the next step.

Shorthand Definitions are the information needed for authoring of a Schematic. The level of information provided in the specification influences how the Shorthand Definitions are created. If the specification provides a Partial Schematic as a starting point, the Shorthand Definition may include a simpler set of parameters, as some of these will already be implied. Using the shorthand names and shorthand parameters that were produced in the previous two sub-functions as inputs, the “Create Shorthand Definitions” sub-function (diagonal element 4.3) transforms those inputs into a more specific set of Shorthand Definitions that define the valid syntax of the Schematic.

The Create Shorthand Definitions sub-function provides an Encoding methodology (or set of the rules) that may be used to encode a “Shorthand” for the manipulations of a given Target Software Product that are required to produce the desired output. This encoded “shorthand” is a Schematic that provides the information needed to implement the Job. In some cases, a complete or partially complete Schematic may be available in the Specification Document. In those cases, it is preferable for the Shorthand Definition to be defined from this point forward, thereby incorporating the parameters of the manipulation already defined by the Schematic found in the specification document as a given input, and making these parameter values implicitly Part of the Schematic.

An example of a situation where a partially complete Schematic is available in the specification document is now described. In some cases a mockup of a screen may be used to describe the screen in a way that is presentable in the Specification Document. That mockup may be considered a partially complete Schematic and may be used as a baseline for the Encoding process of the actual screen. Furthermore, that mockup (or partial Schematic) may in some cases exist as a static version of a screen that, when being assembled by an assembler (per a given completed Schematic) is a starting point. Such starting points may simplify the Encoding process, or in the above described case, may not only simplify the Encoding process, but may also simplify the actual assembly process.

In the creation of partial Schematics for a specification document, a set of tools and templates may be utilized for Specification Document creation. Such tools and templates are designed to automate the Encoding process at various levels. For example, a tool for designing screens may be used to create mockups (or partial Schematics) that may be placed directly into a Specification Document. As a further example, a template driven process for describing the data attributes of a system or business need may become a baseline for a Schematic for a data model part. Such tools and templates, while not necessary for the Software Factory, simplify the Encoding process, and may produce the Schematic for the assembler, or may produce the resultant Software Manipulation directly from the Specification Document. In cases where mockups (or partial Schematics) are used, it is preferable for an Engineer to create the full Schematic (based on the Shorthand Definition) by writing text on the mockups, augmenting the mockups to provide the full information necessary for an Assembler to execute the Software Manipulation, thereby creating the full Schematic.

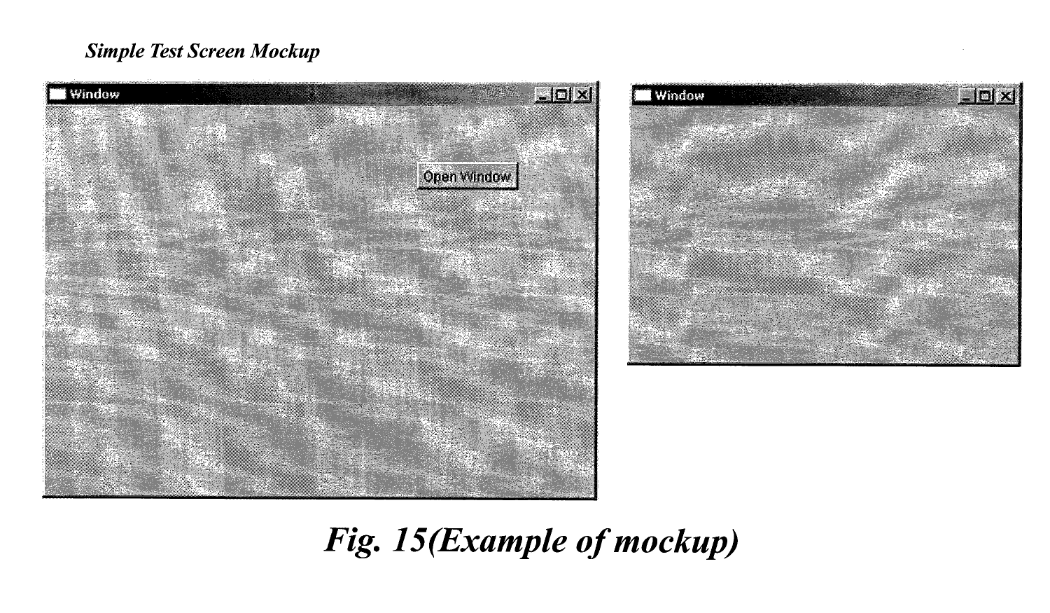

Consider the process of creating a Shorthand Definition for the Shorthand Name “B” described above. This may be accomplished in a variety of ways. For illustrative purposes, two possible ways are discussed below . . . In a first scenario (referred to as the No Schematic scenario), the Specification Document provides only a textual description of a screen, representative requirement descriptions for which are shown in FIG. 7. The specification document provides no Schematic or any Part thereof whatsoever. In a second scenario (referred to as the Partial Schematic scenario), the Specification Document also provides a screen shot or mockup of the screen as shown in FIG. 15.

In the No Schematic scenario, the screen could be created in a variety of completely different manners depending on the approach chosen by the designer of the screen.

The preferred specification document for the Software Factory includes parts that are defined with partial Schematics, that is, those with enough detail to produce a consistent and desired output from the Software Factory.

In both the No Schematic scenario and the Partial Schematic scenario, one desired output is a screen with one button on it where that button, when pushed, opens another window. In scenario, the button object needs to be encoded. The parameters that govern how the manipulation is to be performed by the assembler to achieve the completed button were listed in the Shorthand Parameters in the Determine Parameters sub-function discussed above.

In the Partial Schematic scenario, because the specification contains a mockup or visual representation of the screen (partial Schematic), some parameters (X, Y, W, H, Background color, Text color, Font, Font Style and Title) are not needed as Part of the Shorthand Definition; they are implicitly defined by the partial Schematic. If a partial Schematic is the starting point for the Encoding step discussed below, the parameters associated with the partial Schematic, such as the size and location (X, Y, W, H) of the button and the text on the button (Title) and other visual attributes (Background color, Text color, Font, Font Style) may be eliminated for the Shorthand Definition as they are implied by the mockup. In that case, the Encoding step performed by the Engineer may be written directly on the mockup, augmenting the partial Schematic and thereby providing the Assembler with the full set of parameter values (in the form of a full Schematic) preferred to perform the software manipulation.

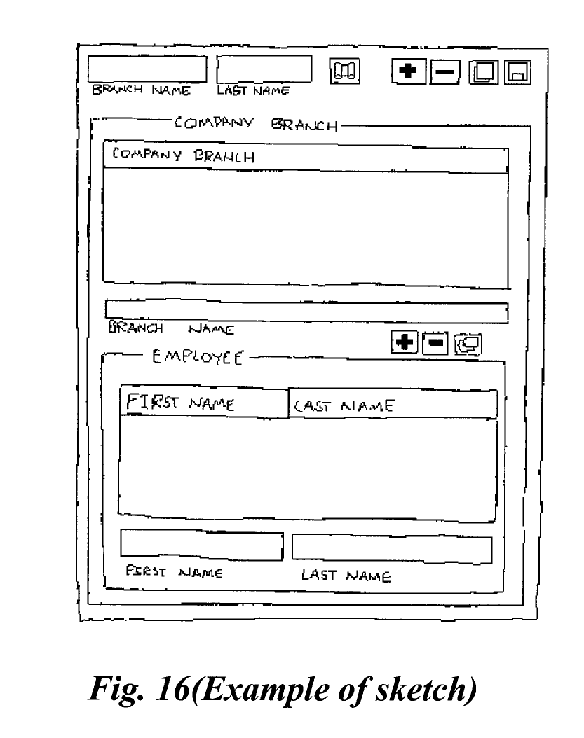

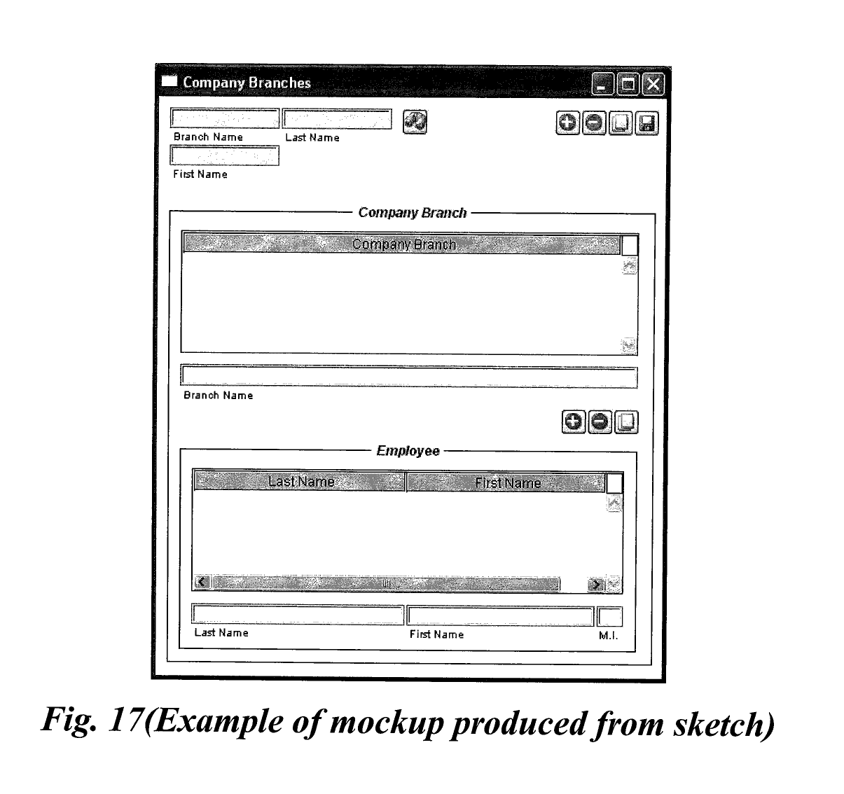

In a preferred embodiment of the invention, the specification contains a partial Schematic. In this case, if the partial Schematic is not completed, it may be completed as Part of the Engineering process prior to continuing with the setup function. Preferably, the partial Schematic may be completed by returning the uncompleted parts of the specification to the customer or by working with the customer to complete the partial Schematic. It should also be noted, that the partial Schematic may be completed by the Software Factory. The output of the factory is not limited to computer understandable specification documents; hard copy Specification Documents may be used as well. For example, if a hand written sketch (FIG. 16) is provided, a screen mockup (which is the partial Schematic) (FIG. 17) may be returned.

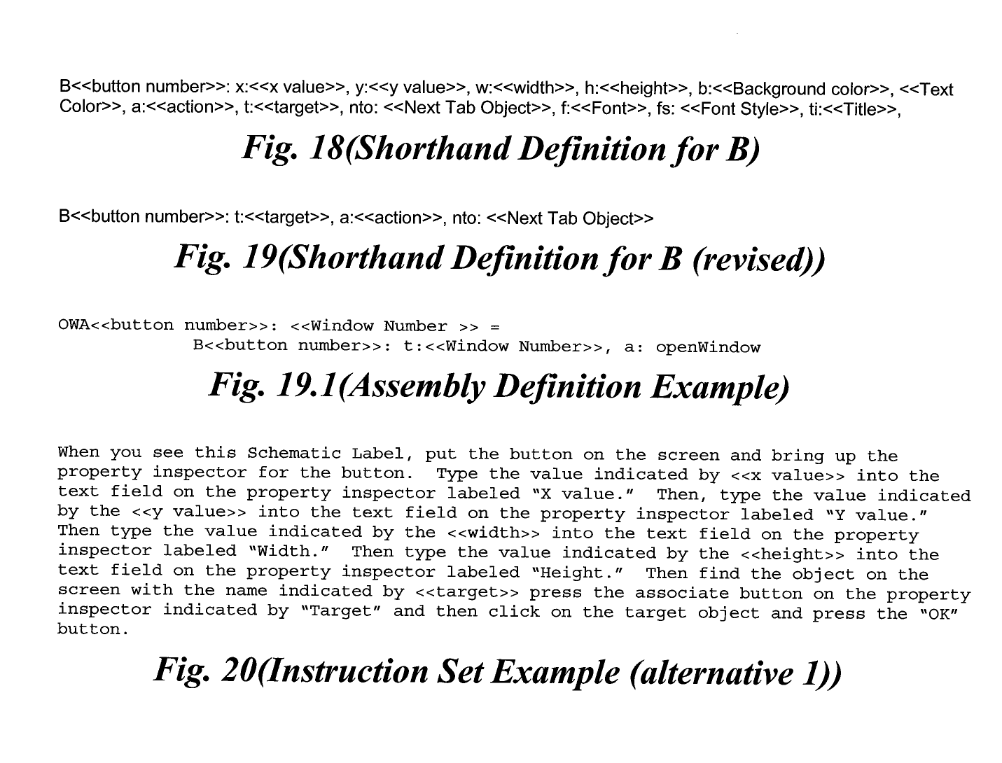

A Shorthand Definition, the output of the Create Shorthand Definitions step may be represented in a variety of forms. One such form is given in FIG. 18, although other formats for grammars known to those skilled in the art such as BNF (Backus-Naur form) may also be used. In FIG. 18, the Shorthand Definition is defined with all available parameters. If the specification includes a partial Schematic (in this case a visual mockup of the screen), then the Shorthand Definition may be appear in a more limited form, given that the remaining parameters may be discerned from the partial Schematic (mockup). Such a limited form Shorthand Definition is shown in FIG. 19.

In both of the above Shorthand Definition, a definition style was used whereby the symbol <<value>> indicates that a parameter value may be inserted at that point. As previously stated, any Shorthand Definition style may be used to define the Shorthand Definition for a given manipulation. Although the various embodiments of the Software Factory of the present invention are not limited to any particular style, it is preferable to maintain a consistent Shorthand Definition style throughout the factory.

The output of this Create Shorthand Definitions step is the Shorthand Definitions. The Shorthand Definitions provide the information needed for the Software Factory to create Schematics for the Parts in question.

As each Job Type on the Part Listing (New Job Types) is processed through this step, the Shorthand Definitions are created and placed into the Reference Library. The next several steps augment the information in the Reference Library, completing the set of information needed for each Job Type on the Part Listing (New Job Types). The Shorthand Definitions produced from this step serve as one of the inputs to the next step, called “Create Assembly Definitions (if needed) (4.4)”. The Shorthand Definitions produced from this step may simultaneously go to the “Create Instructions Sets” step. Instruction Sets may be produced for each Shorthand Definition, providing the detailed step by step instructions on how a Schematic that employs a given shorthand should be implemented into a set of manipulations to a Target Software Product.

The “Create Assembly Definitions (if needed)” sub-function (diagonal element 4.4) provides for the creation of additional Shorthand Definitions that are made up of other Shorthand Definitions. These composite Shorthand Definitions are referred to as “Assemblies”, and they are used to further simplify the process of creating the Schematic (Encoding).

The use of Shorthand Definitions to create a Schematic representation of Final Product of a Target Software Product may involve a significant amount of time. Assembly Definitions provide a way for common Schematics, or portions of common Schematics to be modularized and reused. An Assembly Definition is a mapping from a Shorthand Definition to a set of other Shorthand Definitions that make up the desired assembly. For example, referring to FIG. 19.1, “OWA” is defined in terms of another Shorthand Definition, the Shorthand Definition for “B” previously defined above. More sophisticated uses may exist whereby a single Shorthand Definition may be defined as a set of hundreds of other interrelated Shorthand Definitions. The grammar representation shown in FIG. 19.1 is illustrative. As earlier discussed, other formats for grammars known to those skilled in the art such as BNF (Backus-Naur form) may also be used. Such Assembly Definitions may be defined immediately after the Shorthand Definitions, as well as during the Assembly phase of the Software Manufacturing Process. During the Assembly phase, Schematics are converted into Tested Combined Products and Unit Tested Final Products. These items, along with their corresponding Schematics may also be inputs to the Create Assembly Definitions step. These inputs, coming from the Assembly Phase, represent Part of the self-improving nature of the Software Manufacturing Process. As reusable units or combinations of units are identified, they can be sent to this step to be translated into Assembly Definitions. The Assembly Definitions produced by this step may be added to the Reference Library (in Setup step 4.9).

The interpretation of the Assembly Definitions as well as the Shorthand Definitions is performed during the Assembly Phase through the use of Instruction Sets. Instruction Sets define the particular steps to execute when a Shorthand Definition or Assembly Definition is encountered when processing a given Schematic. These Instruction Sets are defined by the Create Instruction Sets sub-function (diagonal element 4.5).

An Instruction Set is created by reviewing the Shorthand Definitions and extracting the steps identified for the manipulation of the Target Software Product based on that particular Shorthand Definition. An example of the construction of an Instruction Set for the Button and the associated Shorthand Definition disclosed above follows . . .

Two possible Shorthand Definitions were defined for a button. (see FIGS. 18 and 19). A single Instruction Set may be created and associated with both Shorthand Definitions. In the example, the software manipulations indicated to configure a button involve the use of a property inspector, which is a commonly accepted way to define the parameters of a sub-unit. In this example, the sub-unit of the button is referred to by the Target Software Product as an Object. The Target Software Product provides a property inspector for the purpose of performing software manipulation those results in a configured button with the needed behavior and visual appearance. One possible Instruction Set is shown in FIG. 20.

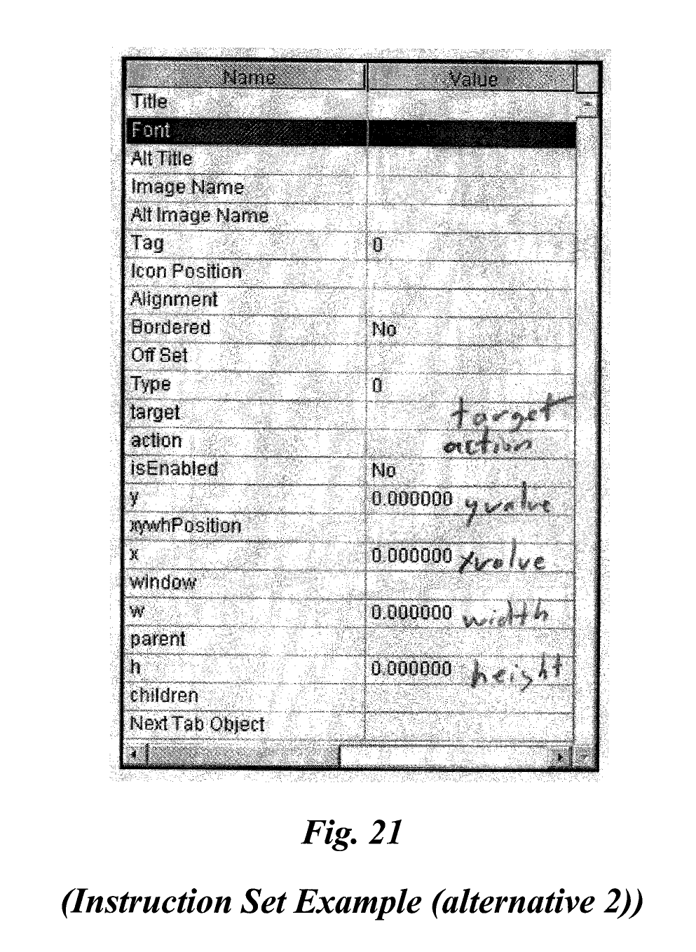

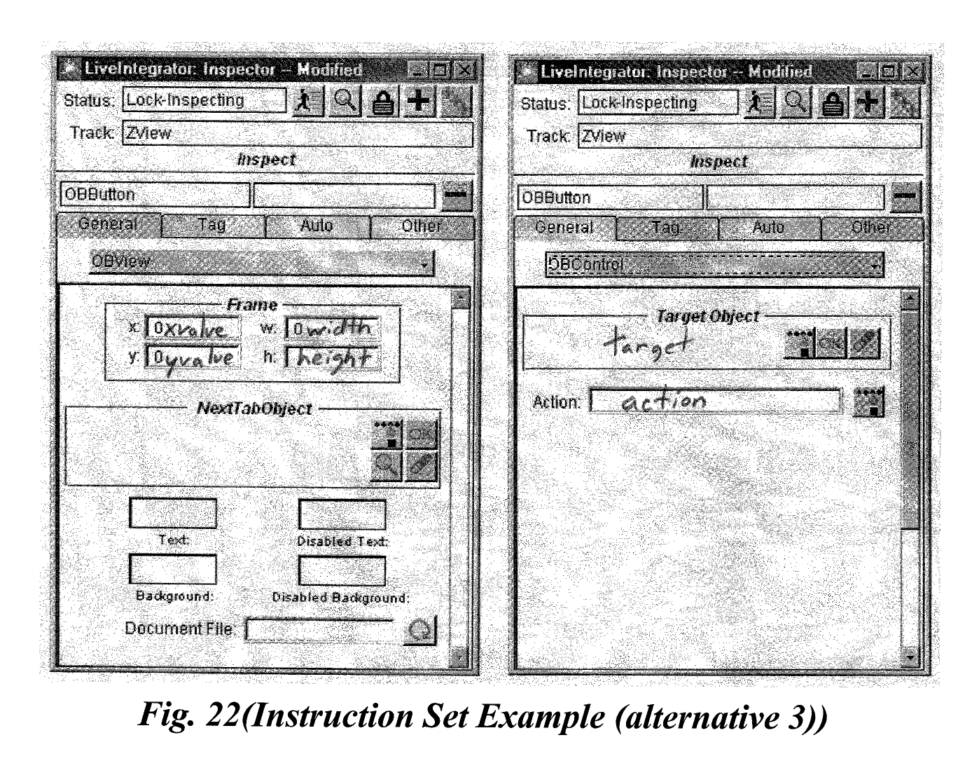

As an alternative to the description above, the Instruction Set could be provided right on the property inspector. Such an Instruction Set is given below in FIG. 21. This Instruction Set is analogous to the Instruction Set above. In certain cases, the Instruction Set may span multiple inspectors all for the same object. This is shown below in FIG. 22.

It is also possible to define Machine Readable Instruction Sets. The specific software manipulations that are desired to implement a Shorthand Definition are described in such a Machine Readable Instruction Set. The Machine Readable Instruction Set will typically be stored in a repository that is indexed on the Shorthand Definition. The format of the Instruction Set is of three related attributes on a given record or entry into the Instruction Set. For each Shorthand Definition there are a set of instructions. Additionally there may be a listing of dependencies which indicate that certain operations cannot be performed until other operations are performed. The three items are therefore 1) Shorthand Definition, 2) Dependencies (optional), and 3) Instructions. This concept of prerequisites for any given operation may exist wholly within the Instruction Set, or may exist in a separate set of Validation Rules.

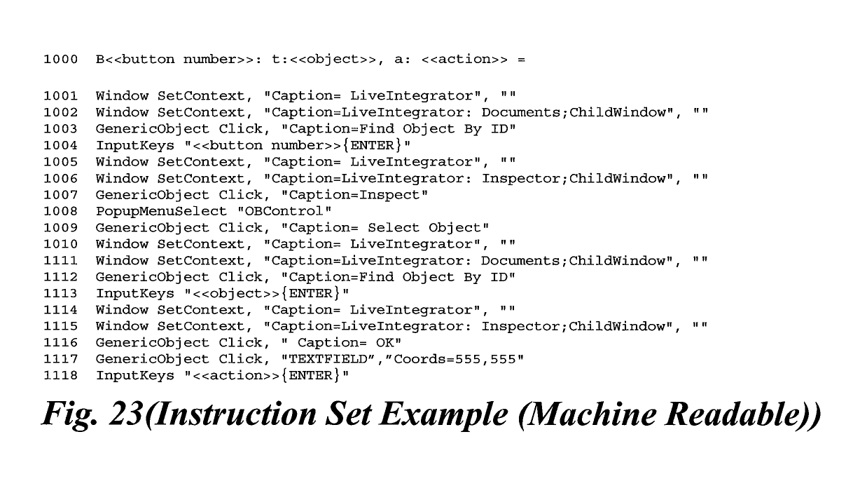

The Machine Readable Instruction Set may be used to describe the exact steps needed for an Assembly Robot to perform the operation. Any number of standard means may be used to parameterize interactions of the Assembly Robot with a given user interface of a Target Software Product. Referring to FIG. 23, one example of an Instruction Set is one that defines a mapping from a Shorthand Definition to a set of operations that emulates human interaction with the user interface of the Target Software Product.

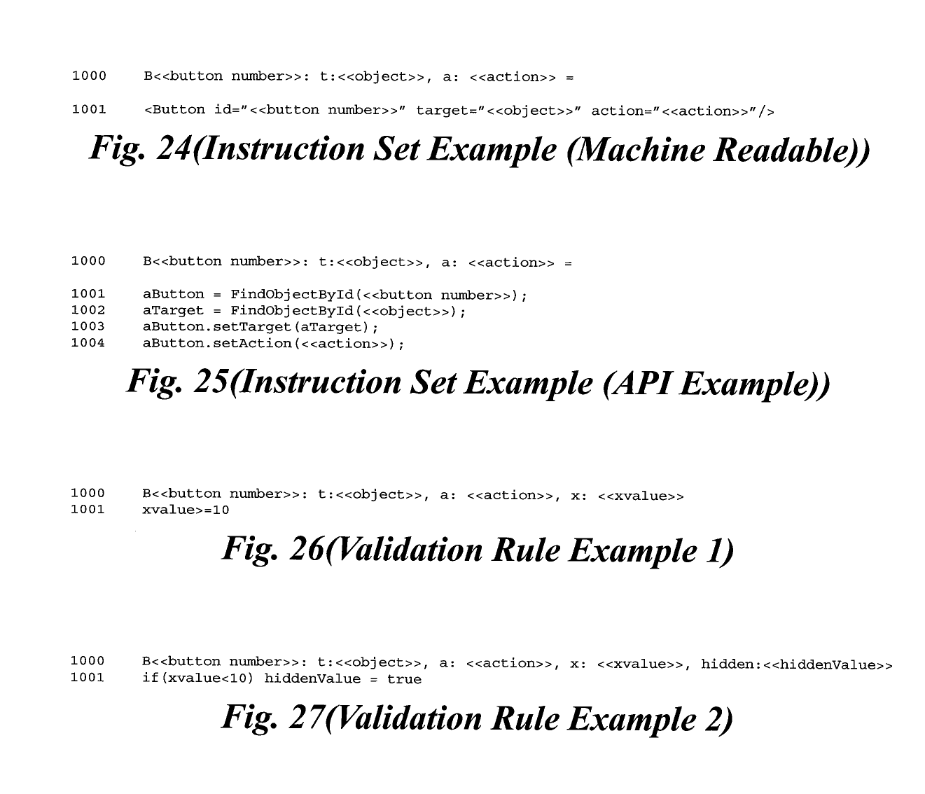

Referring to FIG. 24, another example of an Instruction Set is one that defines a mapping from a Shorthand Definition to an output format that is readable by the Target Software Product. Using such an Instruction Set effectively allows an Assembly Robot to produce the output of a Target Software Product without actually using the Target Software Product. In a preferred embodiment, this format is the same as the format of the Mockup (partial Schematic).

Referring to FIG. 25, still another example of an Instruction Set described is one that defines a mapping from a Shorthand Definition to a set of calls to an Application Programming Interface (API), that when executed in the context of the Software Product, result in the intended software manipulations.

As evidenced by the examples provided, an Instruction Set can take many forms. The machine readable forms are most preferred as they allow automation of the assembly process. As will be described in the Assembly phase, machine readable Schematics effectively allow for the Software manipulations of the Target Software Product without the need for human intervention.

In automating the process of reading the Schematic and performing manipulations on the Target Software Product, preferably, but not necessarily, the Schematic should be validated by passing a set of validation checks (or rules). These Validation Rules may be predefined as Part of the Reference Library.

Alternatively, the Validation Rules may be produced during the setup step of the Preparation phase. Such Validation Rules constrain the allowable parameters and sequences defined on a Schematic. The “Create Validation Rules” sub-function (diagonal element 4.6) produces a set of Validation Rules that are used during the Assembly phase to validate each Schematic before it is assembled.

Validation Rules are created by evaluating a series of inputs (Shorthand Definitions, Assembly Definitions, and Instruction Sets) and determining what the allowable uses of these items are. The allowable uses of these items depend on the allowable configurations of the Target Software Product. For example, if a button is not allowed to have an X value of less than 10 in the Target Software Product, then a Schematic indicating that it should have an X value less than 10 should be rejected as invalid. In most cases, a given set of parameters and valid ranges or valid combinations may be provided. For example, no x value of a Button Schematic Label may be less than 10. This may be indicated through a Validation Rule (shown in FIG. 26). More sophisticated Validation Rules are possible such as: any x value of Button Schematic Label may be less than 10 only if the hidden attribute of the button is true. An example of such a validation rule is shown in FIG. 27.

The setup function ensures that the new Job types may be processed through the factory successfully. One Part of this process is to produce the necessary components within the Reference Library. Another Part of the process is to design the specific workflow of each Job Type to be implemented in the factory. The “Design/Implement Workflow for Job Type” sub-function (diagonal element 4.7) performs this function. Just as with a traditional manufacturing process, the process recommended to assemble a given Part dictates the specific details of the workflow that will be used to assemble that Part in the factory. For illustrative purposes, several examples of how the workflow for a screen Job Type may be created are discussed below.

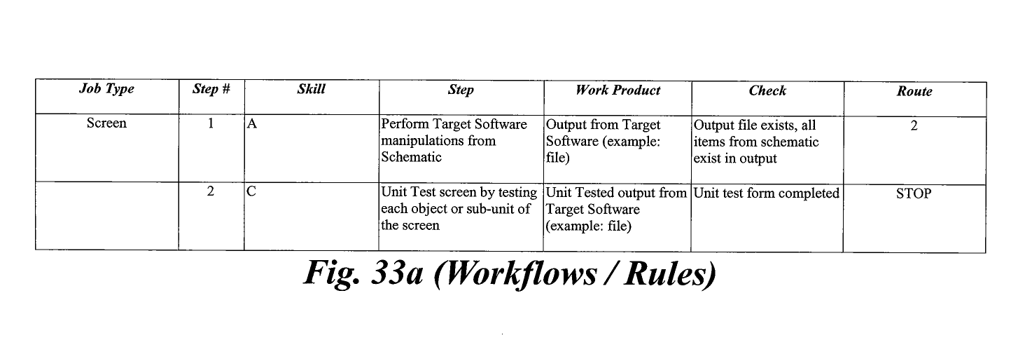

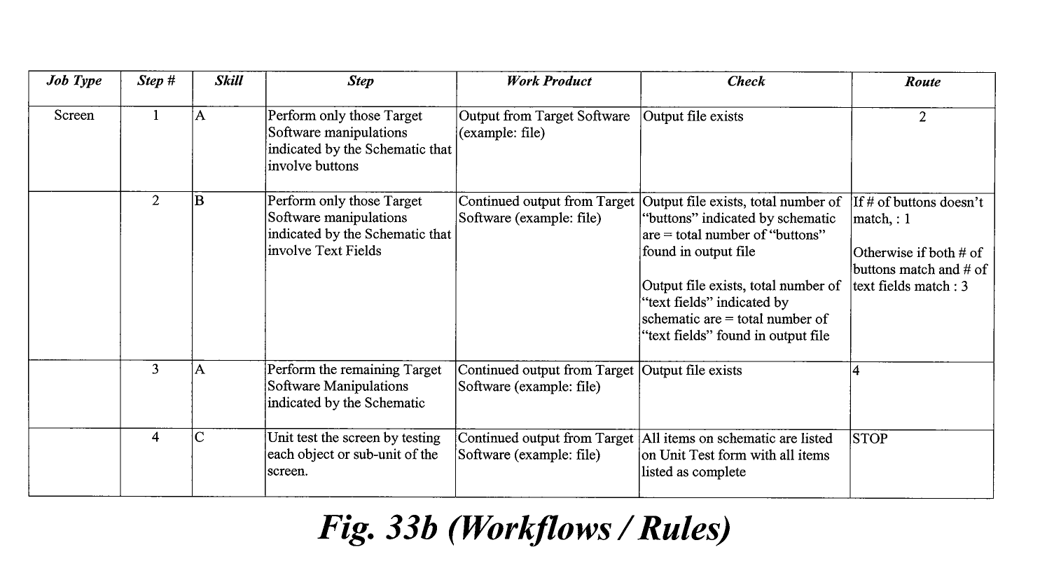

One possible workflow for a screen Job Type may be the following: 1) Perform Target Software manipulations from Schematic and 2) Unit Test screen by testing each object or sub-unit of the screen. Another possible workflow for a screen Job Type may be: 1) Perform only those Target Software manipulations indicated by the Schematic that involve buttons, 2) Perform only those Target Software manipulations indicated by the Schematic that involve Text Fields, 3) Perform the remaining Target Software Manipulations indicated by the Schematic, and 4) Unit test the screen by testing each object or sub-unit of the screen. Both of the workflows described are possible and relevant. The specific workflow designed during this step and selected for this Software Factory depends largely on the capabilities of the Software Factory. Various factors may influence the workflow design. For example, one may choose to separate the assembly into multiple steps if one wants to train personnel to do a minimal set of tasks. Additionally, one may choose to separate the assembly into multiple steps if one is in the process of automating certain steps while still others are not automated. Once the workflow is selected, it may be updated into a Production Control Function (see diagonal element 6.0 of FIG. 2) or it may be implemented into an Operations Manual for the Software Factory. A normal workflow diagram may be used, or a tabular format of such a workflow may be used. FIG. 33 shows an example of a tabular format of the two workflow alternatives described above. FIG. 33 is described in more detail in the 6.0 Production Control Function.

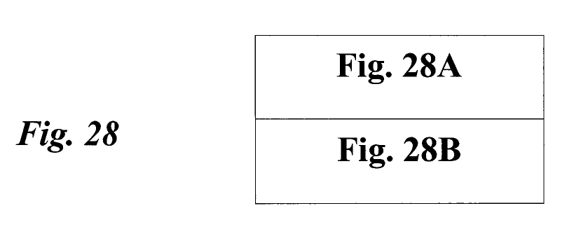

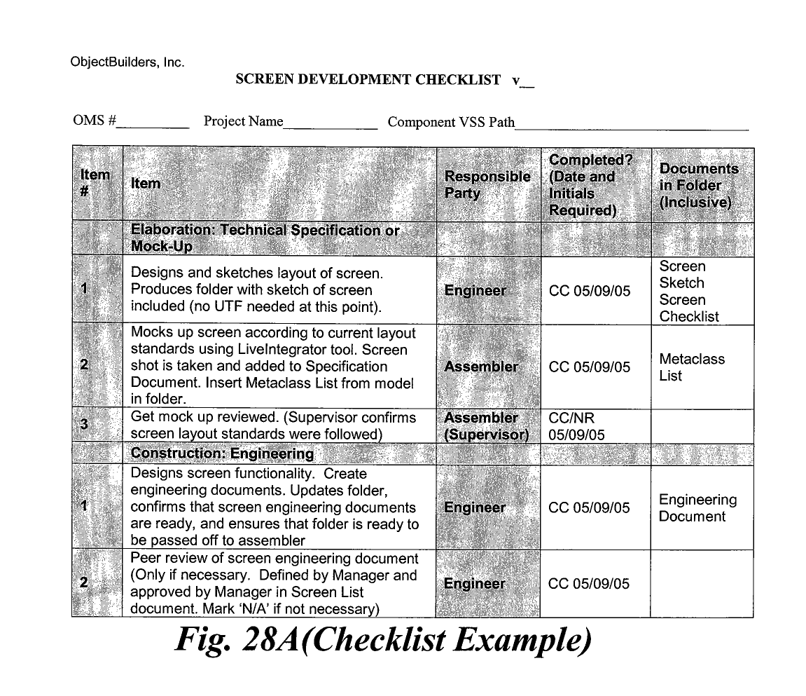

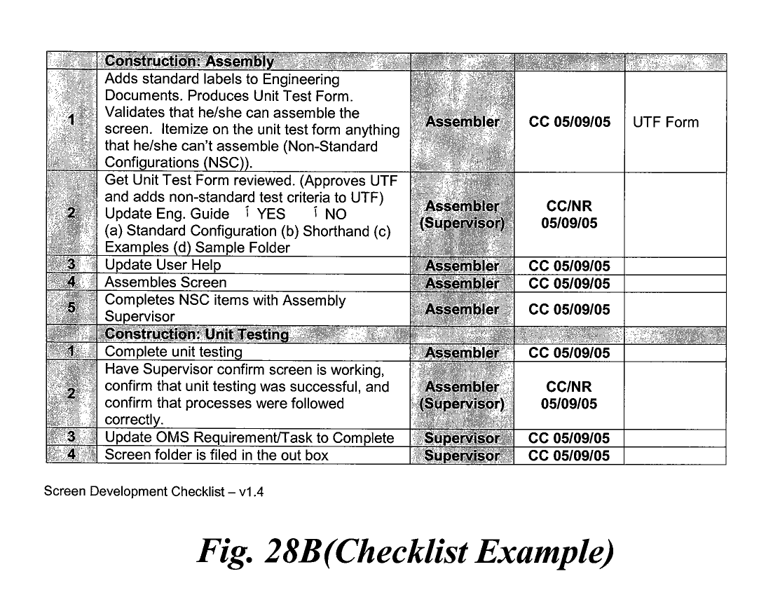

An additional possible output of the “Design/Implement Workflow for Job Type” sub-function may be a set of checklists. These checklists may have the process built into them and may be used to guide a Job of a given Job Type through the factory. An example of such a checklist is shown in FIG. 28.

Once the workflows and/or checklists are defined for any new Job Types, the software manufacturing environment of the Software Factory may be configured to support those workflows. Just as in a manufacturing facility, the software manufacturing environment may have one or more configurable Assembly Lines, each Assembly Line comprising at least one Assembly Station configured to manipulate the Target Software Product for at least one Job type selected from the plurality of Job types as required to support the workflows that are indicated for each Job Type. In traditional manufacturing, an Assembly Line is a significant and costly investment. This may be a limiting factor for both time and investment. In the Software Factory, the Assembly Line is made up of one or more Assembly Stations. An Assembly Station consists of one Computer and one Operator, or if automation is used, it may consist of one process or one thread running within a process on a single computer. This allows for Software Factories to grow very rapidly or even scale up and down to meet demand. In addition there are no costly inventories. These are at least two of the factors that give Software Manufacturing a distinct advantage over traditional manufacturing. Each Assembly Line is made up of a set of Assembly Stations (a minimum of one). Assembly Lines may exist to serve the implementation of a single Job Type or multiple Job Types. In such a case the usage of a Production Control Application for the intelligent assignment and flow of work is desirable. Preferably, all Assembly Lines may have the same ability and can therefore be used interchangeably without constraint on Job Type. This allows a single Software Factory to handle any type of Target Software Product that it has been configured to handle. The configuration of the Assembly Lines within a Software Factory is an operation that is influenced by the characteristics and needs of a particular Software Factory.

The “Update Assembly Line Configuration” sub-function (diagonal element 4.8) configures the Software Factory Assembly Lines to manipulate the Target Software Product for at least one Job type selected from the plurality of Job types. The process of updating or initially configuring the Assembly Lines in a Software Factory may depend on the specific implementation of the Software Factory being used. It is conceivable that one or more of the following parameters would all be considered in deciding on an Assembly Line configuration: a) the workflow of the given Job Type, b) the skill sets of the resources, c) the expected volume of each Job Type and d) the expected time to complete each step within the workflow of a given Job Type. One skilled in the art of Manufacturing would consider these items, among others, when setting up a factory for the creation of virtually any part. The same concepts are applicable to configuring a Software Factory. Accordingly, for brevity, only a brief overview is disclosed here.

The workflow of the Job Type should be considered when understanding the distribution of a given Job Type. For example, if a Job consists of three steps, and the second and third steps are to be conducted by the same resource, the most distributed Assembly Line may consist of two Assembly Stations. Similarly, if workflow for a given Job Type consists of one hundred different steps, and the Software Factory has only five resources that are skilled in those steps, the Assembly Line will consist of five Assembly Stations.

The expected volume of each Job Type typically also influences the Assembly Line configuration within a Factory (and therefore also a Software Factory). For example, consider the scenario where there are two Job Types being processed through a Software Factory. One Job type has three steps and it is expected that one hundred Jobs of this type will be received per day. The other Job Type also has three steps, but it is expected that only thirty will be received per day. One possible configuration for manufacturing the two Job types is to setup multiple Assembly Stations to handle the first Job type (thereby creating an Assembly Line) whereas a single station may be used to process all three steps of the second Job Type (because the volume is lower).

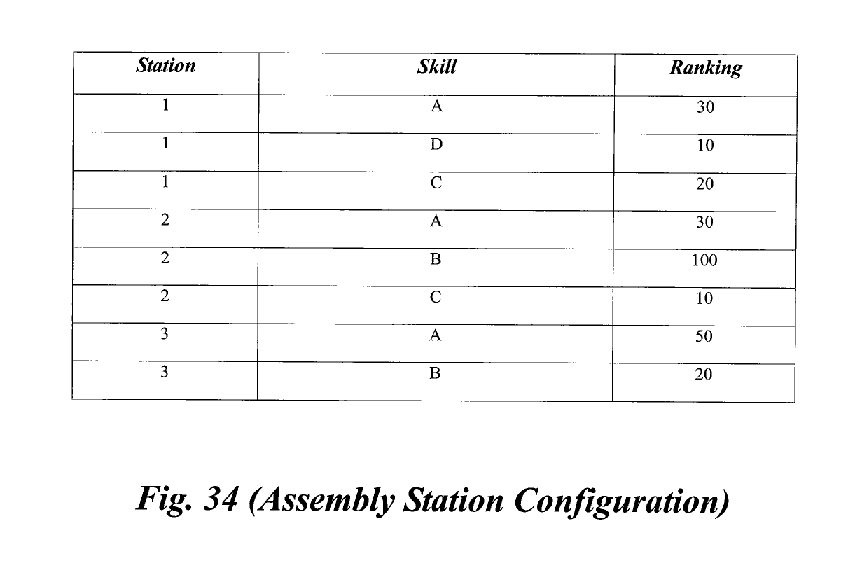

In most cases, the different steps of the workflow for various Job Types will take different amounts of time. Since it is usually preferable to utilize factory resources efficiently, the amount of time that each step takes may also be considered in the configuration of the Assembly Lines. The output of this step is the configured Assembly Lines within the Software Factory. The logic and information on what resources/skill sets/expected volumes are associated with what Assembly Lines/Assembly Stations may also be entered into a production control system. The output of the “Update Assembly Line Configuration” sub-function is therefore a matrix of information that both a) defines the configuration of the Assembly Stations and b) provides an input to the Production Control Function (see diagonal element 6.0 of FIG. 2) for use in making Job assignments. An example of such an output is shown in FIG. 34 discussed in more detail below during the disclosure of the Production Control System (6.4).

The Setup function also includes as a sub-function “Update Reference Library” (diagonal element 4.9). This sub-function adds to the Reference Library the relevant materials that were created during the rest of the Setup process. The setup function is performed, in part, because the necessary information for a given Job Type is unavailable in the Reference Library or for the reasons discussed above reconfiguration of the Assembly Lines may be desired.

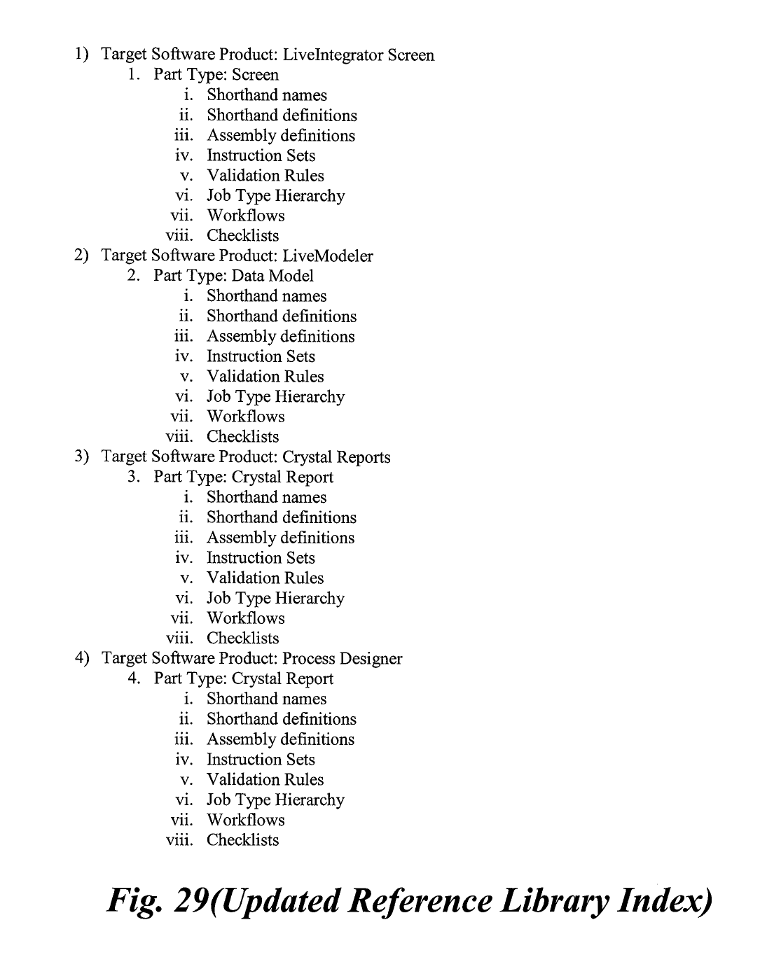

The inputs to the “Update Reference Library” sub-function are the outputs of the other steps performed during setup. Specifically, the Shorthand Definitions, Assembly Definitions, Instruction Sets, and Validation Rules are merged into the existing Reference Library and the index of the Reference Library is updated to show that these sections now exist in the Reference Library by Target Software Product and Job Type. An Example of this shown in FIG. 29.

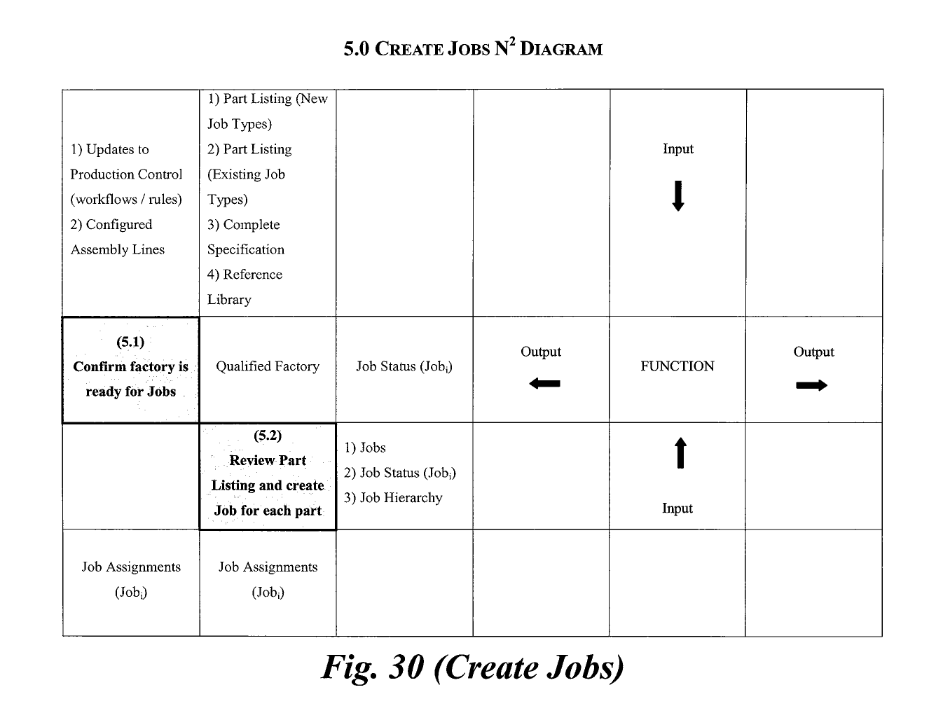

An N² diagram for the Create Jobs Function (diagonal element 5.0 of FIG. 2) is shown in FIG. 30. The Create Jobs function decomposes a Complete Specification into the Jobs indicated by the Part Listings produced earlier in the manufacturing process. This function produces a set of Jobs, each of which represent a unit of work that needs to be performed. The type of Job and the process for each Job type is determined during the Setup function previously defined.

At a high level the Create Jobs function comprises a simple two step process. The first step is to “Confirm factory is ready for Jobs” (diagonal element 5.1). This step qualifies the Software Factory as ready to process those Jobs types that are indicated as being required by the Part Listing. The second step is “Review Part Listing and create Job for each part” (diagonal element 5.2). This step operates on the output of the first step (the now qualified Software Factory) and creates a Job for each item in a Part listing. The individual Jobs are the output of this function.

The “Confirm Factory is ready for Jobs” sub-function uses the Part Listing produced during the Engineering function (previously described) and confirms that the Software Factory is qualified to process those items. (If it had not been confirmed as being qualified, one or more of the sub-functions of the Setup function discussed above may have to be performed). Considering the example described throughout this disclosure, the Reference Library index originally did not contain all the Part types needed for the Complete Specification (FIG. 10). After the Setup function was performed, the Reference Library index was updated to reflect the new Part types (FIG. 29). The “Confirm Factory is ready for Jobs” compares the Part Listing (Existing) (FIG. 11) and Part Listing (New Job Types) (FIG. 12) with the Reference Library index in (FIG. 29). As can be seen by these figures, in this example the Software Factory can now be labeled by this step as a “Qualified Software Factory” because all of the Part types indicated by the Part Listings are available in the Reference Library index.

After the Software Factory has been “Qualified” the next step in the Create Jobs function is the “Review Part Listing and create Job for each part” (diagonal element 5.2). In this step the Part Listing is used to produce a Job for each Part and associate the necessary information from the Complete Specification with each Job.

For each item found in the Part listing, a Job will be created. The Complete Specification will have sections in it that define which content of the specification is associated with which parts (this was how the Part Listing was originally produced). Those portions of the specification that define each Part are then associated with each part.

In a paper example, the specific pages of the Complete specification that need to be associated with each Job type are copied and then placed into a folder that contains the checklist of the Part (based on its Part type) as well as the pages of the specification that are associated with the given part. This combined Job folder is a physical representation of the Job.

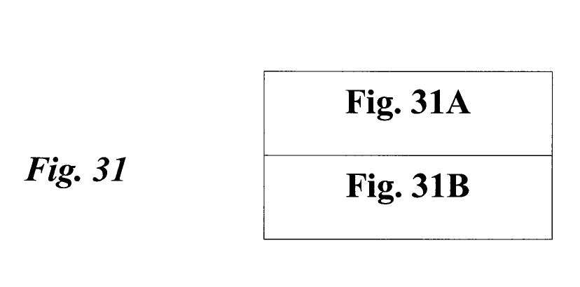

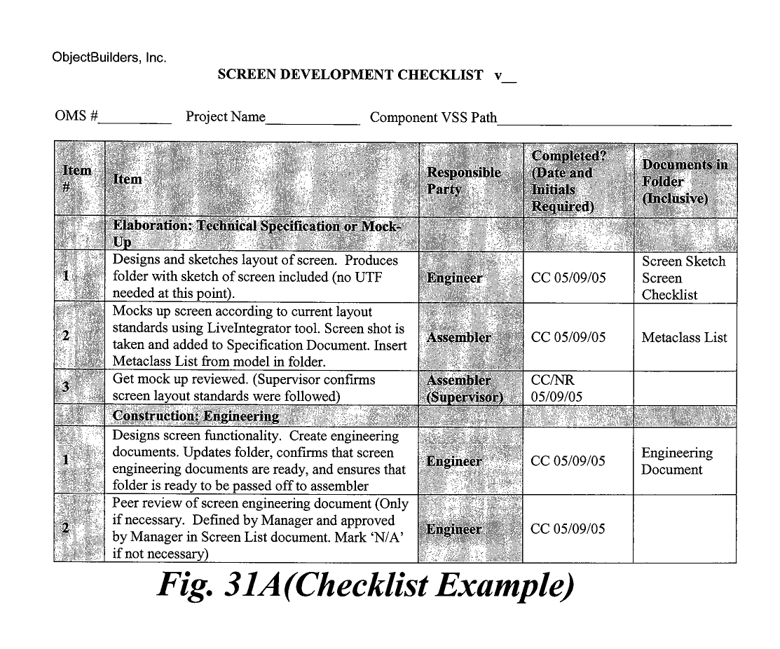

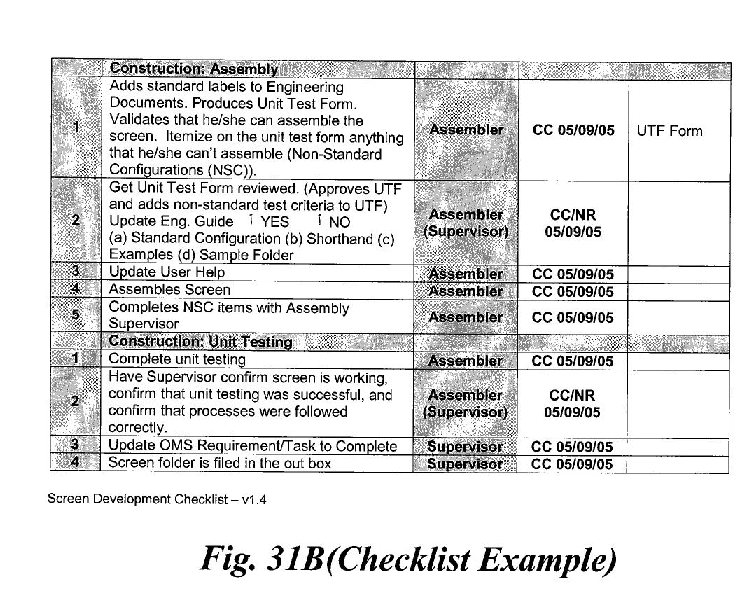

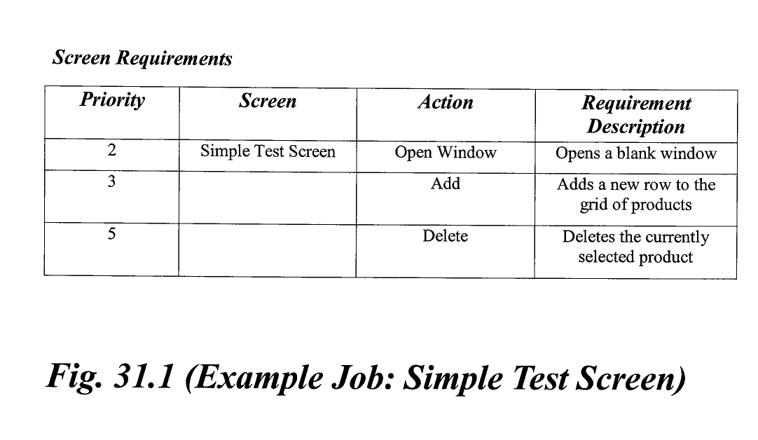

In an electronic form, the Job will contain the same basic parts, except that there will be no paper required. FIG. 31 shows the contents of a physical Job folder (the Job and its associated content) for the Job to create a Part with the name of “Simple Test Screen.” The contents of the folder includes two documents; 1) a checklist for use with parts of type “Screen,” and 2) the information from the Complete specification that is relevant to this particular part.

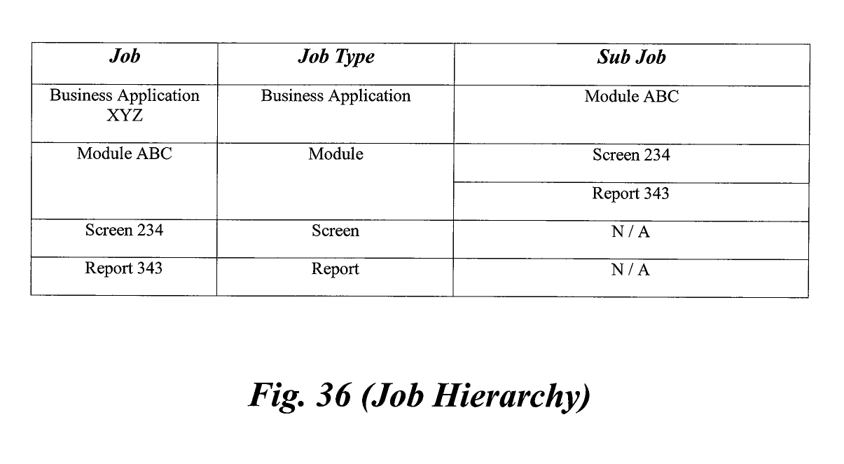

Certain Jobs may be hierarchical in nature. Hierarchies available for different Job types (i.e., Job Type Hierarchies) were described earlier during the discussion of the Setup function. These hierarchies are defined by the Job type and were stored in the Reference Library. The “Review Part Listing and create Job for each part” sub-function may identify that the Job type is a hierarchical Job (through lookup in the Reference Library) and may then associate a set of sub-Jobs with this Job. As a result, a Job Hierarchy may be produced. An example of such a Job Hierarchy output is shown in FIG. 36.

B. Assembly Phase.

Referring again to FIG. 2, the Assembly Phase can be divided into two functions: Encoding (diagonal element 7.0) which prepares the Job to be assembled during the Construction function through the creation of a Schematic, and Construction (diagonal element 8.0) which uses the Schematic produced by the Encoding function to perform the manipulations to the Target Software Products that result in a Final Product. A supporting function, Production Control (diagonal element 6.0), is also considered Part of this phase. The Jobs created as the outcome of the Preparation Phase are managed and routed using the Production Control Function.

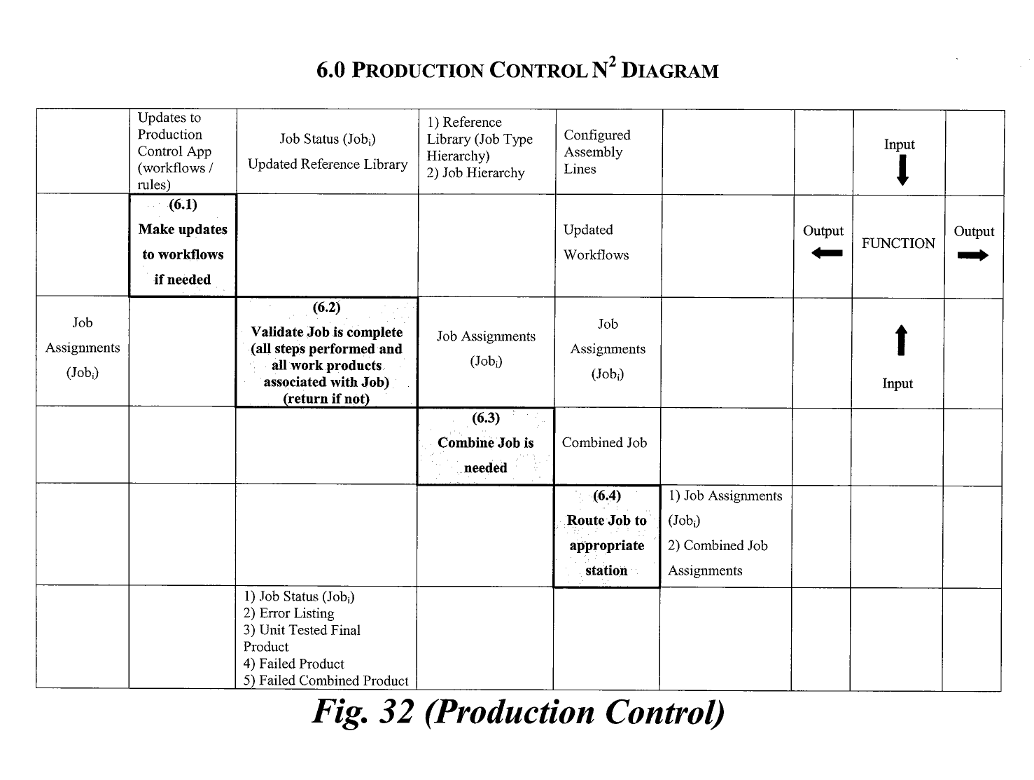

An N² Diagram for the Production Control function (diagonal element 6.0 of FIG. 2) is shown in FIG. 32. The Production Control function is used to manage and track the assignment and status of Jobs as they are processed by the Factory. The management of Jobs includes the processes of validating that a given Job is complete, combining Jobs into a master Job if needed and routing Jobs to appropriate stations based on a set of routing rules. Additionally, the Production Control function interfaces with, (receives inputs from) the setup phase, in those situations where new Jobs types are setup. As new Job types are setup, new routing rules or constraints regarding those types of Jobs may need to be used as Part of the management and tracking of Jobs.

When receiving updates from the Setup function, new workflows and rules may be incorporated into the rule set used by the Production Control function for updating routing logic. This is performed by the “Make updates to workflows if needed” sub-function (diagonal element 6.1). Other steps in the Production Control function include the “Validate Job is complete” sub-function (diagonal element 6.2) where a given Job is checked to confirm that all steps of that Job are complete (i.e., all steps listed in the workflow of a given Job type are performed) and that all work products expected to be produced by the Job are now produced, the “Combine Job if needed” sub-function (diagonal element 6.3) which is invoked to determine if a given Job needs to be combined with another Job, and the “Route Job to appropriate station” sub-function (diagonal element 6.4) which leverages the workflow and routing rules provided to the Production Control function to make Job assignments.

As has been mentioned previously, the preferred embodiment of the present invention includes a large component of automation. As it applies to the production control function, the automation consists of a software and/or hardware component which may be referred to as a Production Control Application. The Production Control Application is preloaded with information regarding the configuration and capability of the Software Factory (Assembly Stations, Assembly Lines, and other resources and capabilities available) as well as the appropriate workflow per Job Type. As such, the Production Control Application creates the appropriate Job Folder and then proceeds to start the workflow for each Job by assigning it to the appropriate Assembly Station or Assembly Line. Typically an implementation of such a Production Control Application provides a queue for each resource and for each Assembly Line. As such a resource pulls a Job from the queue and completes the indicated operations, the Production Control Application moves the Job to the next designated queue. It is preferable to use such a system as it can track the production performance metrics automatically and also allows for the changing of Assembly Line configurations and reassignment of work.

FIGS. 33a and 33b first and second examples, respectively, of possible workflows for Job type of screen. These workflow alternatives are an output of the Setup Function; specifically the sub-function “Design/implement workflow Job type” produces workflows for each Job type. The “Make updates to workflows if needed” receives as its input workflow definitions for Job types (as shown in FIGS. 33a and 33b). The workflows are then used by the “Route Job to appropriate station” Sub-function to make Job assignments. The workflow definitions in FIGS. 33a and 33b include several pieces of information that are used by the Production Control Function. In the examples provided, the Step column of the table indicates the current step number. The Route column indicates the logic (if any) that should be applied in order to determine the next step to route the Job to (by step number). The other columns provided in the workflow definition for the Job type are used later by the sub-function “Route Job to appropriate station”.

In order to make use of the workflow definitions provided to the Production Control Function, the “Make Updates to workflows if needed” sub-function is performed. This sub-function takes as its input the workflow definitions as shown in FIGS. 33a and 33b and updates its internal documentation or workings as needed to incorporate the workflow definitions. In an automated embodiment of this invention the workflow definitions are loaded into a Production Control Application during this step. In a manual embodiment, the workflow definitions may be used as is, to influence the Job assignments made by one or more supervisory personnel.

As Jobs assignments are completed, it is implied that a given Job may be complete or a given step within a Job may be complete. One of the capabilities of the Production Control Function is to validate that the given steps that were supposed to be performed were performed completely. This process of checking that a given Job assignment is complete is performed at this step.

The workflow definitions shown in FIGS. 33a and 33b provide additional information not yet discussed. Specifically, after each step, a validation is given. In some cases, a given Assembly Station may perform several steps. In other cases, it may perform only one step before the Job is routed to another Assembly Station to execute additional steps. In the fully automated embodiment, it is preferable that after each step is performed, some feedback is given electronically to the production control application; this allows validation to occur as each step to complete a given Job is executed. In a manual embodiment, the production control function may be performed by supervisory resources. In such a case, several steps may occur before the supervisor may perform this validation step. In either automated embodiment or the manual embodiment, the rules for validation are provided along with the workflow definition for a given Job type (and/or the checklist that corresponds with this). In the example illustrated by FIGS. 33a and 33b, a column is included in the workflow definition titled “Check.” This column indicates the expected output of a given step that is involved in the production of that Job. Regardless of the interval that the production control function uses to validate the Job assignment, the information contained in “Check” is used to validate those steps needed. Specifically, consider the first example described in FIG. 33a. After the first step, a check is performed to confirm that an output file exists. If such an output file does not exist, the step is not deemed complete and the next Job assignment does not occur, or a given Job assignment may be made that routes the Job back to the Assembly Station that failed to complete that step.

The “Combine Job if Needed” sub-function (diagonal element 6.3) is used to combine Jobs where they are Part of a larger Job. If a Job is being processed by the Factory that is listed on the Job Type Hierarchy as a “Sub Job Type” then it is tracked and allocated to its parent Job. If a Job's Job Type is listed on the Job Type Hierarchy as containing other mandatory Job types, all child Jobs associated with this Job should be marked complete before the given Job may be marked complete. As was described in the overview of the Production Control Function, it is necessary for an accurate status of any given Job to be available and discernable. The combination of Jobs is necessary in performing management of Jobs and reporting of status of Jobs.

The sub-function “Combine Job If Needed” (diagonal element 6.3) is disclosed with reference to the example Job Type Hierarchy shown in FIG. 35. Using this example, consider a situation where Module ABC is of Job type Module and it is a sub Job of Business Application XYZ (of type Business Application). Additionally consider that Module ABC also contains two Jobs one is Screen 234 which is of type “Screen” and another of type “Report” called Report 343. As these Jobs are created during the Create Jobs Function, a Job Hierarchy (as opposed to Job Type Hierarchy) could be created. Such a Job Hierarchy is shown in FIG. 36. This Job Hierarchy is also used as an input to this step. The FIG. 36 shows how it is possible for a Production Control Function to clear Module ABC for completion given an indication that Screen 234 and Report 343 are complete. Note that the Job for Module ABC is cleared to be completed, which means that as long as its individual steps (if any) are performed successfully (i.e., passes the Validate Job is complete sub-function) it may be marked complete.

As the steps for a given Job are performed, the Production Control System is involved in tracking those steps. Each time a step is completed (or after a set of steps are completed) the Production Control system reviews the assignment and determines how to assign the next step. The assignment may be made to the same Assembly Station or to a different Assembly Station depending on the information provided to the Production Control Function. Additionally how the assignments are made will vary between Software Factory implementations.

The sub-function “Route Job to Appropriate Station” (diagonal element 6.4) is performed for each Job assignment by analyzing the Job assignment to determine its status, then comparing that status with the workflow for that Job type to determine the next step that the given Job should go through and finally using some assignment logic with the given configured Assembly Lines (and their current status) to select a next station for assignment.

An example of Job routing in which an assignment algorithm that makes an assignment based on the capabilities and load of a given Assembly Station is described below. In this example, the workflow definition in FIG. 33b is used. Consider that the Job assignment information that this steps receives as input is as follows: Screen 234 Step One complete and validated (of type Screen). Based on the Job Type (Screen) this step uses FIG. 33b to lookup what the next step should be. It finds that given that the current status is step one and that the route field indicates that the next step is step two, it should assign step two to an appropriate station.

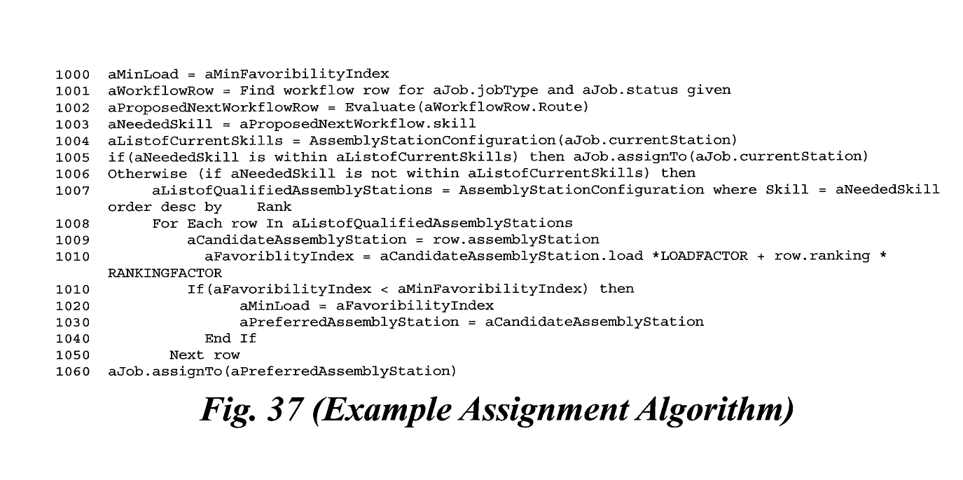

A skill column is then used to lookup Assembly Stations (including the current one) that are qualified to do the step. The ranking of the Assembly Station in terms of its ability to do the step is combined with the current load of the Assembly Station to determine which Assembly Station should receive the assignment. FIG. 37 outlines an algorithm that does just that. Tuning parameters of Load factor and Ranking factor allow for different weighting in terms of current load (ability to get the Job done faster) and ranking (quality level of the Job). There are many possible algorithms for assignment of work in such a setting. Many such algorithms already exist for assignment of work in the Manufacturing domain.

In the example given the ranking of an individual Assembly Station is determined by the number of successful completions (+1 to the ranking) of a given step type and failed completions (−1 to the ranking). Likewise the load is the number of current assignments that a given Assembly Station has. Consider the Assembly Stations listed in FIG. 34. Consider that for the purpose of the example, the load for the three Assembly Stations is as follows 1:100, 2:200, 3:50. Consider the assignment of Screen 234 Step one complete and validated by Assembly Station one. Using the workflow for the Screen Job Type, (FIG. 33b) one can see that the next step is Step two. Also from the workflow definition it is indicated that step two prefers skill B. Given the algorithm in FIG. 37, if Assembly Station one possessed skill A, it would be assigned the second step of the Job. After checking the Assembly Station Configuration (FIG. 34) it is noted that this Assembly Station does not posses that skill, therefore the rest of the Assembly Stations that have that skill to make an assignment change are considered.

First Assembly Station two is considered. It has a rating of 100 for skill B. The assignment would be made to this Assembly Station unless the load was high enough to result in a more favorable assignment to Assembly Station three (consider the two factors (LOADFACTOR and RANKINGFACTOR) in the algorithm in FIG. 37).

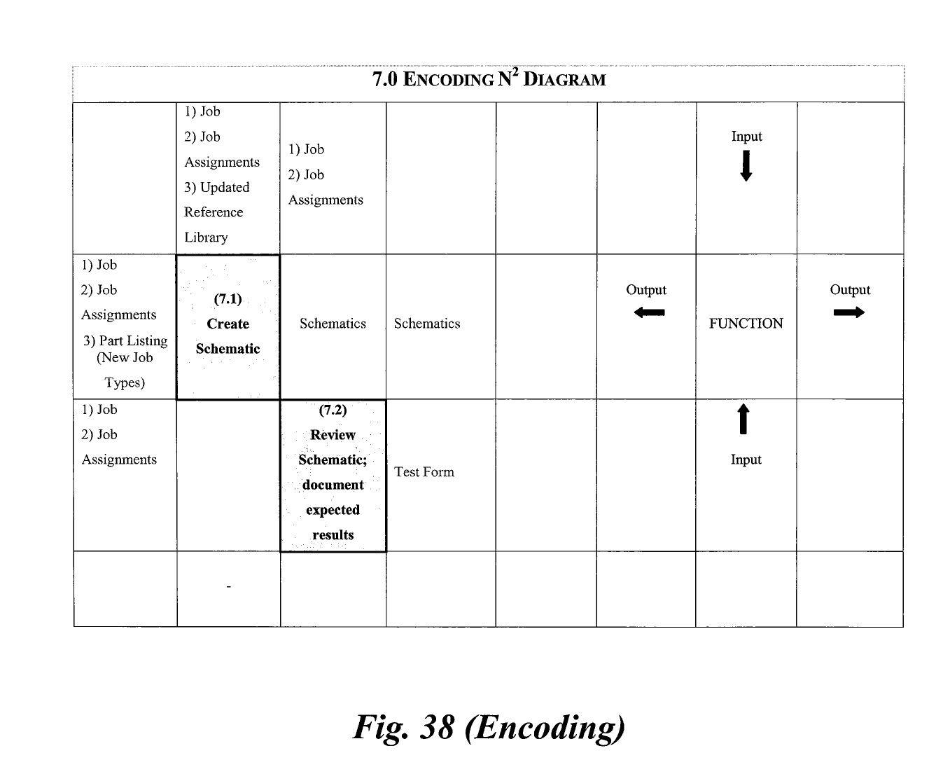

An N² Diagram for the Encoding Function (diagonal element 7.0 of FIG. 2) is shown in FIG. 38. The Encoding function is the first Part of completing a Job that is assigned to an Assembly Station. During the Encoding Process, the Engineers Encode the Jobs using the appropriate EAGuide for each type of Job. For example if the Specification Document indicates that the Screens are to be produced using the LiveIntegrator™ Target Software Product, the LiveIntegrator™ EAGuide would be used. The Encoding process takes place on Assembly Lines with Engineers as the Computer Operators. The more Jobs that exist, the more Assembly Lines that may be used.

The Encoding process provides a Schematic for the Assembly that indicates exactly how the Job is to be assembled. By following the EAGuides with the appropriate Shorthand Definitions, quality can be controlled and the Assembly Lines will produce consist quality output.

The Encoding function is performed by first evaluating the Job and confirming that a Schematic can be created (if it can not be created, it is returned to the Setup function by adding the Job to the Part Listing (new Job types) item), and then creating a Schematic based on the specification and the content of the Reference Library (including the EAGuide for the Target Software Product), the Schematic designating how the Target Software Product is to be manipulated by the at least one Assembly Station. This process is performed by the sub-function “Create Schematic” (diagonal element 7.1). The outputted Schematic is then used to document the expected results of the Schematic (to provide a testing mechanism that can validate the output of the Construction function). Sub-function producing the Test Form is “Review Schematic; document expected results” (diagonal element 7.2). The output of the Encoding function, the Schematic and corresponding Test Form, are used as inputs to the Construction function (diagonal element 8.0 of FIG. 2).

The first Part of creating the Schematic is to confirm if the Job can be assembled in the Software Factory. As a prerequisite for the Encoding function, the Job Folder contains either the non-Schematic description of the Part or the Partial Schematic for the Part. This is typically provided in the Specification Document. If it is not provided, it is created as Part of the process of producing the Schematic. This step starts with the review of the available information for the Part. If the information provided is not adequate, it is returned to Engineering Process and completed prior to continuing. An Engineer uses the EAGuide for the Target Software Product that will be used to construct the Part to create a full or complete Schematic that describes the specific manipulations that are indicated. Schematic Labels are used to augment the Schematic (based on the Shorthand Definition) and are used to define the required values of the parameters of each Sub Unit or Object needed.

The Schematic is created by analyzing the information provided with the Job to discern the expected behavior of the component. Once the expected behavior of the component is understood, an Engineer can produce the Schematic by using the Reference Library created during the Setup Function. If the Specification materials provided with the Job are in a format that is consistent and machine readable, an Engineer robot could be used to map the functionality described in a specification to a Reference Library.

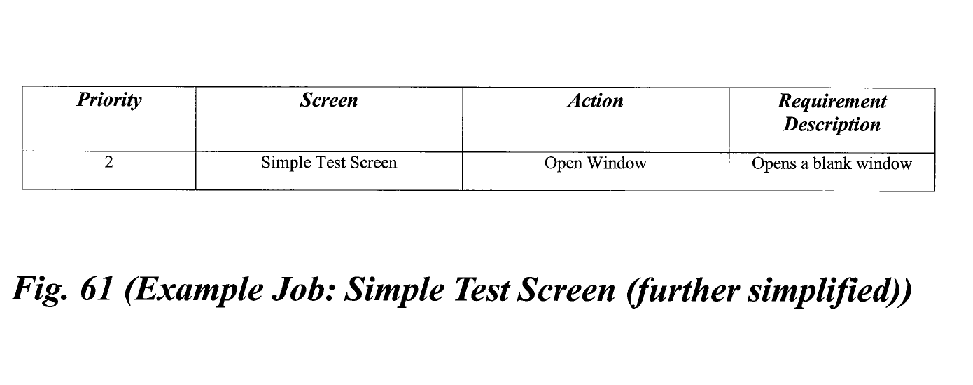

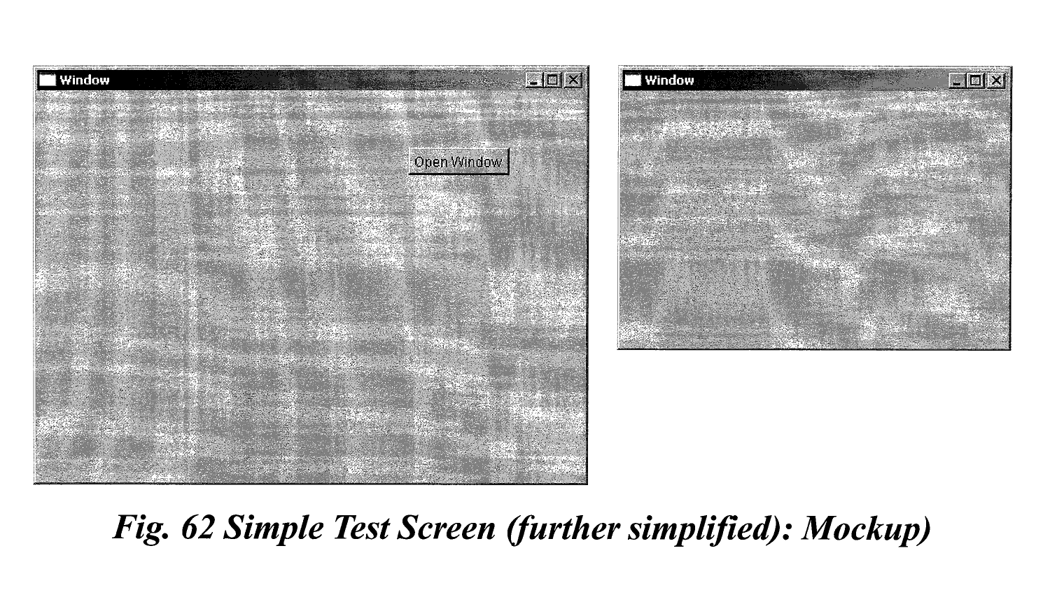

Consider the Job described earlier and illustrated in FIG. 31. Specifically, the Job is of Job type Screen and is a Job for assembling a Screen component called “Simple Test Screen.” As this Job arrives at the “Create Schematic” step, it is first evaluated to determine if it can be assembled. In a preferred embodiment of the specification document, a partial Schematic is provided as a mockup of the screen. Such a mockup is shown in FIG. 62. Although a partial Schematic is preferred, a simplified specification for a screen Job, such as the example shown in FIG. 61 may also provide the information required by the Create Schematic sub-function.

The requirements provided with the Job are used by the operator of the Create Schematic sub-function, through comparison with the EA Guide to determine if the allowable manipulations will allow the desired behavior to be encoded and therefore constructed. In this example, FIG. 31 and FIG. 62 illustrate the Job, and it includes a set of requirements for the Job. Each requirement could be compared with the Reference Library Shorthand Definitions (FIG. 14) and Parameters (FIG. 14.1) to determine if that requirement could be encoded. In many cases, it is conceivable that some interpretation and expertise is necessary for this step to occur. As a result it often may be performed by a human who can interpret the requirements of the Job and understands the capabilities of the Target Software Product. In other cases, it is possible to automate this step.

As an illustration of automated Schematic creation, consider that the actions described in the requirements of the Job (FIG. 31) are already mapped to the mockup (partial Schematic) that is provided with the Job. This mapping allows an Encoding robot to determine that there are three buttons that map to the requirements. In reading the requirements, one can see that there is an action for each of the buttons. These actions are found in the shorthand parameter listing as possible values for the “Action” attribute (FIG. 14.1). Such a systematic analysis allows for automated Encoding.

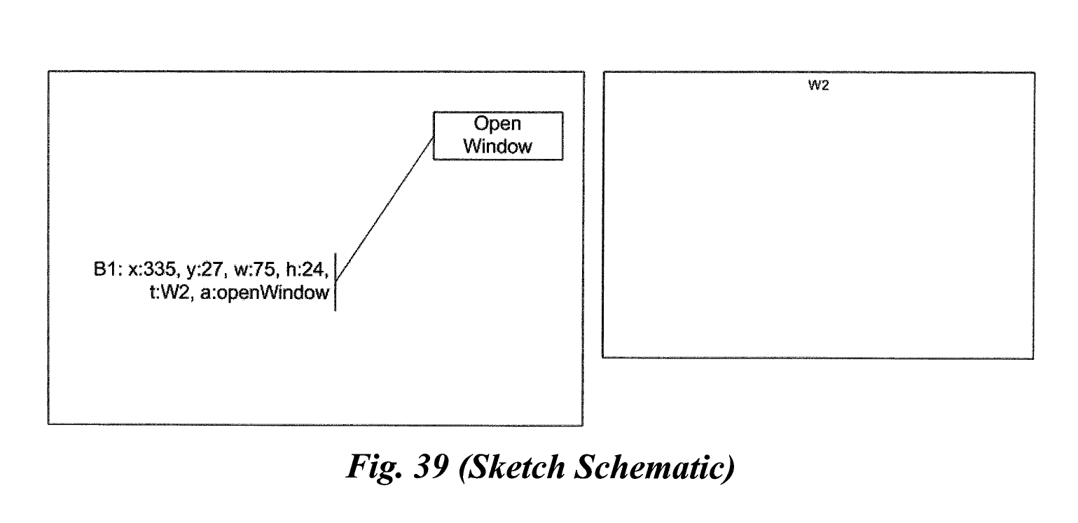

Once it is determined that a given Job can be assembled it is encoded by augmenting a mockup (if one exists) with the necessary notations (based on the shorthands and shorthand parameters that are provided in the Reference Library). For example, consider a situation whereby a button needs to be placed on a screen which shall send a message “openwindow” to another screen (as is the case with the example Job “Simple Test Screen” illustrated in FIG. 31). If the available description of the Part does not include a mockup of that screen, the Schematic produced in the Encoding step for that screen may be as is illustrated in FIG. 39. Such a Schematic is based on a sketch and as such is called the Sketch Schematic. As one can see, such representation may be cumbersome and may not be the fastest way to communicate the details of the software manipulations.

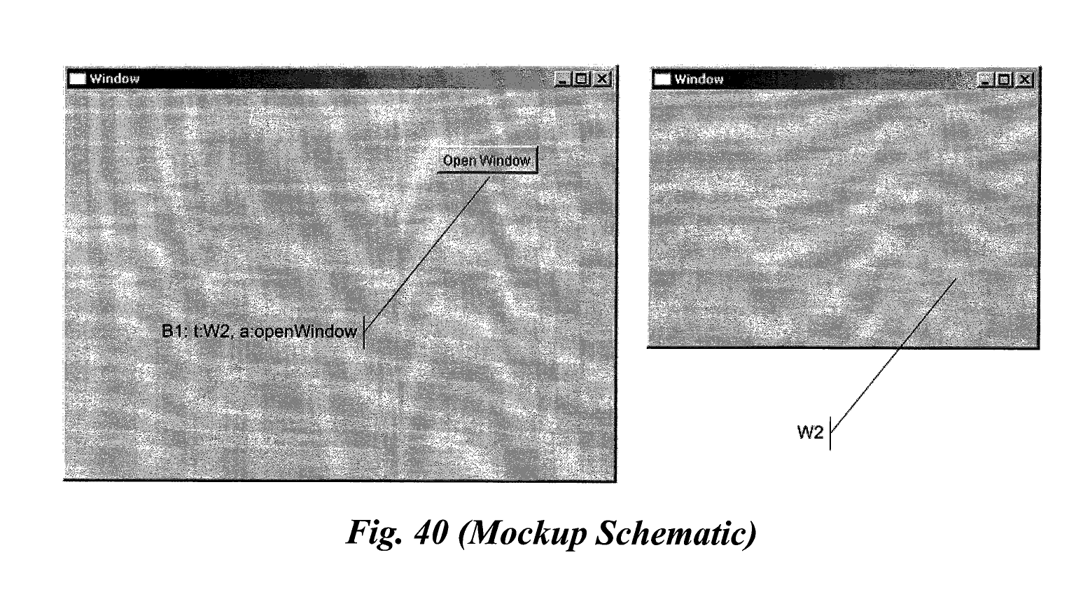

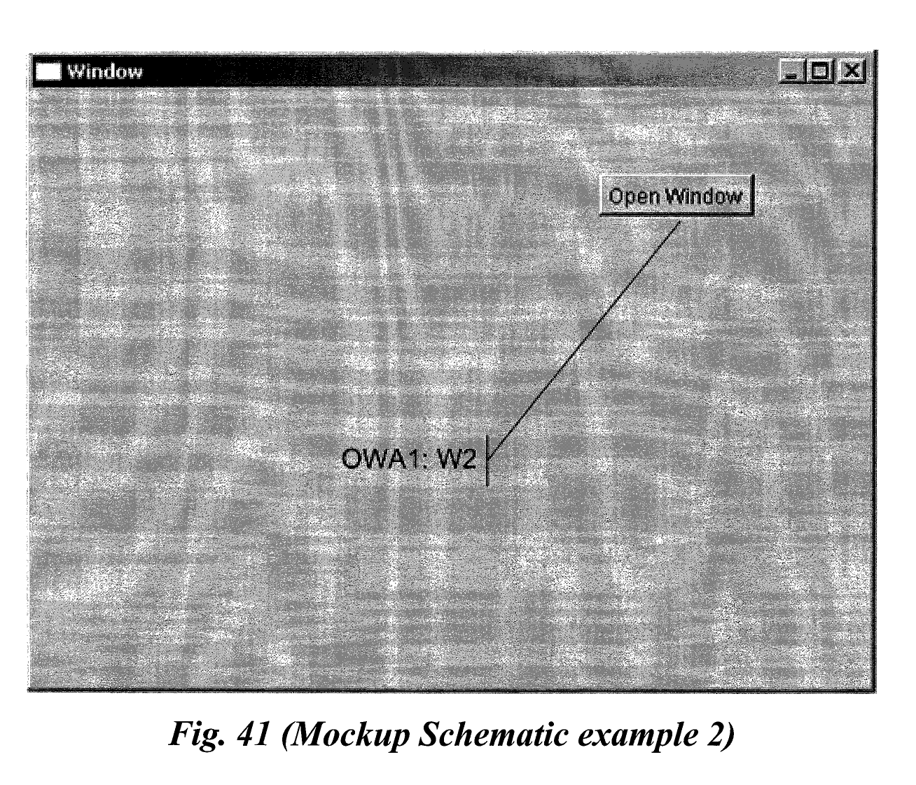

If a Partial Schematic does exist in the Specification (as is the case with the example “Simple Test Screen” in FIG. 31 and more specifically FIG. 61), a better Schematic may be produced after the Encoding step and may look like the one illustrated in FIG. 40. FIG. 40 shows a Schematic that is based on a real mockup of a Part and is therefore called a Mockup Schematic. FIG. 41 shows a Mockup Schematic that uses a Schematic Label that contains a reference to an Assembly Definition instead of a simple Shorthand Definition. FIGS. 40 and 41 are equivalent. However FIG. 41 may require an additional Decoding operation (described later).

The Sketch Schematic shown in FIG. 39 typically is interpreted by a human operator and therefore in the case where the Construction step is automated, if a Sketch Schematic is used as the input to the automation, a human operator is involved in the Construction process.

A preferred Schematic for input to an automated Construction step is the Mockup Schematic shown in FIGS. 40 and 41. More specifically, a Machine Readable Schematic is used. Typically a Machine Readable Schematic is created from an Electronic Mockup. An Electronic Mockup is one which is in a format that allows a software program such as an Assembly Robot to extract from this Electronic Mockup the implied parameters from the Mockup. As such, the Machine Readable Schematic is one of a format that allows a program such as an Assembly Robot to extract the implied parameters as well as the explicit parameters provided by the Schematic and the Schematic Labels (also represented electronically, within this input). In most cases Shorthand Definitions as well as more abstract Assembly Definitions (described in the Setup step) are used to provide Schematic Labels with minimal effort. In this case, depending on the capability of the Target Software Product, an Assembly Robot may need to Decode the Machine Readable Schematic, thereby producing simplified instructions (called the Decoded Schematic) which may then be used to interface with the Target Software Product. The Decoding operation may be performed by separate automation before it is input into an Assembly Robot, or it may happen within an Assembly Robot.

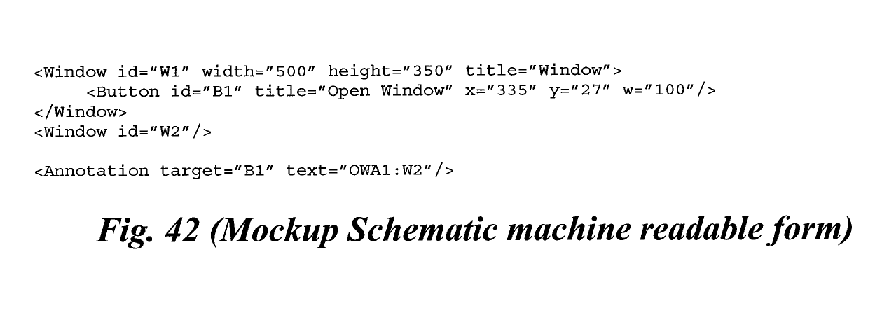

There are two ways to view the Mockup Schematic shown in FIG. 41. The first way is visually; FIG. 41 (and FIG. 42) is a visual representation of the Mockup Schematic. The second way of viewing the Mockup Schematic is in the same manner in which an Assembly Robot may view it, that is, as a text file that may be parsed by a parser. The specific representation given in FIG. 42 below is only one example of a format of such a Mockup Schematic. In the preferred embodiment, XML is used. In other examples this may be a binary file (machine readable), proprietary format, database or any other representation capable of persisting the Target Software Product manipulations (referred to as an Archive). XML is used in this example for its human readability.

Both the visual units (windows and buttons) as well as the Schematic Labels are shown in the example of a Mockup Schematic (FIG. 42) (which is one form of a Machine Readable Schematic). This is a printed rendering of the electronic document. After parsing the electronic version, the Schematic Labels are tied or tagged to the appropriate components. This process is performed by evaluating the requirements of the unit down to the object level (buttons etc.) and then locating those corresponding objects in the parsed electronic document. The annotations are then created for each one of the identified objects and they are applied to the document.

The above example document may be created by using the Target Software Product to produce an incomplete screen (one that is not completely working, also called a Mockup or Partial Schematic) merely to get the layout established. After doing this, the Mockup may be opened by another (or the same) Target Software Product in order to add to the Schematic. A Schematic may be produced which represents an engineer's intent regarding how the Target Software Product should be manipulated in order to result in the desired output.

Most document formats are published and can be read and manipulated outside the original Software Product. For example, the format for certain rich text documents is defined as RTF. This format is well published and documented, allowing other applications to read, write and manipulate documents that use this format. This combination of Mockup and Encoding process produces the Mockup Schematic. That Encoding is represented in the XML with the Annotation element. XML represents one possible Encoding strategy; any Encoding strategy may be used that can reference elements of the document without destroying the integrity or usability of the document (separate documents or files for annotations are also possible). Although in this example the Schematic Labels are shown as an element in the XML document, this may be done differently depending on the format used for the Encoded Mockup. The combined file (FIG. 42) may be readable by the Target Software Product or other software that could display it as FIG. 41.

The process of Encoding may include multiple steps involving peer review and double checking of the Schematic. Including these steps is preferable as they may increase the accuracy of the Encoding step.

Additionally, the process of Encoding may involve multiple Assembly Stations and its own Assembly Line. For example, consider a Schematic that is layered on top of existing Schematics that already contain a certain level of detail. In such an scenario there may be one Engineer (Assembly Station) who is only responsible for Encoding the Buttons on a screen, and another Engineer (Assembly Station) who is only responsible for Encoding the Windows, and yet another Engineer (Assembly Station) who is only responsible for Encoding the Boxes on the screen, and so on.

The Schematic, since it embodies the specific details of the desired software manipulation, may also be used to define the expected output. This expected output may then be incorporated as Part of the Job (or as a new Job) for the purpose of Testing. For example, the Encoding Process may result in two distinct documents: 1) a Schematic for the purpose of Assembly; and 2) a Test Form for the purpose of testing the assembly.

For example if the output is a file created by a software program, the success criteria for the software manipulation may be determined during the Encoding phase. A Test Form may be created (during the Encoding phase), which may then be used post assembly as a success criteria. After the Unit is assembled, the Assembler may execute each of the described tests on the Test Form (corresponding to the requested or required Encoding) and associate a pass or fail result with each (depending on the whether the expected result is seen or not seen respectively). If any of the listed tests fail, the Part is deemed incomplete or defective until the issues are remediated and the tests completed.

The Schematic and the Test Form, when created, are added to the Job Folder. The Encoding Process is complete and the Job is ready for Construction. During the Construction Process, the Assembly Line has an Assembler as the computer Operator.

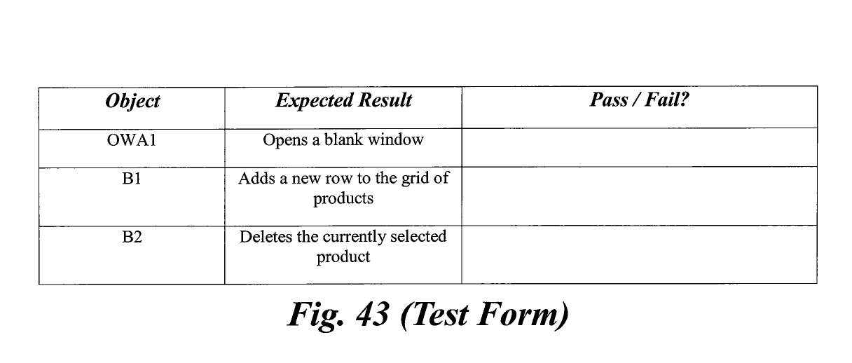

The “Review Schematic; Document Expected Results” sub-function (diagonal element 7.2) takes as its input the Schematic that was produced by the “Create Schematic” Sub-function. For illustrative purposes consider the Schematic shown in FIGS. 41 and 42. As was described above in the Create Schematic step, there is a mapping between the requirements of the component (as listed in the specification) and the Schematic. It was described that there are three buttons, each of which has one function. The function that each button has is listed in the requirements document. A Test Form may be produced that illustrates this mapping. For example, consider the Test Form produced in FIG. 43. This Test Form illustrates how the Schematic is connected to the requirements of the screen, and as such how expected results are anticipated.

After a Job is appropriately Encoded through the Encoding function, the Job Folder is routed by the Control Function to the appropriate Assembly Station. Once the Job folder reaches a qualified Assembly Station, the Assembler has access to both the Schematic and the Target Software Product. Then, for each sub unit on the Schematic, the Assembler implements the necessary software manipulations referring to the EAGuide (specifically the Shorthand Descriptions for each sub unit) as needed to implement the necessary software manipulations.

The Construction function may operate with any combination of human assemblers and automated “Assembly Robots.” Knowledge and experience may be rated mathematically in the Software Factory based on the number of Units or sub units assembled (and/or successfully tested). This concept of rating the skill level of each Assembly Station was illustrated during the discussion of the Production Control Function. As human Assemblers spend more time in the factory, they learn how to manipulate the Software Product to configure new sub units, by leveraging the EAGuides.

Once completed with all Encodings, the Assembler tests the output of the combined software manipulations to determine if that Unit was successfully Assembled. This step may be performed by the Assembler or may be passed to another Assembly Station. The Job incomplete until the Unit has been Assembled and Tested.

Automated assembly may be used to provide a highly productive Software Factory. The robot that performs the automation of the Construction Process is referred to an “Assembly Robot.” The Assembly Robot is one type of assembler. The Assembly Robot will be used to automate the Assembler's functions. This automation ranges from requiring some operator involvement to complete automation where the Assembler is removed completely.

An Assembly Robot is a piece of automation (hardware/software or both) that may serve the purpose of executing the Construction step of the Assembly phase of the Software Manufacturing Process. An Assembly Robot takes as its input one or more Machine Readable Schematics and its output is the result of a manipulation of a Target Software Product. Assembly Robots may achieve this output through any number of means. One possible implementation of an Assembly Robot is one where it generates the output directly, effectively eliminating the need to have a Target Software Product involved in its (Assembly Robot's) operation. Another possible implementation is one where the Assembly Robot interacts with a Target Software Product, simulating the inputs (this may include mouse clicks, key presses, and other inputs) and thereby producing a result of a Target Software Product through a means similar to that of a human operator. A third possible implementation involves the use of an API (Application Programming Interface) that is exposed by the Target Software Product. In such an implementation (API) the Assembly Robot invokes an input interface to the Target Software Product that is non-visual in nature. In the case where an Assembly Robot interacts with a Target Software Product to simulate the inputs of a user, it is possible to use existing third party products that are designed to user interface automation or user interface testing. Additionally macros may be used as a mechanism to record and play back such manipulations. It is also conceivable that machine learning techniques and artificial intelligence could be used to “teach” an Assembly Robot how to interpret Schematics and result in appropriate manipulations of Target Software Products.

Additional inputs may be used by an Assembly Robot to make it more configurable. An example is the use of an Instruction Set that is specific to a given Target Software Product. It is conceivable that such an Instruction Set could be used to provide a mapping from a given Schematic (or Schematic definition) to a set of operations that an Assembly Robot can perform to implement that given Schematic or Schematic construct (part of a Schematic). As such, one can envision that a single Assembly Robot may be flexible enough to work with many Target Software Products, and read many Instruction Sets that may be used to define how it should interact with a Target Software Product (or produce the output of the Target Software Product) for virtually any Schematic.

When using detailed Encodings as described in the Encoding function, the amount of interpretation of engineer's intent by the Assembler is limited. The Assembly Robot leverages this concept to automate a set of software manipulations, in such a way that the Schematic is processed and the Final Product is produced. In order to achieve this, the Assembly Robot may perform certain distinct tasks, such as: 1) Parsing of the Schematic to understand the specific instructions that need to be executed on the Target Software Product; and 2) Implementation of the specific instructions onto to the Target Software Product, thereby simulating the interaction between the Assembler and the Software Product.

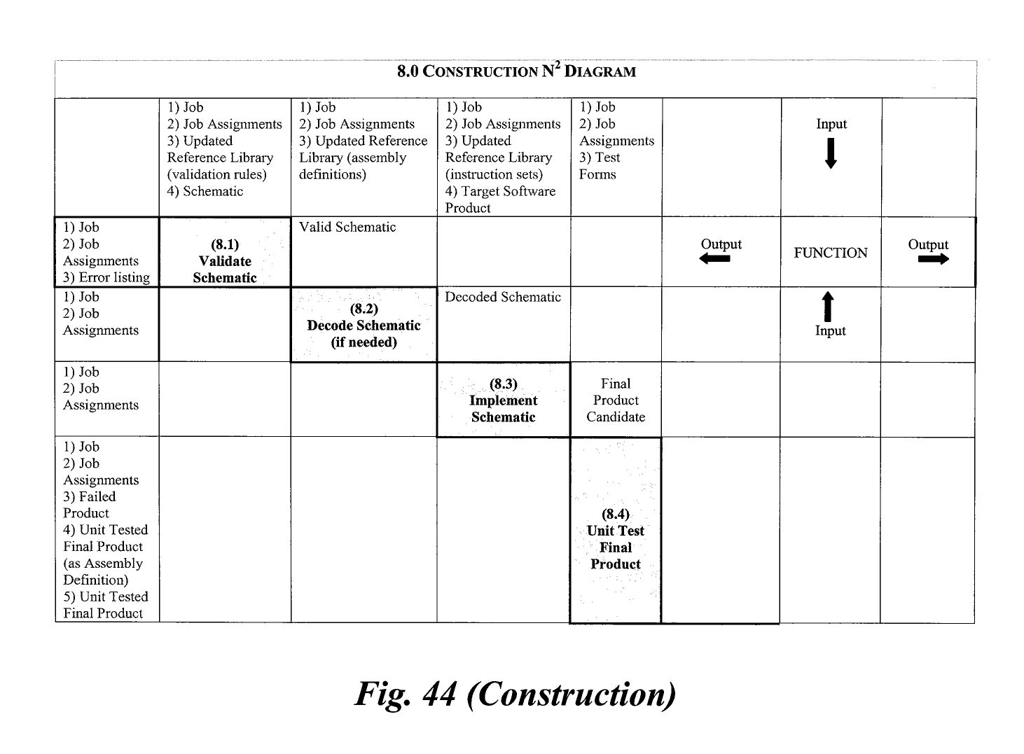

An N² Diagram of the Construction function (diagonal element 8.0 of FIG. 2) is shown in FIG. 44. At a high level there is an interaction between the Assembler, the Schematic, the Reference Library, and the Target Software Product in order to complete the construction process. This interaction comprises four sub-functions: “Validate Schematic” (diagonal element 8.1), which operates on the Schematic provided with the Job, and confirms that the Schematic is valid, “Decode Schematic (if needed)” (diagonal element 8.2), which is used for decomposing the Schematic into its most elemental components. “Implement Schematic” (diagonal element 8.3), where the Final Product is constructed by implementing the Schematic on at least one Assembly Station by interpreting the shorthand provided on the Schematic and manipulating the necessary Target Software Product manipulations, and “Unit Test Final Product” (diagonal element 8.4) which tests the Final Product Candidate using the Test Form that was completed with the Schematic by the Encoding function. Each of these sub-functions is described in more detail below.

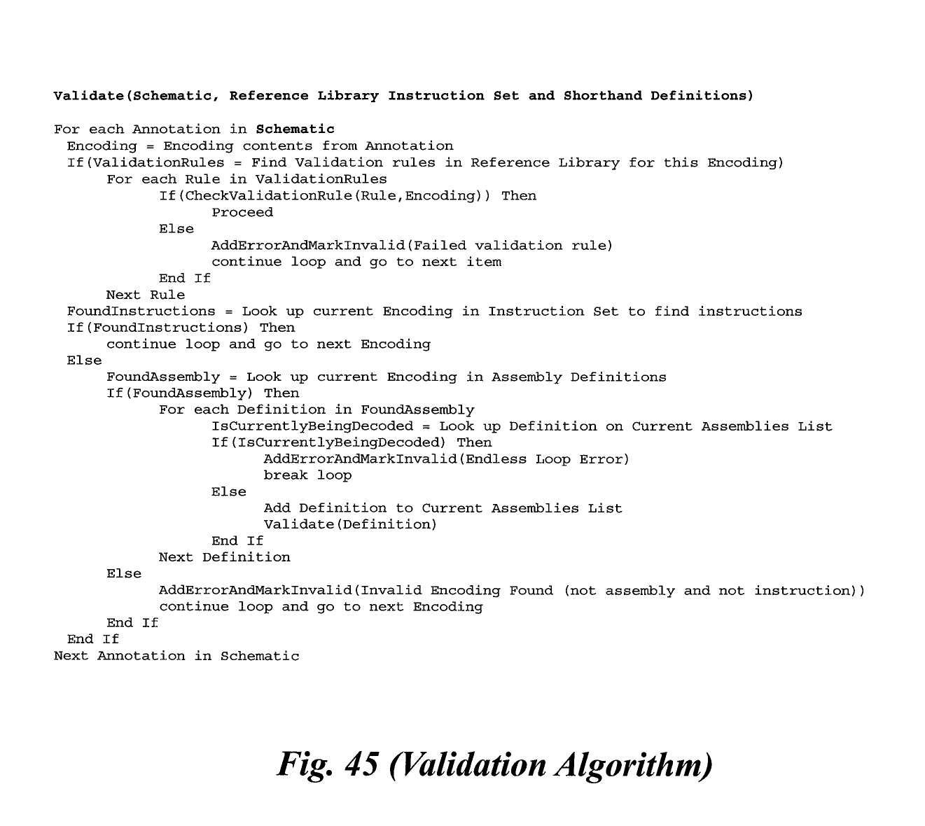

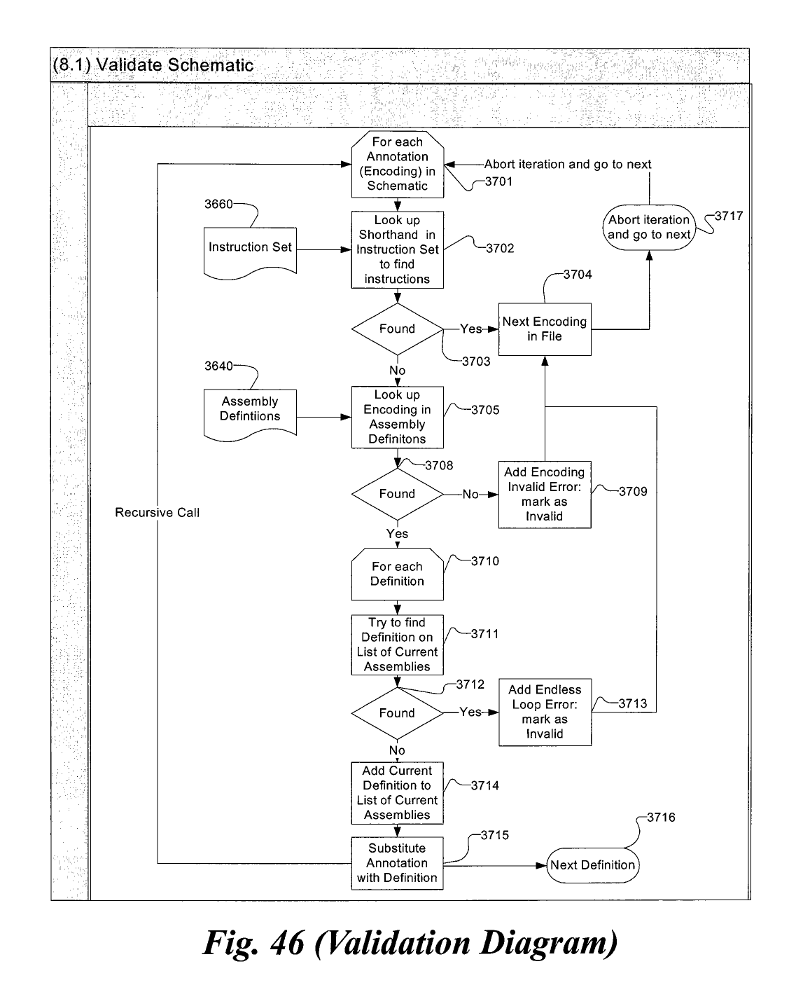

The Validate Schematic” step processes the given Schematic by performing the algorithmic operation described in FIG. 45. The output of this step is the input to the following step “Decode Schematic (if needed)” (in the case where there are no errors). If there are no errors, the output of this step is the same as the input; however it is now called the “Valid Schematic”. In the case where the Schematic does not validate correctly, the appropriate exceptions are created in an “Error Listing” and this is provided back to the Encoding function. The algorithmic operation for Validation is described as pseudo code in FIG. 45 and as a visual flow chart in FIG. 46.

Consider now an example of the “Validate Schematic” sub-function processing the Mockup Schematic described in the Encoding Function and shown in FIG. 41. As was described above, the Mockup Schematic of FIG. 41 is shown in an equivalent machine readable form as FIG. 42.

In the example the contents of FIG. 42 are parsed and the algorithm in FIG. 45 is used to validate each portion of the Schematic. The first operation is to check the Schematic Labels against a set of Validation Rules. The Validation Rules used for this example come from FIG. 26. The first (and only) Schematic Label for this example is the one labeled “OWA.” There are no Validation Rules for this symbol, so the algorithm continues. The next step is to check the Instruction Set (the Instruction Set in FIG. 25 is used for this example) to see that the symbol “OWA” is not found as a detailed instruction for manipulation of the Target Software Product.

The symbol “OWA” is not found in the Instruction Set, and therefore the robot checks to see if there is an Assembly by that name. An Assembly Definitions input (FIG. 19) (which is another input of the type of “reference information” as described above) may be used to then do an additional lookup. In the event that the symbol was not found in the listing of valid detailed instructions, nor found in the listing of Assemblies, a set of errors may be reported and sent as an output (Error Listing).

In this example, “OWA” is found as an assembly with a definition to a symbol “B” (the mapping is apparent from FIG. 19). Note that in the example only one definition is found (to B). In other cases, a single Assembly may be made up of multiple definitions. In such a case, each definition is evaluated independently and recursively (as is described in the algorithm depicted in FIG. 45). After B is found, the algorithm uses the single definition to do a lookup on an internal list called the List of Current Assemblies. If the definition were found on the list, a situation has been detected wherein an assembly is used to define itself; such a case is invalid, (as it would result in the Assembly Station endlessly looping) and therefore an error is generated for the user (again output through the Error Listing). In the event that the definition is not found on the List of Current Assemblies, it is added to the list so that subsequent recursive calls may detect an endless loop situation. After adding it to the list, the annotation is replaced with the definition and the definition is processed through the same mechanism. The operation is repeated until the entire Mockup Schematic is validated. If any errors are detected, the errors are collected and outputted (via any standard means such as User Interface, Output File, etc.) If no errors are detected, the Mockup Schematic is Valid and as such may be moved to the “Decode Schematic (if needed)” stage of the Construction Function.

The Valid Schematic, output from the “Validate Schematic” step, is the input for the “Decode Schematic (if needed)” Sub-function. This step decomposes the Schematic into its elemental forms, so that each Schematic Label can be directly implemented using an Instruction Set. Assembly Definitions as described during the Setup Function are used to simply the Encoding Function and make the creation of the Schematic easier and less time consuming. These Assembly Definitions may be decoded so that simple set of instructions may be applied to result in the manipulation of the Target Software Product.

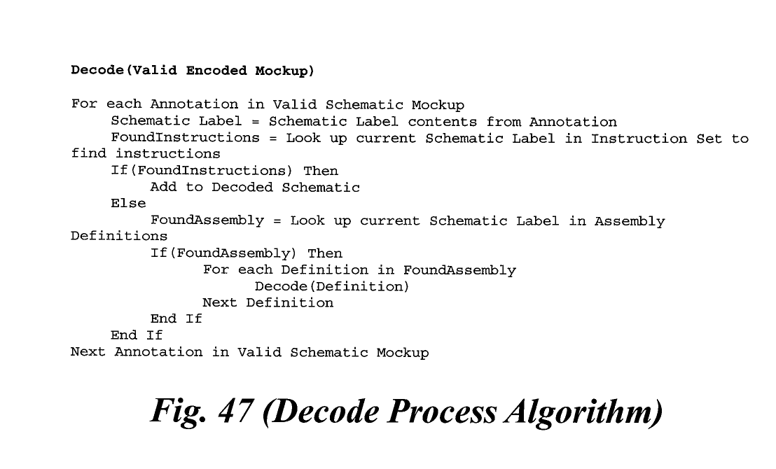

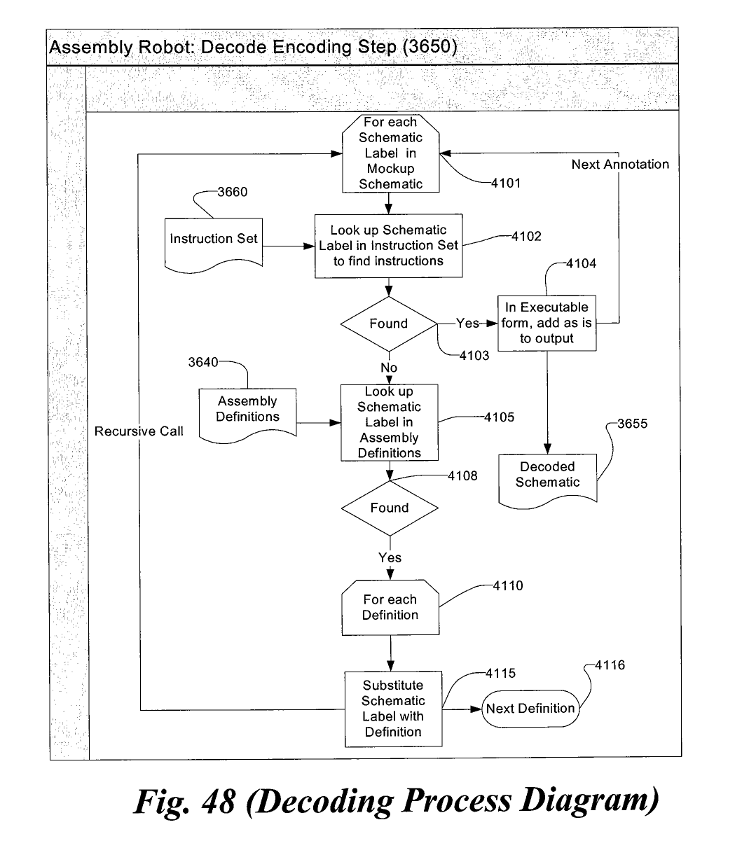

A translation occurs on the inputted Valid Schematic, which results in a Decoded Schematic, that is, a Schematic that can be executed directly (has a mapping for all Schematic Labels into an Instruction Set). An algorithm for such a Decoding Process is given in FIG. 47 with a corresponding flow chart diagram in FIG. 48.

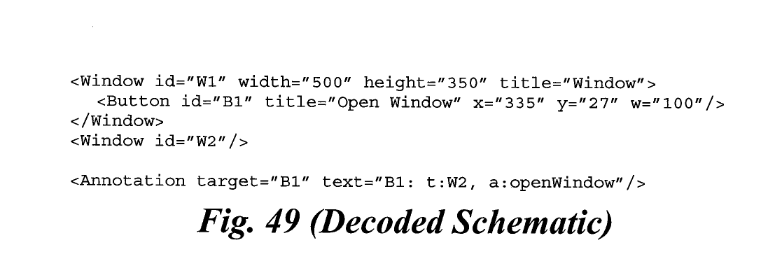

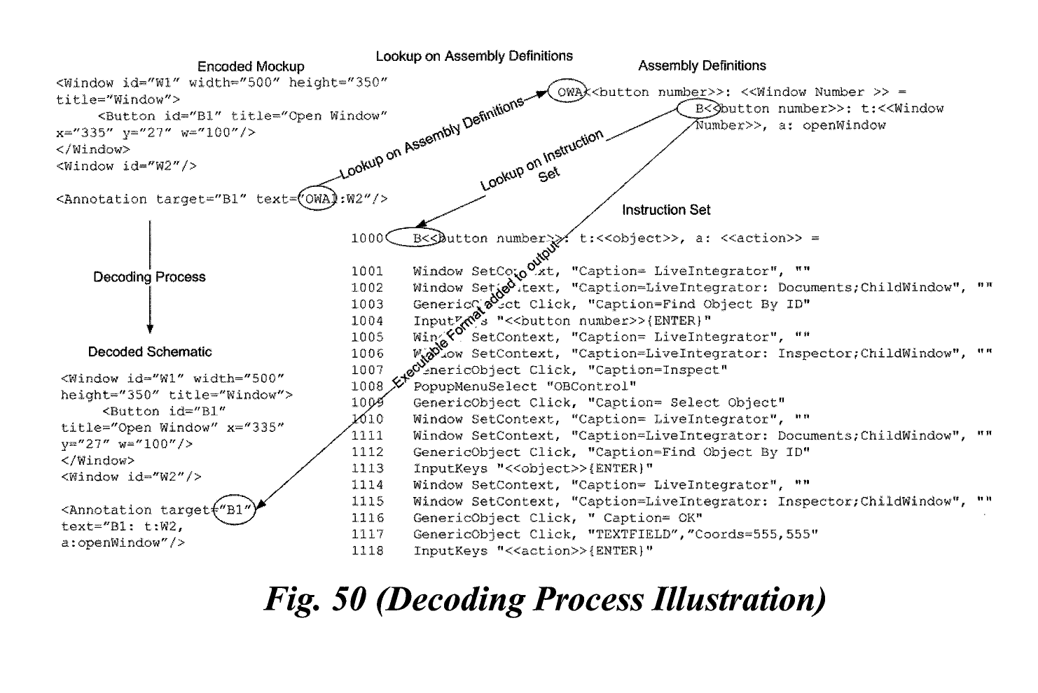

This process starts with the Valid Schematic described in FIG. 42 (which was deemed “Valid” by the “Validate Schematic” step). Each annotation in the document is evaluated and the given Schematic Label is compared with the Schematic Labels listed in the Instruction Set (FIG. 23 or FIG. 25). In this example, the symbol “OWA” is compared with the Instruction Set. No match is found and therefore the algorithm attempts to interpret “OWA” as an assembly. A lookup now occurs with the Assembly Definitions that are shown in FIG. 19. In this case, the symbol “OWA” is found. One definition entry is found, which shows a mapping to the Shorthand B. This definition is then recursively evaluated (which is B) through the same process. The process proceeds with B as the input and upon lookup in the Instruction Set one can see that B is indeed found in the Instruction Set and therefore the symbol B is considered to be in its base or executable form and is then added to the output which is the resulting Decoded Schematic. An illustration of the process is shown in FIG. 50. The output for this specific example is shown in FIG. 49. After having determined that there are no more Schematic Labels left to evaluate, “Decode Schematic (if needed)” step is complete, and the Decoded Schematic output becomes the input to the “Implement Schematic” step.

The Decoded Schematic contains information that maps directly to steps described in the corresponding Instruction Set. The Implement Schematic sub-function (diagonal element 8.3), uses the Decoded Schematic, and maps it to the Instruction Set. Each mapping results in a set of steps that can be executed directly onto or within the Target Software Product. These steps are considered the manipulations of the Target Software Product. The results of the manipulations are a Final Product Candidate.

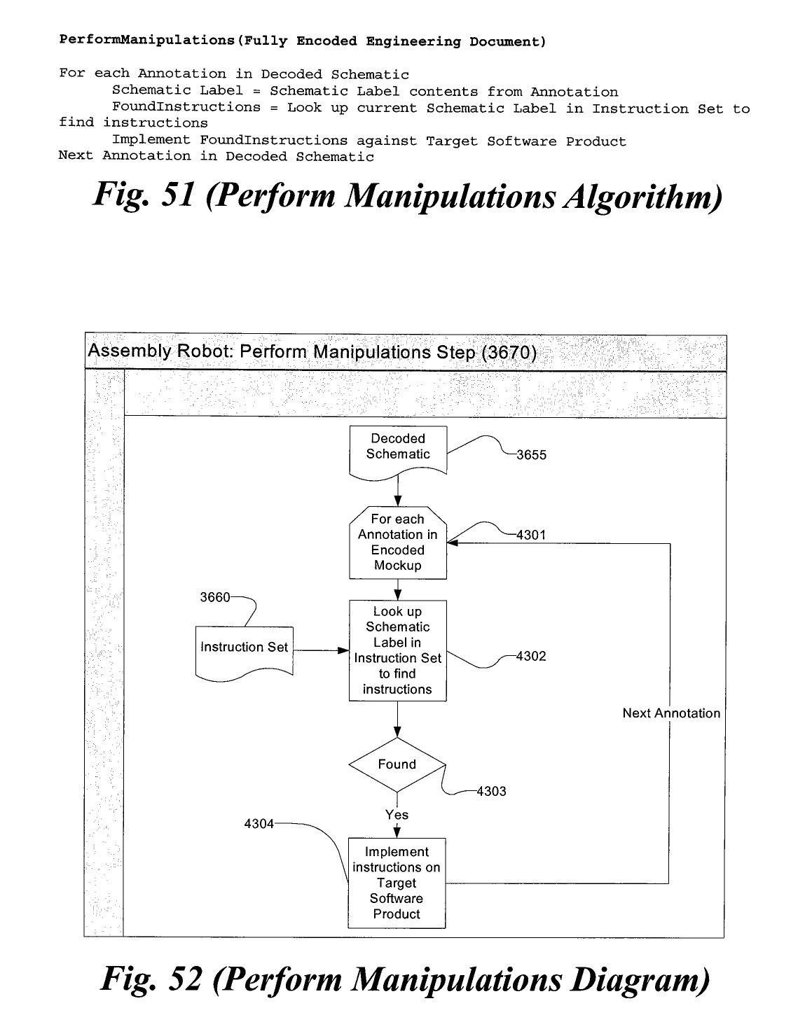

FIG. 51 shows an algorithm that may be used to perform the Implement Schematic step and FIG. 52 shows the corresponding flow chart. The output of this step is the Final Product Candidate which, in the particular example used in this disclosure, is a working screen that allows a user to press a button that opens another window.

In this example, the Assembly Station processes the inputted Decoded Schematic which was shown in FIG. 49. Only one annotation is found and the Schematic Label for B is used to do a lookup to find the necessary instructions from the Instruction Set FIG. 23. It is found, since it was decoded from the symbol “OWA” in the previous step and the instructions are then implement on the Target Software Product. As such, the Assembly Station implements the instructions for B1 (FIG. 23) lines 1000 to 1018. Note that the instructions configure the existing object B1 to interface with existing object W2. This is possible because the Mockup is an Electronic Mockup and therefore is used as the starting point for all software manipulations performed by the Assembly Station.

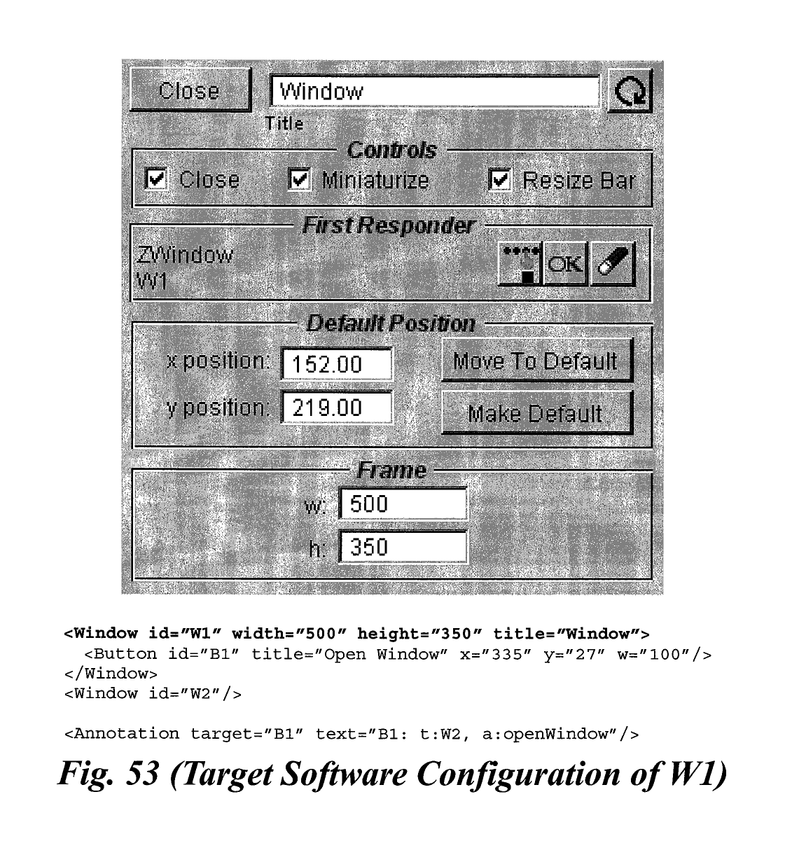

The Assembly Station interfaces with a Target Software Product, such as Livelntegrator™ to configure the completed screen using the instructions listed in the Instruction Set. Depending on the type of Instruction Set, the manipulations are performed differently. Examples of valid Instruction Sets are described in the Setup Function. In this case the Final Product Candidate would be a set of three objects configured with certain parameters. These parameters are visible by a user of the LiveIntegrator after the Assembly Station is complete. The property inspectors for these three objects in their final configuration are shown in FIGS. 53, 54 and 55.

FIG. 53 below shows the inspector of the object denoted by W1 (the window on which the button is configured to reside). Note the “w” (width) and “h” (height) attributes of the frame map to the Schematic. Immediately below the screen shot of the property inspector, is the Schematic with the corresponding section of the Schematic shown in bold.

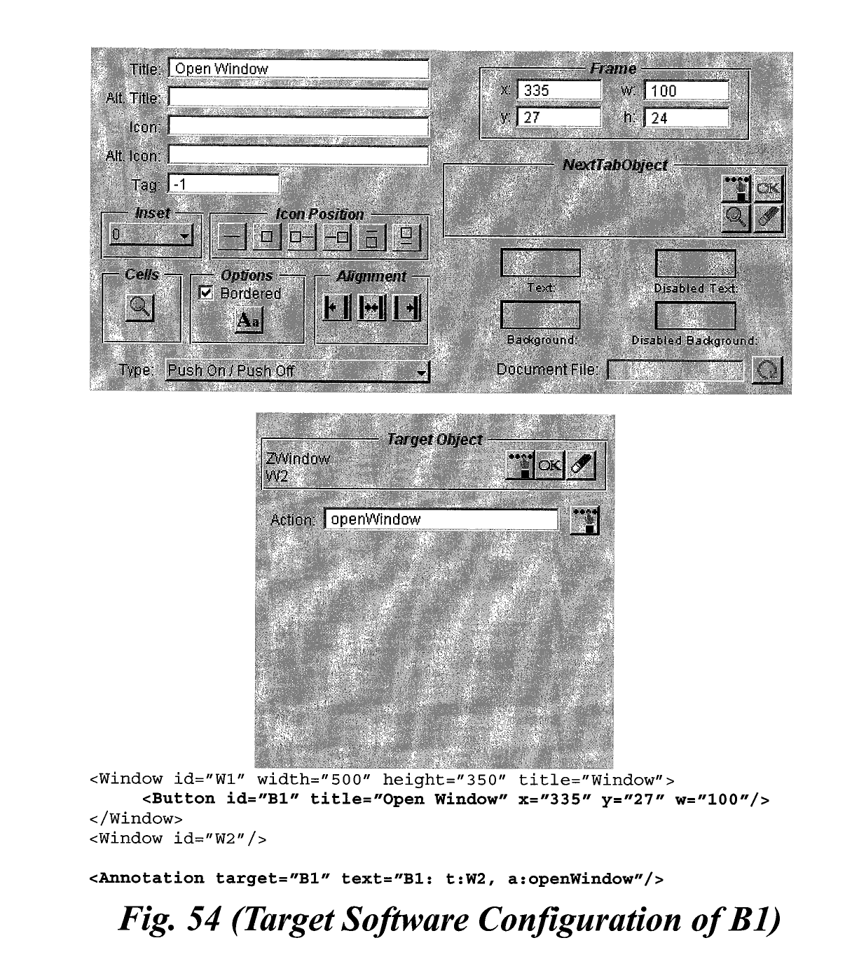

FIG. 54 shows the inspectors that show the state of the button denoted by B1 after the Assembly Station has completed its software manipulations. Note that in the example of the LiveIntegrator™, objects (sub-units) have multiple inspectors that show portions of the attributes of a given object. Each of these inspectors is shown. Note the “title”, the “x”, “y”, “w”, “h”, “target object” and “action” attributes and values (and how the corresponding Schematic shown below maps to these).

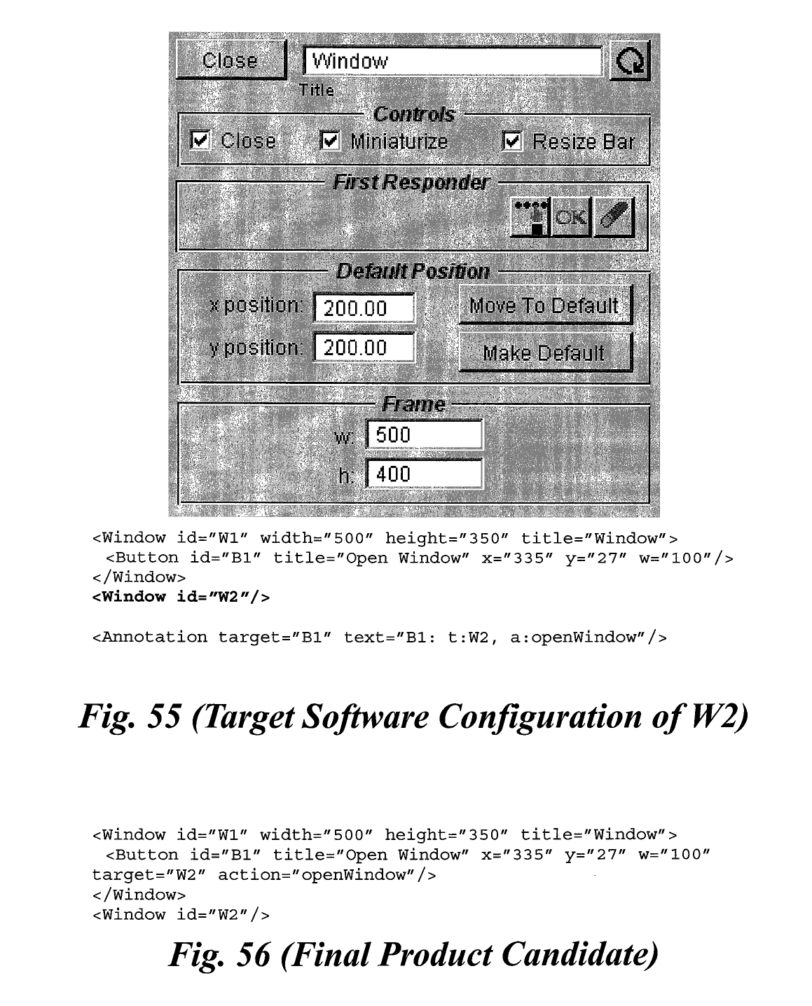

FIG. 55 shows the inspector for the object denoted by W2. Even though no attributes were shown in the Schematic for the object W2, values are still filled in. This is because there were default values assigned to W2 by the Target Software Product (Livelntegrator™) (on creation of any object of the type “Window”). Such a defaulting of attributes and behaviors is common among Target Software Products. In the example discussed, the resulting Final Product Candidate is a persisted configuration of a set of objects that exist within the Target Software Product (Buttons and Windows etc.). This persisted state may be any format that the Target Software Product uses.

For illustrative purposes, consider that the Target Software Product uses XML as the storage mechanism for the persistence of the configurations (manipulations) performed. In that case, the resultant Final Product Candidate may be viewed in a text format as is shown in FIG. 56. Note that this format is similar to the mockup (without annotations), except that the items represented are not just visual in nature.

The Assembly Station and corresponding algorithm may be used with any Target Software Product. Accordingly, the above example is not intended to be limiting. The Final Product Candidate is ready to be tested and become a Final Product. The “Unit Test Final Product Candidate” sub-function (diagonal element 8.4) performs this function.

The “Unit Test Final Product” step takes as its input the Test Form from the Encoding function and applies this to the Final Product Candidate. The result of this operation is either the Unit Tested Final Product or the Failed Product, or in some cases a Unit Test Final Product (as Assembly Definition). In the case of the Unit Test Final Product, it is input to the Production Control Function where it awaits combination with other Jobs. If the result is a Failed Product it is also routed to the Production Control Function where it is routed back to the step that can fix it. If the result is a Unit Tested Final Product (as Assembly Definition) it is routed to the Setup function where it can be incorporated into the Assembly Definitions section of the Reference Library.

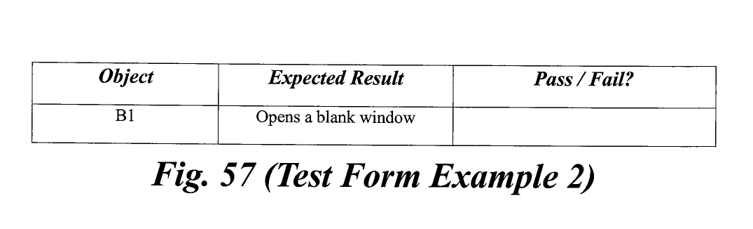

The Final Product Candidate illustrated in FIG. 56 is used as an example to show how the Unit Test Final Product step is executed. In addition to the Final Product Candidate, the Test Form produced during the Encoding function is used. (FIG. 57 provides a Test Form for this example). Each row in the Test Form is interpreted, and then executed on a runtime version of the Final Product Candidate. In the example, the first (and only) row in the unit Test Form indicates that Object by name B1 has an expected result of “Opens a blank window.” The Assembly Station conducting this test derives from the Decoded Schematic (FIG. 49), that B1 is a button. As such, it executes the default operation of the button (which is “Pushing the button”) and the result is observed. If nothing happens, the test fails, and the third column of the Test Form (FIG. 57) is marked “Fail.” If the result matches the expected result, “Pass” is indicated in the form. Any failure results in the Final Product Candidate being reclassified as a “Failed Product” and routed to the Production Control function. If all rows of the Test Form indicate “Pass” the Final Product Candidate is reclassified as a “Unit Tested Final Product.”

In many (or all) cases one may also denote the Unit Test Final Product as a “Unit Tested Final Product (as Assembly Definition).” This Assembly Definition may then be added to the Assembly Definition section of the Reference Library for future use. As such, it can be appreciated that very sophisticated Assembly Definitions can be created. The example of the air conditioner component installed into a vehicle being manufactured as a single unit was described earlier, it is through this process, of using “Unit Tested Final Products” as Assemblies “Unit Tested Final Product (as Assembly Definition)” that such gains can be translated the software world.

C. Inspection Phase

After all Jobs are completed for a Specification Document, the Jobs get put together by Production Control and the completed package is moved to the Inspection Phase. The Specification Document could represent a group of individual components that are not meant to work together or they could represent a group of components that are meant to work together.

If they are meant to work together in the case of a Business Application, the Jobs get combined based on the type of output desired. The process of combining the Jobs is no different than the process of creating a single Job like a Report or Screen. Now the Job is a set of Jobs. For example, consider a Business Application containing Screens, Reports, Workflows and Interfaces. First, the Reference Library for a Business Application is used to Encode the Job and then the Job is Constructed from the Encoding. This way Jobs can be combined to produce much larger outcomes utilizing the same Software Factory.

It is common that one software solution may in fact consist of several systems or interrelated application, each such application then consisting of Modules or logical sections of functionality, and each such Module consisting of Units as described above regarding the Production Control Function. One can see that in these cases, any one of these items (the full solution, an individual application, a given Module and the Units within a Module) may be processed through the factory as a single Job. Jobs may be designed to be independent or dependent upon one another. It is the function of an individual Software Factory and specifically the Production Control to define the relationships between the Job Types and orchestrate the Assembly Lines to make most efficient usage of the resources. This concept of sub Jobs or Assembly is analogous to the concept of manufacturing an air conditioner for an automobile.

This is analogous to the concept of manufacturing an air conditioner for an automobile. The air conditioner may be a sub unit of an automobile, but may go through its own Assembly Line that results in the Final Product. This is commonly referred to as a sub assembly or assembly or part. This unit may then be a component that is put into the automobile as Part of the overall Assembly Line that results in the completed automobile.

Likewise the Business Application Job is the process of producing the overall application from the completed units which have already been processed through the factory. Such a Job may have steps that include pulling together the completed Units, creating a main menu that controls the invocation of the Units during run time and testing those units together as a combined Unit.

The final phase of the Software Manufacturing Process is the Inspection Phase. The Inspection Phase comprises the core function: Inspection (diagonal element 9.0 of FIG. 2). The Inspection Function is a final validation that the Final Product(s) meet the requirements Specification Document. The Inspection Function validates that the number and types of Units indicated by the Specification Document have been created and produced. Typically all the testing, including unit and system testing is conducted as Part of the Construction Process. The Inspection Function performs a final validation that the Final Product(s) meet the requirements defined in the Specification Document and may include post deployment user feedback.

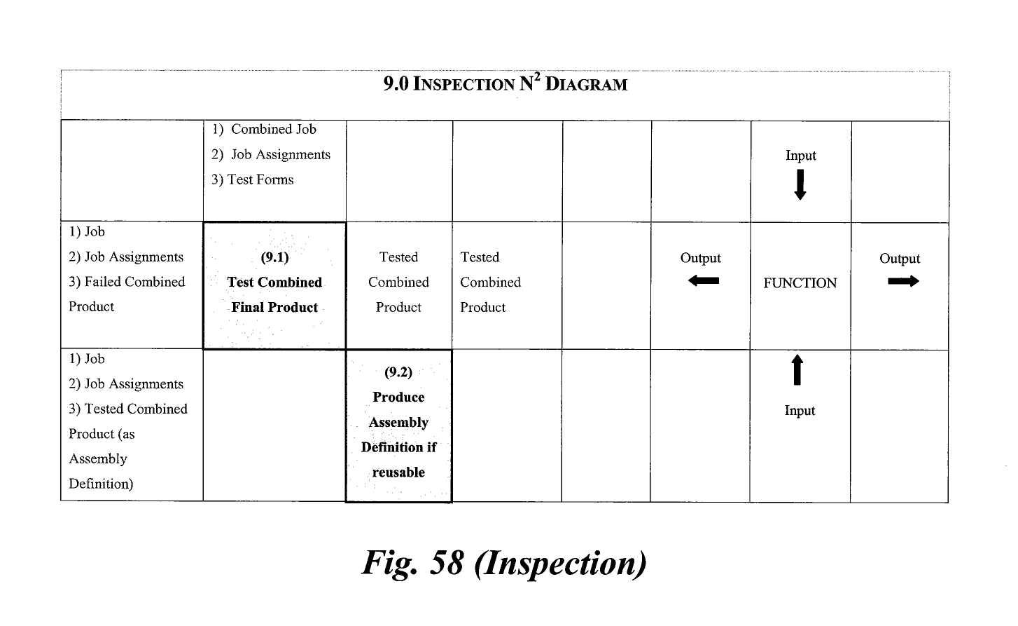

A Test Form may be generated from the requirements listed in the Specification Document. Preferably, the Test Form is generated as Part of the Encoding Function. The Test Form for the Final Product differs from the other Test Forms in that it is at the top of the hierarchy of the Jobs. In Production Control it was disclosed how Jobs may be hierarchical in nature, and as such, a single Job for the overall business application (if that is the desired output of a given specification) is a larger Job that encapsulates the individual units. The overall process of the Inspection Function is illustrated in FIG. 58.

An N² Diagram of the Inspection Function is shown in FIG. 58. The Inspection Function comprises two sub-functions: “Test Combined Final Product” (diagonal element 9.1) and “Produce Assembly Definition if reusable” (diagonal element 9.2). The Test Form produced at the top level for the overall application is used as the input to the first step in the Inspection function “Test Combined Final Product” (diagonal element 9.1). If this step succeeds, the Tested Combined Product is evaluated to determine if it is reusable by step “(9.2) Produce Assembly Definition if reusable.” If it is found to be reusable as a component, an appropriate Assembly Definition is produced.

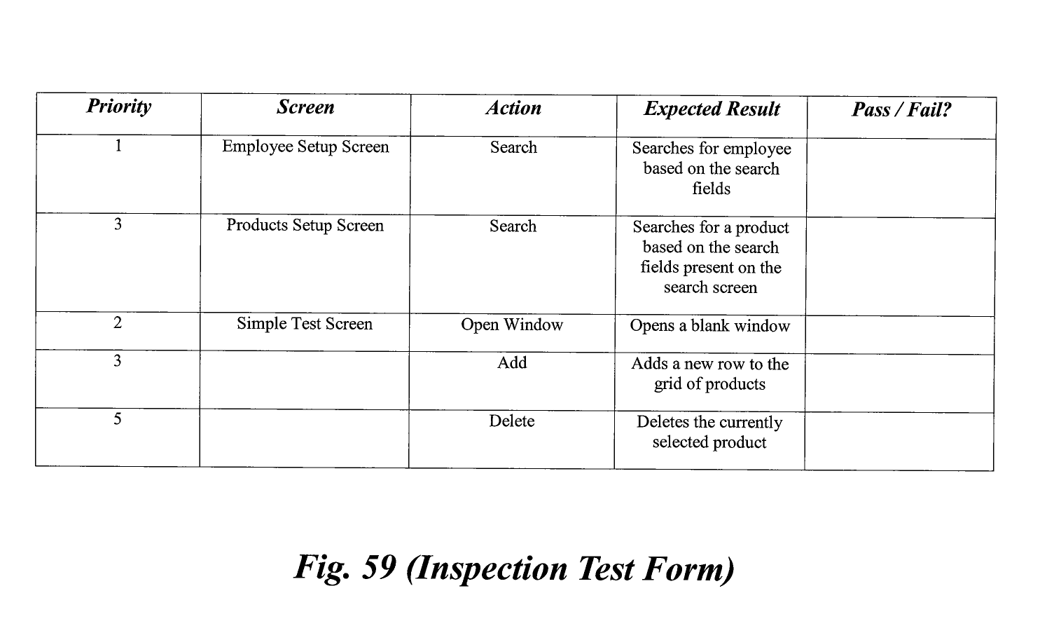

The Test Form produced during Encoding function is the primary input to the Test Combined Final Product sub-function. An example of such a Test Form is shown in FIG. 59. The specification used to produce this Test Form is the complete specification that was illustrated in FIG. 7. Note that the FIG. 59 illustrates the simplest Test Form for the overall application. The specification is used directly and a column is added to indicate the result of the test. The requirement description becomes the expected result. If the action does not result in the expected result, that requirement is not met and therefore the test fails.

An alternative Test Form for the overall application may include a sequence of operations and sample data that may be used to simulate a user's true interaction with an application. Such a technique is advantageous as it takes into account potential users actions in using the application as well as real example of data. Often a specification may actually contain such a Test Form already. These high level Test Forms that test a sequence of operations against the overall application are often known to those skilled in the art as test cases or test scenarios or business scenarios or use cases.

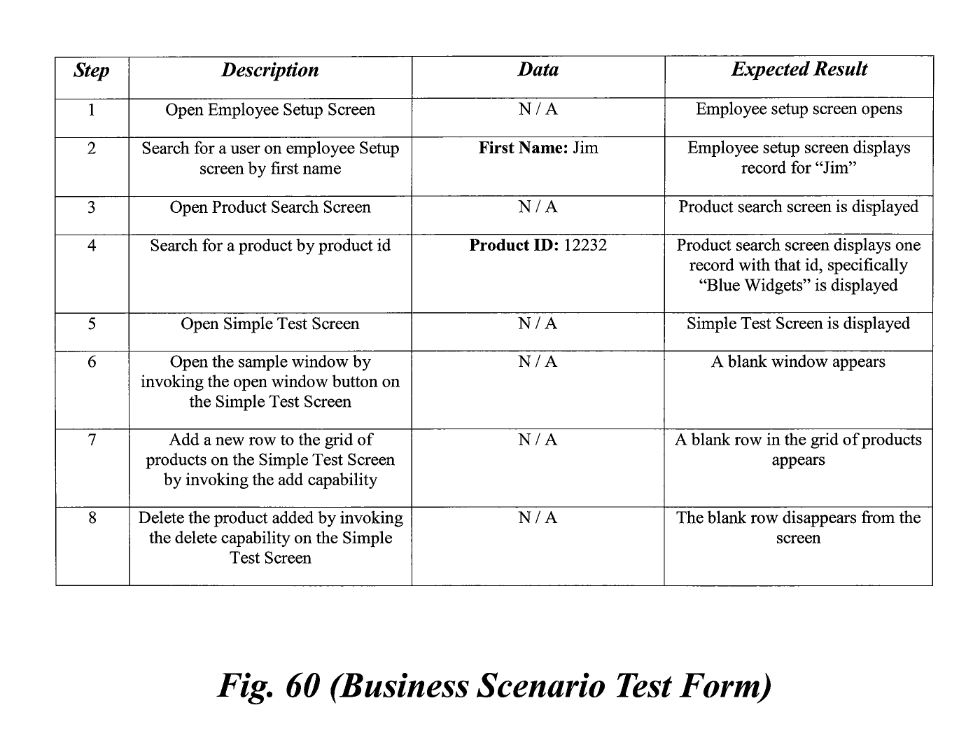

If a Software Factory is to use such a business scenario Test Form, it is assumed that it will be provided with the specification. An example of such a business scenario Test Form is shown in FIG. 60. It should be noted that again the Complete Specification from FIG. 7 is used as the inspiration for the creation of this Test Form. This Test Form would have been provided with the complete specification as an addendum. Those skilled in the art will note that it is advantageous to provide a correlation or mapping between the steps in the business scenario Test Form and the requirements listed in the specification. One can see that such a Test Form may be easily used to test the requirements of the system if it is provided.

Whether a Test Form or a business scenario Test Form is used as the input to the Test Combined Final Product step, the sub-function is performed in substantially the same way. The steps or actions listed in the Test Form are executed one by one in the sequence that they are listed on the Test Form. The unit test Final Product is observed while these actions are performed and the resultant behavior is compared to the expected result for each step. If the expected result matches, that step is marked as Pass, if it does not match, that step is marked as Fail. If any single step fails, the overall test is marked as failed. If the test fails, the unit tested Final Product is re-categorized as the failed combined product and it is returned to the Production Control function. The Production Control function may then route the failed units to the appropriate Assembly Stations for reassembly or repair.

As was described in the above disclosure for the Unit Test Final Product, a given unit may be reclassified as an Assembly Definition. It is advantageous to build up a library of reusable components and therefore the process of reclassifying a given unit as an Assembly Definition is useful. Similarly, the entire combined product may be deemed a reusable component and as such may be reclassified as a Tested Combined Product. The Produce Assembly Definition If Reusable step performs this function.

Determining if a combined Final Product is reusable or not is something that is typically done manually. In an automated implementation, most, if not all, combined Final Products are assumed reusable and as such may be reclassified as Assembly Definitions. The requirements for each Assembly Definition may be stored with the Assembly Definition. Such a library of Assembly Definitions may be searched as a new specification enters the Software Factory. Direct match or close matches may be used to identify if such a Final Product or similar Final Product had previously been assembled by a given Software Factory.

After inspection, Deployment (diagonal element 10.0 of FIG. 2) occurs. The Deployment function produces the appropriate media for delivery and fulfills the delivery process. Deployment operations are well known to those skilled in the art and for brevity are not described. It should be noted that the output of the Software Factory (as described in this document) is not by any means limited to the production of a Deployed Finished Application. Outputs can be any manipulation of a set of (or one) target software product.

Consistent and detailed examples of the preferred embodiments of the Software Factory as they apply to business application (software) development has been disclosed above. It is possible to use embodiments of the present invention for the creation or configuration of vastly different types or kinds of software. Specifically, consider the example of a computer game.

First person games are familiar to those skilled in the art. Such games are highly graphical in nature and present to the end user a virtual world in which a character moves around. A first person view of such a world is provided to the end user. The computer monitor displays the view as if the user were the character navigating the virtual world (and the image as would be seen by the eyes of the character). Keyboard, mouse and other input devices are used to capture the end user's desired control movements and as such, the software responds, adjusting the image presented to the user to simulate the movement through the virtual world. For example, a hallway may be shown with three doors on the side. As the user advances the character using the keyboard, the doors appear to move closer. As the user indicates that a right turn is desired, a doorway may appear to move from the side of the user to the front. The perspective is adjusted accordingly. In such games it is typical to include adversary characters such as monsters or aliens. These characters are often controlled through software logic and are designed to engage the end user's character in battle or other interactions. Additionally it is often the case that in such a game various treasures or other positive (or negative) items are placed or hidden within the virtual world.

A preferred embodiment of the invention described in this disclosure may be used to facilitate the creation of such software. It is known to those skilled in the art that such computer games are often created using a “gaming engine.” Such a gaming engine is an executable that is designed to interact with a set of documents that indicate what is to be displayed to the end user. It was indicated earlier that most business applications may contain screens, reports, workflows etc. In the first person computer game, a computer game may consist of level-maps, treasure definitions, and enemy definitions. Each of these items may be a document that, once completed, may be used by the gaming engine to render a specific game to the end user's computer.

Consider first the specification. A specification document may be created indicating the level-maps, enemy characters and treasures desired. Additionally the specific locations or layouts may be indicated within the specification as well. This is similar to the usage of mockups within the specification described earlier. Specifically, a drawing of a level map may be provided for each level designated by the specification. This “mockup” may be an aerial view of a virtual world, with lines indicating the walls and other styles of lines indicating doors etc. As is the case with the business application example given above a set of Productivity Tools may be used to assemble such a level-map into a document which is electronically readable by the gaming engine. A process of creating Shorthand Definitions and the like may be used to define a Reference Library Setup that applies to the Target Software Products used to create parts needed for the game application. In the example described here, one possible Part Listing may be: Level 1 map, Level 2 map, Big monster, Small monster, and fist aid kit. In this example Level 1 map and Level 2 map may be level-maps and big monster and small monster may be enemy definitions and first aid kit may be a treasure definition. An Encoding process may be used based on short hands defined within the Setup step that allows the maps to be encoded with special attributes (x may represent the location of a monster, or a certain style of line shading may indicate a different surface type etc.). Attributes of each of the Part are encoded in such a way to bridge the specification and the Target Software Products (Productivity Tools) (based on the Reference Library, which is created using the process defined in Setup). Assembly Stations can then be used to assemble and test each unit (level, enemy or treasure appropriately).

Those skilled in the art will appreciate that changes could be made to the embodiments described above without departing from the broad inventive concept thereof. Therefore, the electronic learning device with a graphic user interface for interactive writing is not limited to the particular embodiments disclosed, but it is intended to cover modifications within the spirit and scope of the present invention as defined by the appended claims.

All references, patent applications, and patents mentioned above are incorporated herein by reference in their entirety and are not to be construed as an admission that any of the cited documents constitutes prior art, or as an admission against interest in any manner.

We claim:

1. A method for manufacturing a Final Product of a Target Software Product based on a specification for the Final Product, the method comprising:
a. setting-up a software manufacturing environment having a configurable Assembly Line comprising at least one Assembly Station; and
b. constructing the Final Product by implementing a Schematic on the Assembly Line, the Schematic designating how the Target Software Product is to be manipulated by the at least one Assembly Station.

2. The method according to claim 1, further comprising confirming the specification format.

3. The method according to claim 1, further comprising creating a Part Listing based on the specification, the Part Listing comprising a plurality of parts, at least one Part associated with a Job.

4. The method of claim 1, wherein the setting-up step further comprises providing or enhancing a Reference Library having content related to the Target Software Product and a plurality of Job types.

5. The method of claim 1, wherein the setting-up step further comprises configuring the at least one Assembly Station to manipulate the Target Software Product for at least one Job type selected from a plurality of Job types.

6. The method according to claim 1, wherein the setting-up step further comprises determining a plurality of allowable manipulations of the Target Software Product.

7. The method according to claim 6, wherein the setting-up step further comprises creating a plurality of Shorthand Definitions, each Shorthand Definition corresponding to one manipulation of the plurality of allowable manipulations.

8. The method according to claim 7, wherein the setting-up step further comprises creating at least one Assembly Definition comprising at least two Shorthand Definitions.

9. The method according to claim 7, wherein the setting-up step further comprises creating an Instruction Set corresponding to at least one Shorthand Definition.

10. The method according to claim 9, wherein the Instruction Set is machine readable.

11. The method according to claim 1, wherein the setting-up step further comprises creating Validation Rules.

12. The method according to claim 1, wherein the setting-up step further comprises designing a work flow for each Job type of a plurality of Job types.

13. The method according to claim 1, wherein the Schematic is a sketch Schematic.

14. The method according to claim 1, wherein the Schematic is a mockup Schematic.

15. The method according to claim 15, wherein the mockup Schematic is a Machine Readable Schematic.

16. The method of claim 1, further comprising Encoding a Job.

17. The method of claim 16, wherein the Encoding step comprises producing the Schematic for the Job based on the specification and the content of the Reference Library.

18. The method according to claim 16, wherein the Encoding step comprises producing a Test Form.

19. The method according to claim 1, wherein the constructing step further comprises validating the Schematic.

20. The method according to claim 1, wherein the at least one Assembly Station comprises an automated Assembly Robot and the constructing step implements the Schematic with the Assembly Robot.

21. The method according to claim 1, further comprising controlling production of the Final Product, the controlling step comprising routing a Job to the at least one Assembly Station.

22. A method for manufacturing a Final Product of a Target Software Product based on a specification for the Final Product, the method comprising:
a. setting-up a software manufacturing environment having a configurable Assembly Line comprising at least one Assembly Station, the setting-up step comprising:
(1) providing or enhancing a Reference Library having content related to the Target Software Product and a plurality of Job types; and
(2) configuring the at least one Assembly Station to manipulate the Target Software Product for at least one Job type selected from the plurality of Job types;
b. Encoding a Job corresponding to the at least one Job type, the Encoding step comprising:
(1) producing a Schematic for the Job based on the specification and the content of the Reference Library, the Schematic designating how the Target Software Product is to be manipulated by the at least one Assembly Station; and
c. constructing the Final Product by implementing the Schematic on the at least one
Assembly Station.

23. A method for manufacturing a Final Product of a Target Software Product based on a specification for the Final Product, the method comprising:
a. performing an engineering analysis of the specification, the performing step comprising:
(1) confirming the specification format; and
(2) creating a Part Listing based on a decomposition of the specification, the Part Listing comprising a plurality of parts, each Part associated with a Job type of a plurality of Job types;
b. setting-up a software manufacturing environment having a configurable Assembly Line comprising a plurality of Assembly Stations, the setting-up step comprising:
(1) providing or enhancing a Reference Library having content related to the Target Software Product and the plurality of Job types;
(2) configuring the Assembly Line to manipulate the Target Software Product for each Job type of the plurality of Job types, each Assembly Station configured to manipulate the Target Software Product for at least one Job; and
(3) creating a plurality of Jobs, each Job associated with one Part of the plurality of parts;
c. controlling production of the Final Product by managing the assignment of Jobs to the plurality of Assembly Stations;
d. Encoding each Job, the Encoding step comprising:
(1) producing a Schematic for the each Job based on the specification and the content of the Reference Library, the Schematic designating how the Target Software Product is to be manipulated by the plurality of Assembly Stations; and
e. constructing the Final Product by implementing the Schematic on the Assembly Line.

24. A method for controlling the production of a Final Product of a Target Software Product in a software manufacturing environment, the method comprising:
a. providing a configurable Assembly Line comprising at least one Assembly Station; and
b. routing a Job associated with the manufacturing of the Final Product to the at least one Assembly Station in accordance with a workflow for the Job.

25. The method of claim 24, further comprising validating the Job is complete, the validating step producing a validation notice.

26. The method of claim 24, wherein the workflow comprises a plurality of steps, and the routing step assigns at least one step of the plurality of steps to the at least one Assembly Station.

27. The method of claim 26, wherein the validating step determines whether the at least one Assembly Station has completed the at least one step.

28. The method of claim 24, wherein the workflow comprises a plurality of steps and the validating step determines whether each step of the plurality of steps is complete.

29. The method of claim 24, wherein the routing step routes a Job based on a capability and an availability of the at least one Assembly Station.

30. The method of claim 24, further comprising updating the workflow associated with the Job.

31. The method of claim 24, wherein a plurality of Jobs are associated with the manufacturing of the Final Product, and the method further comprises a combining Job step wherein at least two Jobs of the plurality of Jobs are combined.

32. The method of claim 24, further comprising a reconfiguration step wherein the configuration of the Assembly Line is changed based on performance metrics associated with the Assembly Line.

33. A method for Encoding a Job in a Software Factory, the Job associated with a Part of a Final Product of a Target Software Product, the method comprising:
a. confirming that a Schematic can be created in the Software Factory; and
b. producing a Schematic designating how the Target Software Product is to be manipulated to produce a Part of a Final Product of a Target Software Product.

34. The method according to claim 33, further comprising preparing a Test Form documenting the expected result of manipulating the target software in accordance with the Schematic.

35. The method according to claim 33, further comprising obtaining a non-Schematic description of the part.

36. The method according to claim 33, further comprising obtaining a partial Schematic of the part.

37. The method according to claim 33, wherein the Schematic produced by the producing step is a sketch Schematic.

38. The method according to claim 33, wherein the Schematic produced by the producing step is mockup Schematic.

39. The method according to claim 33, wherein the Schematic produced by the producing step is a Machine Readable Schematic.

40. The method according to claim 33, further comprising making a request to a library having content related to the Target Software Product, the request related to Encoding the Job and retrieving content from the library in response to the request, and the producing step produces the Schematic based on the retrieved content.

41. The method according to claim 33, wherein the producing step produces the Schematic based on Assembly Definitions.

42. The method according to claim 33, wherein the producing step produces the Schematic based on Shorthand Definitions.

43. A method for constructing a Final Product of a Target Software Product in accordance with a Schematic having a Schematic Label, the method comprising implementing the Schematic, wherein the implementing step constructs the Final Product.

44. The method of claim 43, further comprising decoding the Schematic.

45. The method of claim 44, wherein the decoding step comprises identifying an instruction associated with the Schematic Label, the Instruction Set implementable by the target software.

46. The method of claim 45, wherein the instruction is retrieved from a library associated with a software manufacturing environment.

47. The method of claim 43, wherein the decoding step comprises identifying an Assembly Definition associated with the Schematic Label.

48. The method of claim 47, wherein the Assembly Definition is retrieved from a library associated with a software manufacturing environment.

49. The method of claim 43, wherein the implementing step comprises manipulating the Target Software Product to produce the Final Product.

50. The method of claim 43, further comprising validating the Schematic.

51. The method of claim 50, wherein the validating step comprises determining whether the Schematic Label complies with a validation rule.

52. The method of claim 43, further comprising testing the Final Product.

53. The method of claim 52, wherein the testing step comprises:
a. executing the Final Product to produce a result; and
b. determining whether the result is an expected result.

54. A method for constructing in a software manufacturing environment a Final Product of a Target Software Product in accordance with a Schematic having a Schematic Label, the method comprising:
a. validating the Schematic, wherein the validating step produces a validated Schematic;
b. decoding the validated Schematic, wherein the decoding step produces a decoded Schematic;
c. implementing the decoded Schematic, wherein the implementing step constructs a unit Final Product; and
d. testing the final unit product, wherein the testing step produced a tested Final Product.

55. A method for providing support for manufacturing a Final Product of a Target Software Product, the method comprising:
a. making a request to a Reference Library having content related to the Target Software Product, the request related to the construction of the Final Product;
b. retrieving content from the Reference Library in response to the request; and
c. making the retrieved content available for use in the manufacturing of the Final Product.

56. The method according to claim 55, further comprising updating the Reference Library based on information acquired during the manufacturing of the Final Product.

57. The method according to claim 55, wherein the Reference Library comprises an electronic database, the request is a search query, and the retrieving step retrieves the content in machine readable form.

58. The method according to claim 55, wherein the content comprises Shorthand Definitions.

59. The method according to claim 55, wherein the content comprises Instruction Sets.

60. The method according to claim 55, wherein the content comprises Validation Rules.

61. The method according to claim 55, wherein the content comprises Assembly Definitions.

62. A method for constructing a Final Product of a Target Software Product in accordance with a Machine Readable Schematic, the method comprising:
a. configuring an Assembly Robot to produce an output corresponding to a manipulation of the Target Software Product;
b. reading the Machine Readable Schematic with the Assembly Robot; and
c. producing the Final Product by implementing the Machine Readable Schematic with the Assembly Robot.

63. The method according to claim 62, wherein the configuring step configures the Assembly Robot to manipulation the Target Software Product and the producing step manipulates on the Assembly Robot the Target Software Product to produce the Final Product.

64. The method according to claim 62, wherein the configuring step configures the Assembly Robot to create an application programming interface compatible with the Target Software Product.

65. The method according to claim 62, further comprising:
a. parsing the Schematic into Instruction Sets executable by the Target Software Product; and
b. the producing step implements the Instruction Sets on the Target Software Product.

66. The method according to claim 62, wherein the Assembly Robot comprises hardware, or a third party product, or a machine readable Instruction Set.

67. The method according to claim 62, wherein the configuring step comprises training or machine learning.
